(19) United States
(12) Patent Application Publication
(10) Pub. No.: US 2015/0237104 A1
(43) Pub. Date: Aug. 20, 2015

(54) COMMUNICATION SYSTEM, COMMUNICATION APPARATUS, AND COMMUNICATION METHOD

(71) Applicant: FUJITSU LIMITED, Kawasaki-shi (JP)

(72) Inventor: Naoki OGUCHI, Kawasaki (JP)

(73) Assignee: Fujitsu Limited, Kawasaki (JP)

(21) Appl. No.: 14/622,206

(22) Filed: Feb. 13, 2015

(30) Foreign Application Priority Data
Feb. 20, 2014 (JP) 2014-030725

(51) Int. Cl. H04L 29/06; H04L 29/08

(52) U.S. Cl. CPC H04L 65/608; H04L 67/10; H04L 69/16

(57) ABSTRACT

A communication system including: a communication apparatus including: a transmitter, and a processor coupled to the transmitter and configured to: set an operation mode in the communication apparatus for forwarding data, to be one of a first operation mode and a second operation mode, the first operation mode in which the data is forwarded without a protocol conversion, the second operation mode in which the data is forwarded with the protocol conversion, detect identification information of the data included in the data that is received from an upstream communication apparatus and forwarded to a downstream communication apparatus, and when the operation mode in the communication apparatus is the first operation mode and the identification information detected by the first processor is a first given value, switch the operation mode in the communication apparatus from the first operation mode to the second operation mode.

### CROSS-REFERENCE TO RELATED APPLICATION

This application is based upon and claims the benefit of priority of the prior Japanese Patent Application No. 2014-030725, filed on Feb. 20, 2014, the entire contents of which are incorporated herein by reference.

### FIELD

The embodiment discussed herein is related to a communication system, a communication apparatus, and a communication method.

### BACKGROUND

In the related art, a communication apparatus is known in which a protocol processing unit performs synchronization processing on a protocol processing unit for low-speed processing and a payload packet transmitting and receiving processing unit for high-speed processing, according to an instruction of the payload packet transmitting and receiving processing unit (for example, refer to Japanese Laid-open Patent Publication No. 2009-077024).

Furthermore, details of a technology in which a transmission control protocol (TCP) packet stream between a client and a server is passively monitored during a session between a client and a server over a network are known (for example, refer to Japanese National Publication of International Patent Application No. 2003-530623). Furthermore, details of a technology in which, when a real time streaming protocol (RTSP) stream is monitored and thus it is determined that a primary server is inactive, a TCP connection to the primary server transitions to a TCP connection to a backup server is known (for example, refer to Japanese National Publication of International Patent Application No. 2010-531618).

Furthermore, an apparatus is known that provides first and second packet transmission processing tasks at the same time by terminating TCP retransmission control with respect to multiple TCP connections between apparatuses that are added to both ends of a wide area network, respectively, and that are arranged in such a manner as to face each other with the wide area network in between (for example, refer to Japanese Laid-open Patent Publication No. 11-341072). Furthermore, an apparatus is known that decreases the number of times that retransmission occurs in response to packet discarding and improves speed performance of TCP communication by dynamically allocating a receiving buffer memory area corresponding to each receiving port (for example, refer to Japanese Laid-open Patent Publication No. 2009-081595).

### SUMMARY

According to an aspect of the invention, a communication system includes a first communication apparatus including: a first transmitter, and a first processor coupled to the first transmitter and configured to: set an operation mode in the first communication apparatus for forwarding data, to be one of a first operation mode and a second operation mode, the first operation mode in which the data is forwarded without a protocol conversion, the second operation mode in which the data is forwarded with the protocol conversion, detect identification information of the data included in the data that is received from an upstream communication apparatus and forwarded to a second communication apparatus, and when the operation mode in the first communication apparatus is the first operation mode and the identification information detected by the first processor is a first given value, switch the operation mode in the first communication apparatus from the first operation mode to the second operation mode, and the second communication apparatus including: a second transmitter, and a second processor coupled to the second transmitter and configured to: set an operation mode in the second communication apparatus for forwarding data, to be one of the first operation mode and the second operation mode, detect identification information of the data included in the data that is received from the first communication apparatus and forwarded to a downstream communication apparatus, and when the operation mode in the second communication apparatus is the second operation mode and the identification information detected by the second processor is the first given value, switch the operation mode in the second communication apparatus from the second operation mode to the first operation mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a communication system;

FIG. 2 is a descriptive diagram illustrating one example of the communication system;

FIG. 3 is a descriptive diagram for describing a specific configuration of the communication system;

FIG. 4 is a descriptive diagram illustrating a configuration example of a base station;

FIG. 5 is a descriptive diagram illustrating a configuration example of a radio terminal apparatus;

FIG. 6 is a diagram illustrating one example of a software configuration of a computer apparatus;

FIG. 7A is a first half of a sequence diagram illustrating an example of transmitting and receiving data at the time of performing position determination;

FIG. 7B is a second half of the sequence diagram illustrating an example of transmitting and receiving the data at the time of performing the position determination;

FIG. 8A is a diagram for describing one example of a position determining method;

FIG. 8B is a descriptive diagram illustrating one example of contents entered into an inter-apparatus quality table;

FIG. 9A is the first portion of a sequence diagram illustrating one example of a method of measuring communication quality between WAN optimizers;

FIG. 9B is the second and last portion of the sequence diagram illustrating one example of the method of measuring the communication quality between WAN optimizers;

FIG. 10 is a descriptive diagram illustrating one example of a result of measuring inter-apparatus quality;

FIG. 11 is a descriptive diagram illustrating an example of a relationship between a discard rate for every RTT and throughput;

FIG. 12 is a descriptive diagram illustrating a different example of the relationship between the discard rate for every RTT and the throughput;

FIG. 13 is a descriptive diagram illustrating a different example of the result of measuring the inter-apparatus quality;

FIG. 14 is a descriptive diagram illustrating one example of an operation that is performed in a case where switching between TCP and a high-speed protocol is performed by a second WAN optimizer;

FIG. 15 is a descriptive diagram illustrating one example of an operation that is performed in a case where switching between TCP and a high-speed protocol is performed by a first WAN optimizer;

FIG. 16A is the first portion of a sequence diagram illustrating one example of an operation that is performed by the communication system when a TCP session is shortened;

FIG. 16B is the second and last portion of the sequence diagram illustrating one example of the operation that is performed by the communication system when a TCP section is shortened;

FIG. 17A is the first portion of a sequence diagram illustrating one example of an operation that is performed by the communication system when a TCP section is lengthened;

FIG. 17B is the second portion of the sequence diagram illustrating one example of the operation that is performed by the communication system when a TCP section is lengthened;

FIG. 18 is the third and last portion of the sequence diagram illustrating one example of the operation that is performed by the communication system when a TCP section is lengthened;

FIG. 19A is the first portion of a flowchart illustrating packet receiving processing that is performed by the WAN optimizer;

FIG. 19B is the second and last portion of the flowchart illustrating the packet receiving processing that is performed by the WAN optimizer;

FIG. 20 is a flowchart illustrating one example of mode transition processing that is performed by the WAN optimizer;

FIG. 21 is the first portion of a flowchart illustrating one example of proxy mode processing that is performed by the WAN optimizer;

FIG. 22 is the first portion of a flowchart illustrating one example of snoop mode processing that is performed by the WAN optimizer;

FIG. 23 is the second portion of the flowchart illustrating one example of proxy mode processing that is performed by the WAN optimizer;

FIG. 24 is the second portion of the flowchart illustrating one example of snoop mode processing that is performed by the WAN optimizer;

FIG. 25 is the third portion of the flowchart illustrating one example of proxy mode processing that is performed by the WAN optimizer;

FIG. 26 is the third and last portion of the flowchart illustrating one example of snoop mode processing that is performed by the WAN optimizer;

FIG. 27 is the fourth and last portion of the flowchart illustrating one example of proxy mode processing that is performed by the WAN optimizer;

FIG. 28 is a descriptive diagram illustrating one example of a format of a management table;

FIG. 29A is a descriptive diagram illustrating one example of a configuration of a packet in TCP;

FIG. 29B is a descriptive diagram illustrating one example of a configuration of a packet in the high-speed protocol;

FIG. 30A is a descriptive diagram illustrating one example of a configuration of a TCP measurement packet;

FIG. 30B is a descriptive diagram illustrating one example of a configuration of a TCP option header;

FIG. 30C is a descriptive diagram illustrating one example of a configuration of a high-speed-protocol measurement packet;

FIG. 31A is a descriptive diagram illustrating one example of an IP header.

FIG. 31B is a descriptive diagram illustrating one example of details of an IP header;

FIG. 32A is a descriptive diagram illustrating one example of a TCP header;

FIG. 32B is a descriptive diagram illustrating one example of details of a TCP header;

FIG. 33 is a descriptive diagram illustrating one example of an “option” type for TCP;

FIG. 34 is the first portion of a descriptive diagram illustrating one example of control data;

FIG. 35 is the second and last portion of the diagram of one example of control data;

FIG. 36 is a descriptive diagram illustrating a modification example of the communication system;

FIG. 37 is a sequence diagram illustrating one example of transmitting and receiving data when position determination is performed in a modification example of an embodiment;

FIG. 38A is the first portion of a sequence diagram illustrating one example of a method of measuring communication quality between the WAN optimizers in the modification example of the embodiment;

FIG. 38B is the second and last portion of the sequence diagram illustrating one example of the method of measuring the communication quality between the WAN optimizers in the modification example of the embodiment;

FIG. 39 is a sequence diagram illustrating one example of an operation that is performed by the communication system when a TCP section is shortened in the modification example of the embodiment; and

FIG. 40 is a sequence diagram illustrating one example of an operation that is performed by the communication system when a TCP section is lengthened in the modification example of the embodiment.

### DESCRIPTION OF EMBODIMENTS

However, in the related art, for example, once communication has been discontinued in order to change a communication apparatus that terminates a specific protocol among multiple communication apparatuses, this causes the problem that it is difficult to dynamically change a termination position of the protocol.

One aspect of the present embodiment is to serve a purpose of making dynamic changing of the termination position of the protocol possible.

A communication system, a communication apparatus, and a communication method according to the present embodiment will be described in detail below referring to the drawings.

### Embodiment

### One Example of a Functional Configuration of the Communication System

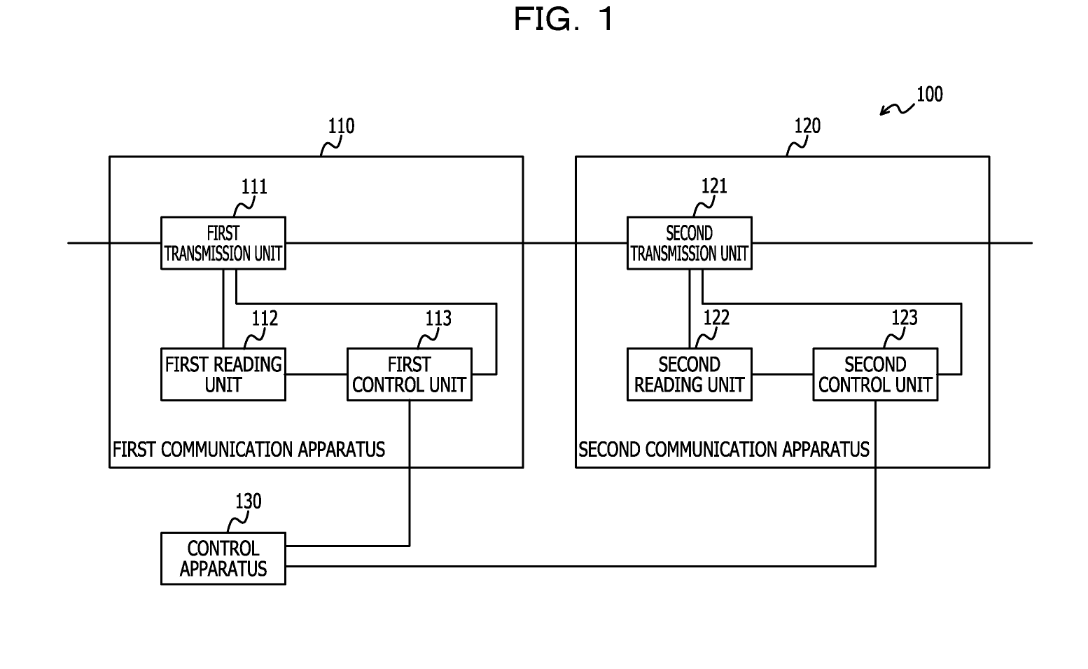

FIG. 1 is a block diagram illustrating a functional configuration of the communication system. First, assuming that a first communication apparatus 110 at the upstream side is in a first transmission state (snoop mode) where protocol conversion is not performed and a second communication apparatus 120 at the downstream side is in a second transmission state (proxy mode) where the protocol conversion is performed, a case will be described where switching of each of the first and second communication apparatuses 110 and 120 between the first and second transmission states is performed. Note that the transmission state may be referred to as “operation mode” in this application.

In FIG. 1, a communication system 100 includes the first communication apparatus 110 and the second communication apparatus 120, and a control apparatus 130. The first communication apparatus 110 includes a first transmission unit 111, a first reading unit 112, and a first control unit 113. The first transmission unit 111 makes it possible to switch between the first transmission state where data received from an upstream communication apparatus is transmitted to the second communication apparatus 120 without being protocol-converted, and the second transmission state where the data is protocol-converted and then is transmitted to the second communication apparatus 120. The protocol, for example, is Transmission Control Protocol (TCP) or a high-speed protocol.

In the first transmission state, the first transmission unit 111 transmits the data, which is received from the upstream communication apparatus using TCP or the high-speed protocol, to the second communication apparatus 120, without the data being protocol-converted. Furthermore, in the second transmission state, the first transmission unit 111 converts the data in TCP, which is received from the upstream communication apparatus, into data in high-speed protocol, and then transmits the resulting data in the high-speed protocol to the second communication apparatus 120. Furthermore, in the second transmission state, the first transmission unit 111, for example, converts the data in the high-speed protocol, which is received from the upstream communication apparatus, into data in TCP, and then transmits the resulting data in TCP to the second communication apparatus 120. Furthermore, for example, in the second transmission state, the first transmission unit 111 converts the data in TCP, which is received from the upstream communication apparatus, into data in the high-speed protocol, and then transmits the resulting data in the high-speed protocol to the second communication apparatus 120.

In a case where the first transmission unit 111 is in the first transmission state, the first reading unit 112 reads data identification information of the data that is transmitted in the state of being included in the data that is transmitted by the first transmission unit 111. The identification information, for example, is a serial number of data that is transmitted and, specifically, a sequence number. The sequence number is stored in data header information. By snooping (looking into), the first reading unit 112 reads the sequence number that is stored in the data header information. The first transmission state refers to the snoop mode in which the reading of the identification information is performed.

In a case where the identification information read by the first reading unit 112 is given identification information, the first control unit 113 causes the first transmission unit 111 to switch from the first transmission state to the second transmission state. The given identification information is a sequence number of waiting. Specifically, in a case where the snooping-acquired sequence number agrees with the sequence number for waiting, the first control unit 113 causes the first transmission unit 111 to switch from the first transmission state to the second transmission state. The second transmission state refers to the proxy mode in which the protocol conversion is performed. Note that the given identification information may be referred to as “a given value”.

The second communication apparatus 120 has a second transmission unit 121, a second reading unit 122, and a second control unit 123. The second transmission unit 121 can be made to switch between the first transmission state where the data received from the first communication apparatus 110 is transmitted to the downstream communication apparatus without being protocol-converted and the second transmission state where the data received from the first communication apparatus 110 is protocol-converted and then is transmitted to the downstream communication apparatus.

In a case where the second transmission unit 121 is in the second transmission state, the second reading unit 122 reads the identification information of the data that is transmitted in the state of being included in the data that is transmitted by the second transmission unit 121. The second reading unit 122 reads the identification information that is detected at the time of the protocol conversion in the second transmission state. For example, by snooping (looking into), the second reading unit 122 reads the sequence number that is stored in the data header information at the time of the protocol conversion in the second transmission state.

In a case where the identification information read by the second reading unit 122 is given identification information, the second control unit 123 causes the second transmission unit 121 to switch from the second transmission state to the first transmission state. Given identification information for the switching of the first control unit 113 between the transmission states and given identification information for the switching of the second control unit 123 between the transmission states are the same as the identification information. That is, in a case where the first control unit 113 and the second control unit 123 read the same given identification information, they perform the switching of the transmission state at the same time. Specifically, the first control unit 113 causes the first transmission unit 111 to switch from the first transmission state to the second transmission state in a case where given identification information is read, and the second control unit 123 causes the second transmission unit 121 to switch from the second transmission state to the first transmission state in a case where given identification information is read.

In this manner, according to the present embodiment, the termination position of the high-speed protocol can be dynamically changed without discontinuing the communication because the switching between the transmission states takes place between the communication apparatuses (between the first communication apparatus 110 and the second communication apparatus 120) that are connected to each other.

Furthermore, in a case where the identification information read by the second reading unit 122 is given identification information, the second control unit 123 sends a control signal indicating that data including given identification information has been received, to the first communication apparatus 110. The control signal is a signal indicating readiness for the switching between the transmission states, such as a synchronization-ready message or a switching-okayed message. Specifically, in a case where the identification information is given identification information, the second control unit 123 sends a control signal to the first communication apparatus 110 and causes the second transmission unit 121 to switch from the proxy mode to the snoop mode. When the switching to the snoop mode takes place, the second transmission unit 121 transmits data to the downstream communication apparatus without performing the protocol conversion on the data.

In a case where the identification information read by the first reading unit 112 is given identification information, the first control unit 113 causes the first transmission unit 111 to interrupt (or suspend) data transmission. In a case where a control signal is received from the second communication apparatus 120, the first control unit 113 causes the first transmission unit 111 to switch from the first transmission state to the second transmission state and then to resume the data transmission. Even though given identification information is read, the first control unit 113 does not cause the first transmission unit 111 to switch the first transmission state to the second transmission state or to resume the data transmission until the control signal is received from the second communication apparatus 120.

Specifically, in the case where the identification information is given identification information, the first control unit 113 causes the first transmission unit 111 to temporarily interrupt the data transmission. Then, the first control unit 113 causes the first transmission unit 111 to switch from the snoop mode to the proxy mode after there is readiness for switching of the second transmission unit 121 between the transmission states. When the switching to the proxy mode takes place, the first transmission unit 111 transmits the protocol-converted data to the second communication apparatus 120. Accordingly, at the time of the dynamic change of the termination position of the high-speed protocol, a amount of data mismatch can be reduced.

Furthermore, in a case where lost data is present among the items of data that are transmitted from the first communication apparatus 110, the second control unit 123 requests the first communication apparatus 110 to retransmit lost data. The lost data, for example, is data that is discarded by the second communication apparatus 120 or is difficult for the second communication apparatus 120 to receive. The second control unit 123, for example, detects the presence or absence of lost data, based on the sequence number. In a case where lost data is detected, the second control unit 123 requests the first communication apparatus 110 to retransmit the lost data.

In a case where the second communication apparatus 120 makes a request for the retransmission of the lost data, the first control unit 113 retransmits the lost data to the second communication apparatus 120. Even though the identification information is given identification information, in a case where the lost data is not received from the first communication apparatus 110, the second control unit 123 does not perform the sending of a control signal to the first communication apparatus 110 and the switching of the second transmission unit 121 between the transmission states.

Furthermore, even though the identification information is given identification information, in a case where the request for the retransmission of the lost data to the second communication apparatus 120 is made, the first control unit 113 performs the switching of the first transmission unit 111 between the transmission states after the lost data is retransmitted. Accordingly, even though the lost data is present before the switching between the transmission states is performed, the first communication apparatus 110 can retransmit the lost data in the same protocol as when the data was first sent. Furthermore, the second communication apparatus 120 can receive the lost data in the same protocol as when the lost data occurred. In this manner, the lost data can be made up for, and the data matching is possible before and after the switching between the transmission states.

Furthermore, the given identification information is information that is determined based on the time the second communication apparatus 120 takes to receive the data sent from the first communication apparatus 110. The time the second communication apparatus 120 takes to receive the data sent from the first communication apparatus 110 is, for example, a delay time indicating a difference between a sending timing and a receiving timing. For example, the longer the delay time, the greater the sequence number for waiting. Accordingly, predetermined identification can be set based on the delay time between each of the first communication apparatus 110 and the second communication apparatus 120, and a synchronization deviation can be suppressed at the time of the switching between the transmission states.

The control apparatus 130 determines identification information, and outputs the given identification information to the first control unit 113 and the second control unit 123. Specifically, the control apparatus 130 determines given identification information based on the time the second communication apparatus 120 takes to receive the data sent from the first communication apparatus 110. The control apparatus 130 may be included in the first communication apparatus 110, be included in the second communication apparatus 120, and be included in an external apparatus.

Furthermore, before communication is established between the first communication apparatus 110 and the second communication apparatus 120, the control apparatus 130 sets the transmission state of the first transmission unit 111 and the transmission state of the second transmission unit 121, based on communication quality (or channel quality) between the first communication apparatus 110 and the second communication apparatus 120. The control apparatus 130 causes the transmission state of the first transmission unit 111 and the transmission state of the second transmission unit 121 to be different for each other. The control apparatus 130, for example, detects a relationship in position between each of the multiple control apparatuses including the first communication apparatus 110 and the second communication apparatus 120 or the communication quality between each communication apparatus. Based on a result of the detection, the control apparatus 130 determines the first communication apparatus 110 and the second communication apparatus 120 as the termination positions of the high-speed protocol and sets their respective transmission states. Accordingly, the communication can be started at the optimal termination position of the high-speed protocol that is determined considering the relationship in position between each of the multiple communication apparatuses or the communication quality between each communication apparatus.

The control apparatus 130 determines whether to change the transmission states of the first transmission unit 111 and the second transmission unit 121 based on communication quality between the first communication apparatus 110 and the second communication apparatus 120. For example, in a case where communication using TCP is performed between the first communication apparatus 110 and the second communication apparatus 120, because many bands are available when a radio link becomes in a non-congested state, the control apparatus 130 determines to change the transmission state in such as manner as to perform communication using the high-speed protocol. The first communication apparatus 110 and the second communication apparatus 120 switch their respective transmission states in a case where the control apparatus 130 determines to change the transmission state and the identification information is given identification information. Accordingly, the optimal termination position of the high-speed protocol can be dynamically changed according to the communication quality between the first communication apparatus 110 and the second communication apparatus 120.

First, assuming that the first communication apparatus 110 at the upstream side is in the second transmission state where the protocol conversion is performed and the second communication apparatus 120 at the downstream side is in the second transmission state where the protocol conversion is not performed, a case will be described where the switching of each of the first and second communication apparatuses 110 and 120 between the first and second transmission states is performed.

In a case where the first transmission unit 111 is in the second transmission state, the first reading unit 112 reads the identification information of the data that is transmitted in the state of being included in the data that is transmitted by the first transmission unit 111. The first reading unit 112 reads the identification information that is detected at the time of the protocol conversion in the second transmission state. For example, by snooping (looking into), the first reading unit 112 reads the sequence number that is stored in the data header information at the time of the protocol conversion in the second transmission state.

In the case where the identification information read by the first reading unit 112 is given identification information, the first control unit 113 causes the first transmission unit 111 to switch from the second transmission state to the first transmission state. Specifically, when a predetermined sequence number is read, the first control unit 113 switches to the snoop mode.

In a case where the second transmission unit 121 is in the first transmission state, the second reading unit 122 reads the identification information of the data that is transmitted in the state of being included in the data that is transmitted by the second transmission unit 121. By snooping (looking into), the second reading unit 122 reads the sequence number that is stored in the data header information. In the case where the identification information read by the second reading unit 122 is given identification information, the second control unit 123 causes the second transmission unit 121 to switch from the first transmission state to the second transmission state. Specifically, where a predetermined sequence number is read by snooping, the second control unit 123 switches to the proxy mode.

Furthermore, in the case where the identification information read by the second reading unit 122 is given identification information, the second control unit 123 sends the control signal indicating that data including given identification information has been received, to the first communication apparatus 110. Furthermore, in the case where the identification information read by the second reading unit 122 is given identification information, in addition to sending a control signal, the second control unit 123 causes the second transmission unit 121 to switch from the first transmission state to the second transmission state.

In the case where the identification information read by the first reading unit 112 is given identification information, the first control unit 113 causes the first transmission unit 111 to interrupt data transmission. Furthermore, the first control unit 113 receives a control signal from the second communication apparatus 120, and thus causes the second transmission unit 121 to switch from the second transmission state to the first transmission state and then to resume the data transmission. The first control unit 113 does not perform the switching of the second transmission unit 121 from the second transmission state to the first transmission state or the resuming of the data transmission until the control signal is received from the second communication apparatus 120.

### One Example of the Communication System

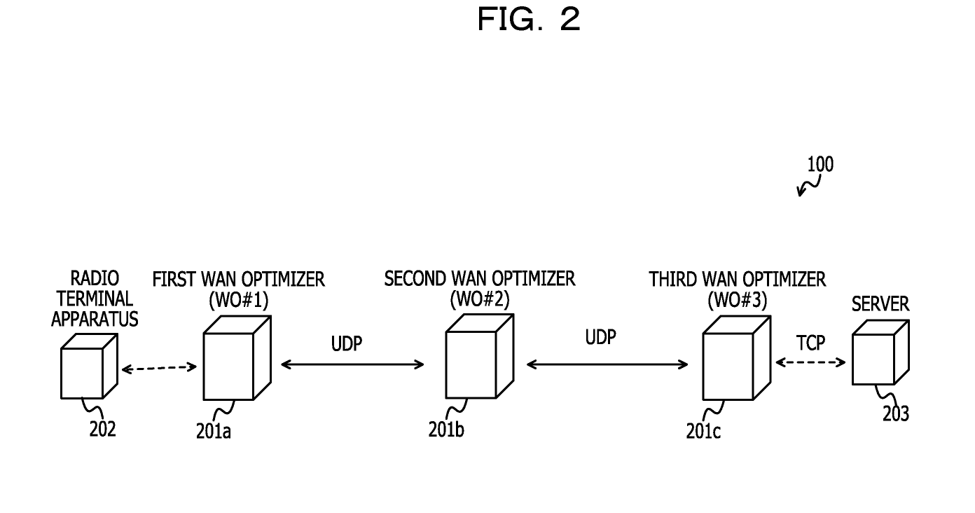

FIG. 2 is a descriptive diagram illustrating one example of the communication system. As illustrated in FIG. 2, the communication system 100 includes WAN optimizers (WO) 201a, 201b, and 201c that are available for communication over a Wide Area Network (WAN), a radio terminal apparatus 202, and a server 203. The first WAN optimizer 201a performs radio communication with the radio terminal apparatus 202 using high-reliability protocol TCP.

The WAN optimizers 201a, 201b, and 201c are realized by the first communication apparatus 110 and the second communication apparatus 120 that are illustrated in FIG. 1. Specifically, a relationship between each WAN optimizer that performs communication (a relationship between the first WAN optimizer 201a and the second WAN optimizer 201b or a relationship between the second WAN optimizer 201b and the third WAN optimizer 201c) is equivalent to a relationship between the first communication apparatus 110 and the second communication apparatus 120.

The first WAN optimizer 201a terminates a TCP session with the radio terminal apparatus 202, and performs cable communication with the second WAN optimizer 201b with the high-speed protocol (for example, User Datagram Protocol (UDP) being substituted for the TCP session). According to the present embodiment, Universal Network Acceleration Protocol (UNAP) that is a UDP-based protocol is used as the high-speed protocol.

In UNAP, a sequence number is appended to packet information in the packet. When a packet is not transferred, with UNAP, it can be determined whether the reason that the packet has not been transferred results from packet loss or packet delay, or from packet delay. For this reason, when the packet loss takes place, only the lost packet can be retransmitted, and thus transmission delay due to retransmission of unnecessary packets can be suppressed, thereby improving a throughput.

As the high-speed protocol, in addition to UNAP, Random Parity Stream (RPS) is available. RPS employs a scheme in which, at the sending side, redundant data that is coded using a predetermined algorithm can be sent in a state of being appended to a packet to be sent, and in which, at the receiving side, redundant data can be decoded, and the presence or absence of packet loss or packet order can be checked. If as a result of the checking, an error is detected, restoration is automatically performed without the data being retransmitted. For this reason, even in an area that has poor quality, with RPS, a decrease in transmission speed can be suppressed, and reliability of UDP can be increased.

The first WAN optimizer 201a, the second WAN optimizer 201b, and the third WAN optimizer 201c each perform cable communication, for example, using the high-speed protocol. Specifically, the first WAN optimizer 201a, the second WAN optimizer 201b, and the third WAN optimizer 201c each perform communication using a high-speed protocol bus. The third WAN optimizer 201c communicates with the server 203 using reliable TCP. The third WAN optimizer 201c terminates the TCP session with the server 203, and performs cable communication with the second WAN optimizer 201b with UDP being substituted for the TCP session.

The radio terminal apparatus 202 is a computer apparatus that is used by a user, such as a personal computer (PC), a notebook PC, a smartphone, a tablet terminal, and a mobile phone. The server 203 is, for example, a server of an overseas cloud data center. The cloud data center, for example, is located overseas or geographically in the far distance. For this reason, Round Trip Time (RTT) tends to be longer. In a case where TCP communication is performed in a link that has a long RTT, this causes the problem that once packet discarding occurs, performance is greatly decreased, and the throughput is difficult to sustain.

To deal with this problem, the average throughput between end devices can be improved by arranging a WAN optimizer 201 (the first WAN optimizer 201a and the third WAN optimizer 201c) at both ends of a WAN. The first WAN optimizer 201a and the third WAN optimizer 201c temporality terminate the TCP session with the radio terminal apparatus 202 or the server 203, convert TCP into the high-speed protocol, and communicate with a different WAN optimizer 201 that is connected.

Furthermore, the first WAN optimizer 201a and the third WAN optimizer 201c that are connected to the radio terminal apparatus 202 or the server 203 convert the high-speed protocol being into TCP and communicate with the radio terminal apparatus 202 or the server 203. Accordingly, it is possible to substitute congestion control of the WAN optimizer 201 for TCP congestion control of the end device. Thus, even though packet discarding occurs, the retransmission can be performed without decreasing the throughput, and the throughput can be improved.

The first WAN optimizer 201a, the second WAN optimizer 201b, and the third WAN optimizer 201c are hereinafter collectively simply referred to as the WAN optimizer 201 as long as it is not desired to particularly distinguish between them for description. Furthermore, in the drawings, the first WAN optimizer 201a is suitably described as “WO #1,” the second WAN optimizer 201b as “WO #2,” and the third WAN optimizer 201c as “WO #3.”

### One Example of a Specific Configuration of the Communication System

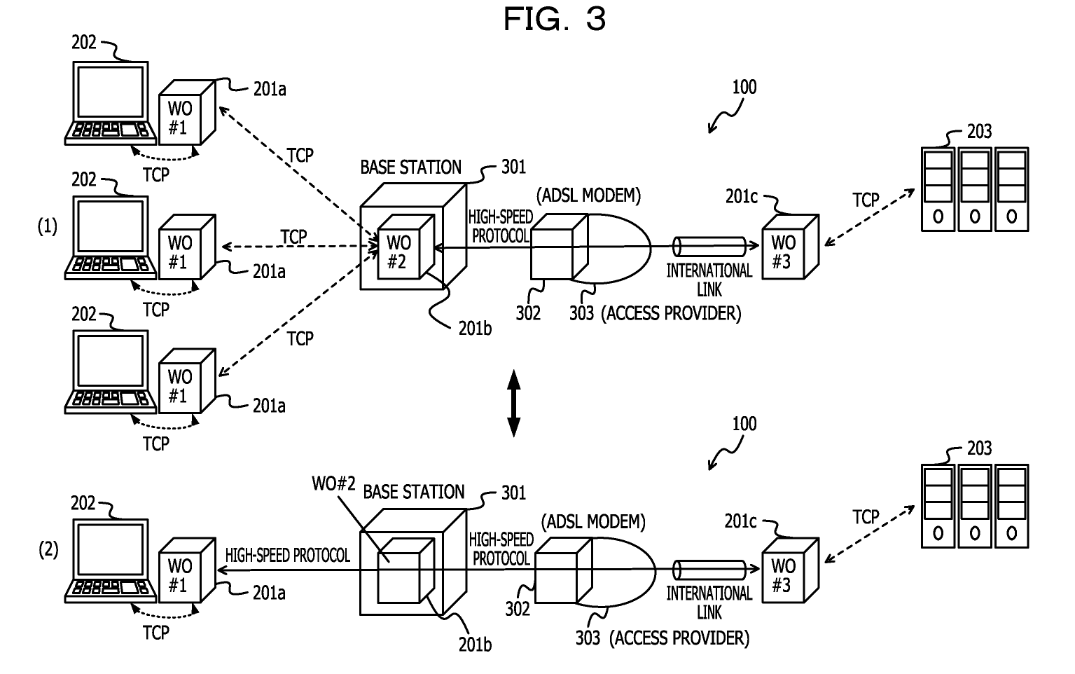

FIG. 3 is a diagram for describing one example of a specific configuration of the communication system. As illustrated in (1) of FIG. 3, the communication system 100 includes multiple radio terminal apparatuses 202, the server 203, and a base station 301. The multiple radio terminal apparatuses 202 include their respective first WAN optimizers 201a. The base station 301 includes the second WAN optimizer 201b. The server 203 performs radio communication with the third WAN optimizer 201c.

The second WAN optimizer 201b and the third WAN optimizer 201c perform communication using the high-speed protocol through an Asymmetric Digital Subscriber Line (ADSL) modem 302 and an access provider 303 over an international link. The first WAN optimizer 201a and the radio terminal apparatus 202 perform radio communication with each other using TCP. The third WAN optimizer 201c and the server 203 perform radio communication using TCP.

Furthermore, as illustrated in (2) of FIG. 3, the first WAN optimizer 201a and the second WAN optimizer 201b can switch between radio communication using TCP and radio communication using the high-speed protocol. For example, because a communication quality of radio communication may easily change, when the radio link is congested, the communication system 100 performs communication using TCP between the first WAN optimizer 201a and the second WAN optimizer 201b. Furthermore, because when the radio link becomes in a non-congested state, many bands are available, the communication system 100 performs communication using the high-speed protocol between the first WAN optimizer 201a and the second WAN optimizer 201b. The switching between the high-speed protocol and TCP will be described in detail below.

Moreover, the communication system 100 is set to typically perform communication using the high-speed protocol without performing the switching between TCP and the high-speed protocol between the second WAN optimizer 201b and the third WAN optimizer 201c. However, the communication system 100 is not limited to this, and may be configured to be able to switch between TCP and the high-speed protocol also between the second WAN optimizer 201b and the third WAN optimizer 201c.

### Configuration Example of a Base Station

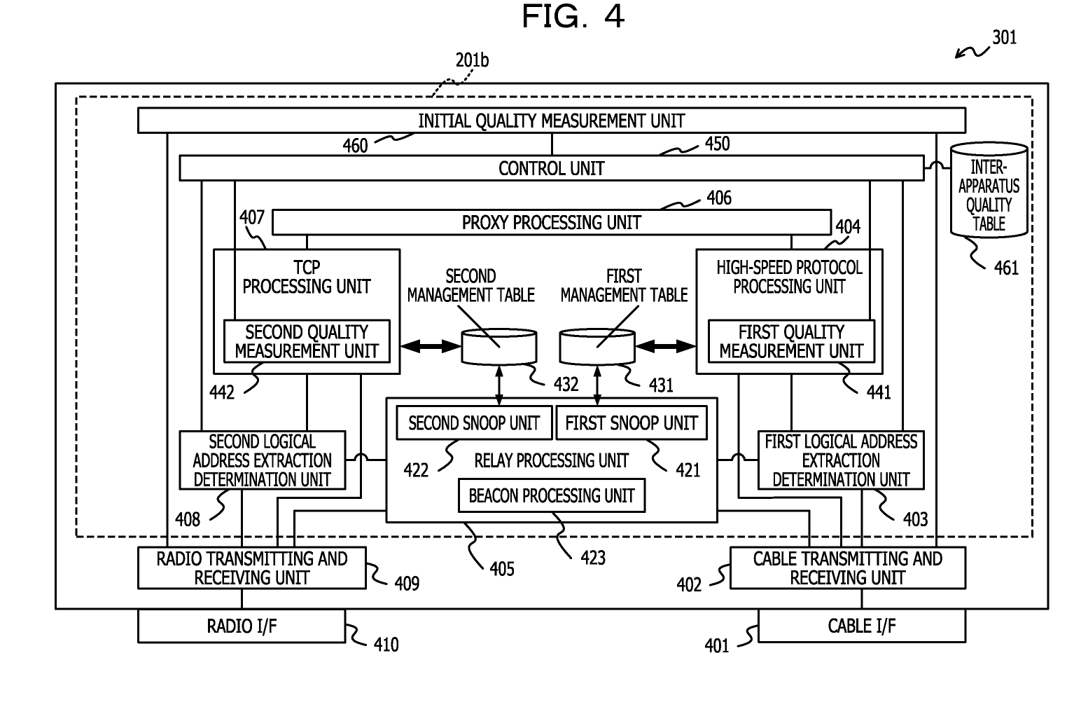

FIG. 4 is a descriptive diagram illustrating a configuration example of a base station. As illustrated in FIG. 4, the base station 301 includes the second WAN optimizer 201b, a cable I/F 401, a cable transmitting and receiving unit 402, a radio transmitting and receiving unit 409, and a radio I/F 410. The second WAN optimizer 201b can enter into any one of the proxy mode in which a protocol of the received data is converted and then the received data is relayed and the snoop mode in which the received data is relayed without the protocol of the received data being converted.

The second WAN optimizer 201b includes a first logical address extraction determination unit 403, a high-speed protocol processing unit 404, a relay processing unit 405, a proxy processing unit 406, a TCP processing unit 407, a second logical address extraction determination unit 408, a control unit 450, and an initial quality measurement unit 460.

First, functional units will be described based on a process in which a signal that is input to the cable I/F 401 flows through each of the functional units into the radio I/F 410 for outputting. The cable I/F 401 outputs an electrical signal or an optical signal from a cable network, to the cable transmitting and receiving unit 402. The cable transmitting and receiving unit 402 converts a cable network frame, which is included in the signal that is output from the cable I/F 401, into an Internet Protocol (IP) packet and outputs a result of the conversion to the first logical address extraction determination unit 403. The first logical address extraction determination unit 403 determines whether or not the packet that is output from the cable transmitting and receiving unit 402 is processed as a packet destined for the second WAN optimizer 201b itself, or is processed for transmission, and, based on a result of the determination, outputs the packet to the high-speed protocol processing unit 404 or the relay processing unit 405. The processing of the packet as one destined for the second WAN optimizer 201b itself is protocol conversion processing that is performed in the proxy mode. The processing for transmission is snooping (looking into) processing.

In a case where it is determined that the packet is processed as one destined for the second WAN optimizer 201b itself, the first logical address extraction determination unit 403 outputs the packet that is output from the cable transmitting and receiving unit 402, to the high-speed protocol processing unit 404. The high-speed protocol processing unit 404 performs high-speed protocol processing on the packet that is determined, by the first logical address extraction determination unit 403, to be one destined for the second WAN optimizer 201b itself, and outputs the data, of which the high-speed protocol is terminated, to the proxy processing unit 406. Furthermore, the high-speed protocol processing unit 404 checks the header information in the packet on which the high-speed protocol processing is performed and stores a protocol communication state in a first management table 431. The sequence number is included in the header information in UNAP that is the high-speed protocol.

The proxy processing unit 406 outputs the data that is output from the high-speed protocol processing unit 404 to the TCP processing unit 407. The TCP processing unit 407 divides the data that is output from the proxy processing unit 406 into packets in TCP and outputs the resulting packets in TCP to the radio transmitting and receiving unit 409. Furthermore, the TCP processing unit 407 checks the header information in the packet that is output to the radio transmitting and receiving unit 409, and stores the protocol communication state in a second management table 432. For example, the sequence number is included in the header information in TCP.

Furthermore, in a case where it is determined that the packet is processed for transmission, the first logical address extraction determination unit 403 outputs the packet, which is output from the cable transmitting and receiving unit 402, to the relay processing unit 405. The relay processing unit 405 transmits the packet, which is output from the first logical address extraction determination unit 403, to the radio transmitting and receiving unit 409 in compliance with a relay rule.

The radio transmitting and receiving unit 409 converts the packet that is output from the TCP processing unit 407 or the relay processing unit 405, into a radio frame, and outputs a radio signal, which results from the conversion, to the radio I/F 410. The radio I/F 410 outputs the radio signal, which is output from the radio transmitting and receiving unit 409, to an external apparatus through a network.

Here, the relay processing unit 405 includes a first snoop unit 421. By snooping in the snoop mode, the first snoop unit 421 reads the header information in the packet when the packet in the high-speed protocol (UNAP) that is output from the first logical address extraction determination unit 403 or the second logical address extraction determination unit 408 is relayed. The first snoop unit 421 stores the protocol communication state, which is indicated by the header information read by snooping, in the first management table 431.

Furthermore, when a transition from the snoop mode to the proxy mode occurs, the first snoop unit 421 performs a number determination of whether or not a predetermined sequence number for performing a data waiting operation on the downstream WAN optimizer 201 has been reached. In a case where the result of the number determination is that it is determined that the predetermined sequence number is reached, the first snoop unit 421 outputs information (control signal) indicating that the data having the predetermined sequence number has been received, to the radio transmitting and receiving unit 409 and the control unit 450. The radio transmitting and receiving unit 409 outputs the radio signal, which results from converting the information being output from the first snoop unit 421 into the radio frame, to the radio I/F 410.

In a case where a configuration is provided in which the WAN optimizer 201 is present further upstream than the second WAN optimizer 201b itself and the switching between the snoop mode and the proxy mode is performed between the apparatuses at the upstream side, as illustrated in FIG. 4, the high-speed protocol processing unit 404 may be configured to include a first quality measurement unit 441. In this case, the first quality measurement unit 441 measures a discard rate, a round trip time, a bandwidth, and the like between the first WAN optimizer 201a, the second WAN optimizer 201b, and the third WAN optimizer 201c that are communication partners, in the proxy mode between the apparatuses at the upstream side. Specifically, the first quality measurement unit 441 measures the discard rate, the round trip time, the bandwidth, and the like, from a retransmission situation of the high-speed protocol, in the proxy mode between the apparatuses at the upstream side. The first quality measurement unit 441 outputs a result of the measuring to the control unit 450. Accordingly, the switching from the proxy mode to the snoop mode can be performed between the apparatuses at the upstream side.

Next, the functional units will be described based on a process in which a signal that is input to the radio I/F 410 flows through each of the functional units into the cable I/F 401 for outputting. The radio I/F 410 outputs the radio signal from the radio network, to the radio transmitting and receiving unit 409. The radio transmitting and receiving unit 409 converts the radio frame of the radio signal that is output from the radio I/F 410, into the IP packet, and outputs a result of the conversion to the second logical address extraction determination unit 408. The second logical address extraction determination unit 408 determines whether or not the packet that is received from the radio transmitting and receiving unit 409 is processed as a packet destined for the second WAN optimizer 201b itself, or is processed for transmission, and, based on a result of the determination, outputs the packet to the TCP protocol processing unit 407 or the relay processing unit 405.

In the case where it is determined that the packet is processed as one destined for the second WAN optimizer 201b itself, the second logical address extraction determination unit 408 outputs the packet that is output from the radio transmitting and receiving unit 409, to the TCP protocol processing unit 407. The TCP protocol processing unit 407 performs TCP processing on the packet that is determined, by the second logical address extraction determination unit 408, to be one destined for the second WAN optimizer 201b itself, and outputs the data, of which TCP is terminated, to the proxy processing unit 406. Furthermore, the TCP processing unit 407 stores in the second management table 432 the protocol communication state that is indicated by the header information in the packet on which the TCP processing is performed.

The proxy processing unit 406 outputs the data that is output from the TCP processing unit 407, to the high-speed protocol processing unit 404. The high-speed protocol processing unit 404 divides the data that is output from the proxy processing unit 406 into packets in the high-speed protocol, and output the resulting packets in the high-speed protocol to the cable transmitting and receiving unit 402. The high-speed protocol processing unit 404 stores in the first management table 431 the protocol communication state that is indicated by the header information in the packet that is output to the cable transmitting and receiving unit 402.

Furthermore, in the case where it is determined that the packet is processed for transmission, the second logical address extraction determination unit 408 outputs the packet, which is output from the radio transmitting and receiving unit 409, to the relay processing unit 405. The relay processing unit 405 transmits the packet, which is output from the second logical address extraction determination unit 408, to the cable transmitting and receiving unit 402 in compliance with a relay rule.

The cable transmitting and receiving unit 402 converts the packet that is output from the high-speed protocol processing unit 404 or the relay processing unit 405, into a cable frame, and outputs an electrical signal or an optical signal, which results from the conversion, to the cable I/F 401. The radio I/F 401 outputs the electrical signal or the radio signal, which is output from the cable transmitting and receiving unit 402, to an external apparatus through a network.

In the case where a configuration is provided in which the WAN optimizer 201 is present further upstream than the second WAN optimizer 201b itself and the switching between the snoop mode and the proxy mode is performed between the apparatuses at the upstream side, as illustrated in FIG. 4, the relay processing unit 405 may be configured to include a second snoop unit 422. By snooping in the snoop mode, the second snoop unit 422 reads the header information in the packet when the packet in TCP that is output from the first logical address extraction determination unit 403 or the second logical address extraction determination unit 408 is relayed. Then, the first snoop unit 422 stores the protocol communication state, which is indicated by the header information read by snooping, in the second management table 432.

Furthermore, when the transition from the snoop mode to the proxy mode occurs, the second snoop unit 422 performs the number determination of whether or not a predetermined sequence number for allowing the data to have a rendezvous with the upstream WAN optimizer 201 has been reached. In the case where it is determined as a result of the number determination that the predetermined sequence number has been reached, the second snoop unit 422 outputs information (control signal) indicating that the data having the predetermined sequence number has been received, to the cable transmitting and receiving unit 402 and the control unit 450. The cable transmitting and receiving unit 402 outputs the signal, which results from converting the information being output from the second snoop unit 422 into the cable frame, to the cable I/F 401. Accordingly, the switching from the snoop mode to the proxy mode can be performed between the apparatuses at the upstream side.

Furthermore, the TCP processing unit 407 includes a second quality measurement unit 442. The second quality measurement unit 442 measures the discard rate or the round trip time, and the bandwidth between the first WAN optimizer 201a, the second WAN optimizer 201b, and the third WAN optimizer 201c that are communication partners. The second quality measurement unit 442 measures the discard rate, the round trip time, the bandwidth, and the like, from a retransmission situation of TCP, for example, in proxy mode. The second quality measurement unit 442 outputs a result of the measuring to the control unit 450.

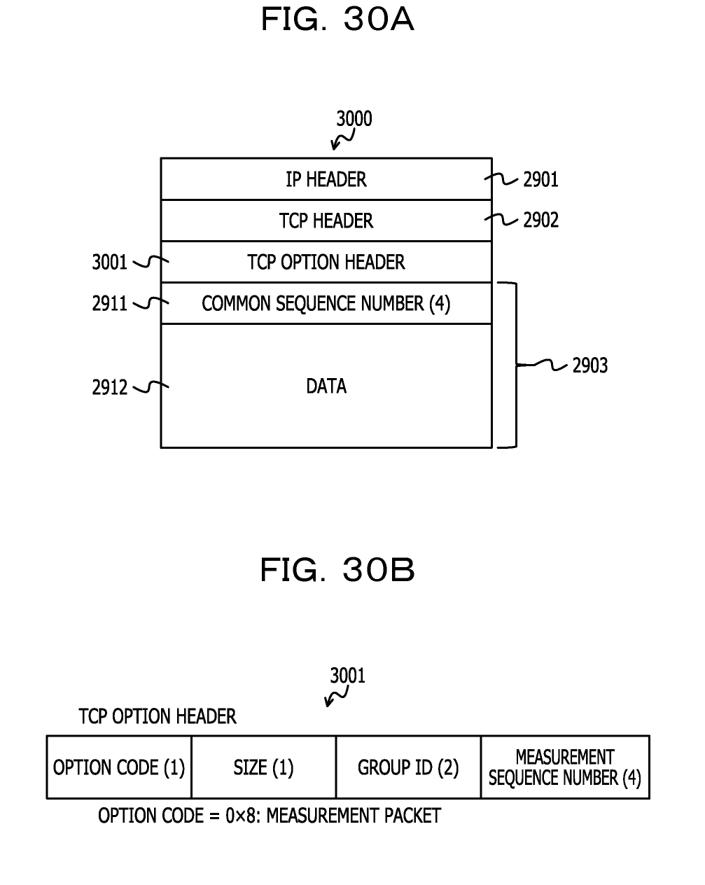

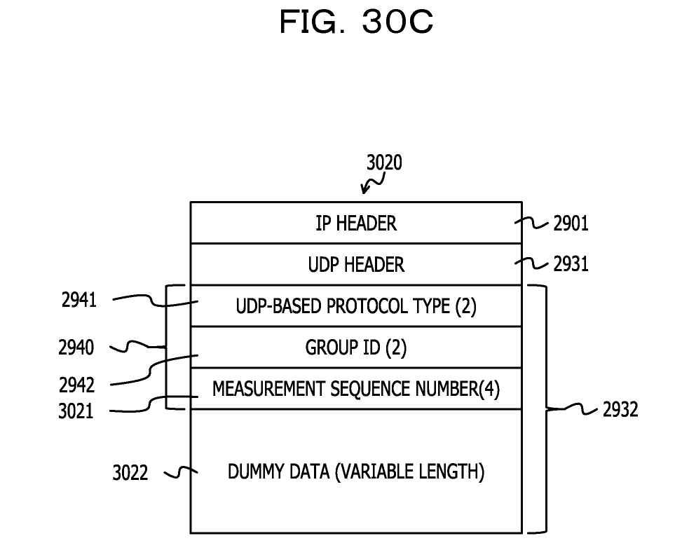

Furthermore, the relay processing unit 405 includes a beacon processing unit 423. The beacon processing unit 423 appends beacon information to a SYN (synchronize) packet that is relayed, or a SYN/ACK packet. The beacon processing unit 423, for example, stores the beacon information in a TCP option header (refer to FIG. 30A). Furthermore, the beacon processing unit 423 refers to the beacon information that is stored in the TCP option header, and thus detects a relationship in position between the first WAN optimizer 201a, the second WAN optimizer 201b, and the third WAN optimizer 201c that are present on a communication path.

Furthermore, the control unit 450 exchanges control information with a different WAN optimizer that is a candidate for a protocol termination point subject to switching, and causes the base station 301 to switch communication mode from the proxy mode to the snoop mode, or from the snoop mode to the proxy mode. For example, the control unit 450 performs mode switching when receiving information (control signal) indicating that data of a predetermined sequence number has been received by the first snoop unit 421 or the second snoop unit 422 of the first WAN optimizer 201a that is illustrated in FIG. 4. Furthermore, the control unit 450 enters the relationship in position between each of the first WAN optimizer 201a, the second WAN optimizer 201b, and the third WAN optimizer 201c and a result of measuring into an inter-apparatus quality table 461, based on the result of the measuring by the first quality measurement unit 441, the second quality measurement unit 442, or the initial quality measurement unit 460.

Furthermore, the control unit 450, for example, instructs the proxy processing unit 406 or the relay processing unit 405 to interrupt packet transmission processing at the time of the mode switching. The proxy processing unit 406 or the relay processing unit 405 temporarily interrupts the packet transmission processing at the instruction of the control unit 450 to interrupt the transmission processing. Furthermore, the control unit 450 performs control in such a manner that the proxy processing unit 406 and the relay processing unit 405 resume the packet transmission processing.

In a case where a path using the high-speed protocol, such as when the communication is started, is not established between each of the first WAN optimizer 201a, the second WAN optimizer 201b, and the third WAN optimizer 201c, the initial quality measurement unit 460 measures the quality (the discard rate or the round trip time, and the bandwidth) between each of the first WAN optimizer 201a, the second WAN optimizer 201b, and the third WAN optimizer 201c. Furthermore, the control unit 450 enters the relationship in position between each of the first WAN optimizer 201a, the second WAN optimizer 201b, the third WAN optimizer 201c and the quality such as the discard rate or the round trip time between each of the first WAN optimizer 201a, the second WAN optimizer 201b, and the third WAN optimizer 201c into the inter-apparatus quality table 461, based on a result of the measuring by the initial quality measurement unit 460.

### Configuration Example of the Radio Terminal Apparatus

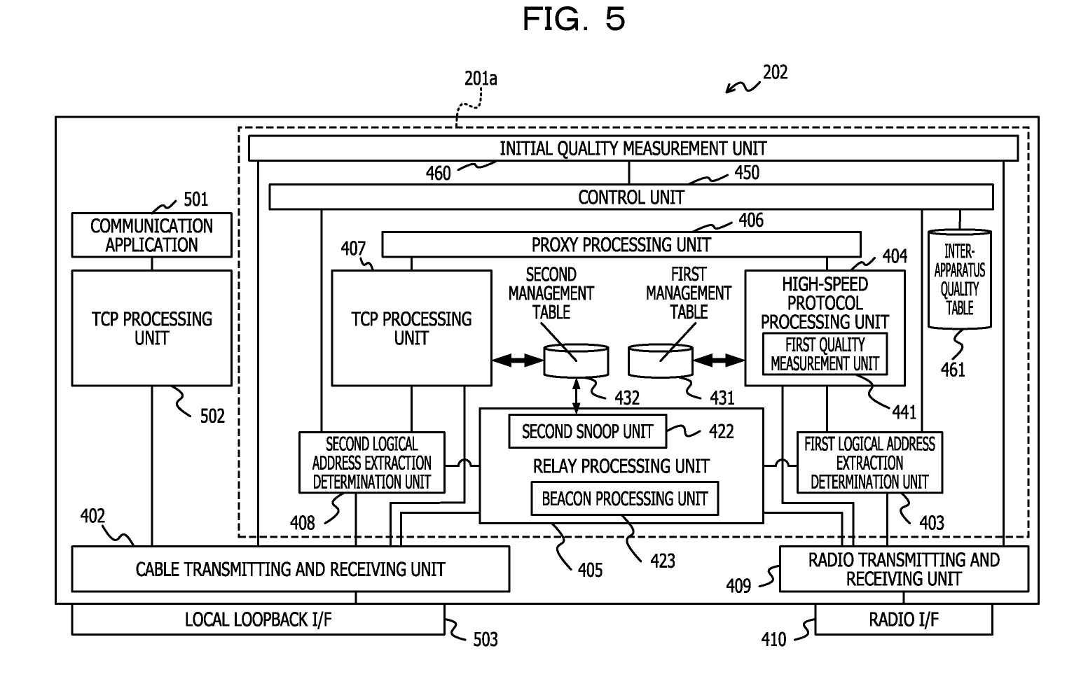

FIG. 5 is a descriptive diagram illustrating a configuration example of the radio terminal apparatus. The same functional units as those of the base station 301 described referring to FIG. 4 are given the same reference numerals, and descriptions of them are omitted when descriptions are provided referring to FIG. 5. In FIG. 5, the radio terminal apparatus 202 includes the first WAN optimizer 201a. The first WAN optimizer 201a can enter into any one of the proxy mode in which a protocol of the received data is converted and then the received data is relayed and the snoop mode in which the received data is relayed without the protocol of the received data being converted.

For example, the first WAN optimizer 201a can be realized by executing predetermined software that causes a computer apparatus, such as the radio terminal apparatus 202, to perform functions of the WAN optimizer 201. The radio terminal apparatus 202, for example, can perform the functions of the WAN optimizer 201 by executing predetermined software on a server, or by executing predetermined software installed on the radio terminal apparatus 202 itself.

The radio terminal apparatus 202 includes a communication application 501, a TCP processing unit 502, and a local loopback I/F 503. Furthermore, the radio terminal apparatus 202 does not include, for example, the cable I/F 401, the first snoop unit 421, and the second quality measurement unit 442, among the functional units that the base station 301 includes (refer to FIG. 4).

The communication application 501 is a functional unit that provides a service directly to the user while performing communication on the radio terminal apparatus 202 over a network. The TCP processing unit 502 divides the data into packets in TCP and outputs the resulting packets in TCP to the cable transmitting and receiving unit 402. The cable transmitting and receiving unit 402 outputs the packet that is output from the TCP processing unit 502, to the local loopback I/F 503.

The local loopback I/F 503 loops back the packet that is sent as a result of the cable transmitting and receiving unit 402 performing sending processing, and outputs the resulting packet to the cable transmitting and receiving unit 402. The cable transmitting and receiving unit 402 outputs the packet that is output from the local loopback I/F 503, to the second logical address extraction determination unit 408.

The second logical address extraction determination unit 408 determines whether or not the packet that is received from the cable transmitting and receiving unit 402 is processed as a packet destined for the second WAN optimizer 201b itself, or is processed for transmission, and, based on a result of the determination, outputs the packet to the TCP protocol processing unit 407 or the relay processing unit 405. In the case where it is determined that the packet is processed as one destined for the second WAN optimizer 201b itself, the second logical address extraction determination unit 408 outputs the packet that is output from the cable transmitting and receiving unit 402, to the TCP protocol processing unit 407. Furthermore, in the case where it is determined that the packet is processed for transmission, the second logical address extraction determination unit 408 outputs the packet, which is output from the cable transmitting and receiving unit 402, to the relay processing unit 405.

Furthermore, the radio transmitting and receiving unit 409 converts the radio frame of the radio signal that is output from the radio I/F 410, into the IP packet, and outputs a result of the conversion to the first logical address extraction determination unit 403. The first logical address extraction determination unit 403 determines whether or not the packet that is received from the radio transmitting and receiving unit 409 is processed as a packet destined for the second WAN optimizer 201b itself, or is processed for transmission, and, based on a result of the determination, outputs the packet to the high-speed protocol processing unit 404 or the relay processing unit 405.

In the case where it is determined that the packet is processed as one destined for the second WAN optimizer 201b itself, the first logical address extraction determination unit 403 outputs the packet that is output from the radio transmitting and receiving unit 409, to the high-speed protocol processing unit 404. Furthermore, in the case where it is determined that the packet is processed for transmission, the first logical address extraction determination unit 403 outputs the packet, which is output from the radio transmitting and receiving unit 409, to the relay processing unit 405.

### One Example of a Software Configuration of the Computer Apparatus Such as the WAN Optimizer and the Radio Terminal Apparatus

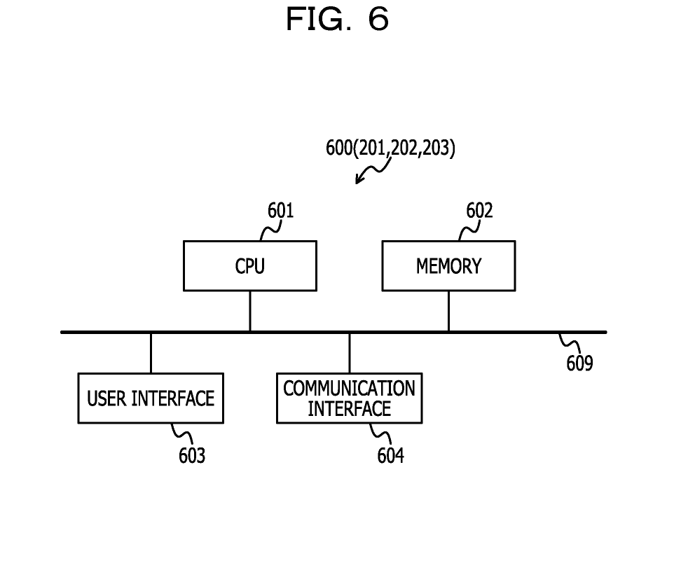

FIG. 6 is a diagram illustrating one example of a software configuration of the computer apparatus. As illustrated in FIG. 6, a computer apparatus 600, such as the WAN optimizer 201, the radio terminal apparatus 202, and the server 203, includes a central processing unit (CPU) 601, a memory 602, a user interface 603, and a communication interface 604. The CPU 601, the memory 602, the user interface 603, and the communication interface 604 are connected with one another by the bus 609.

The CPU 601 manages control of the entire computer apparatus 600. The memory 602, for example, includes a main memory and an auxiliary memory. The memory, for example, is a random access memory (RAM). The main memory is used as a work area of the CPU 601. The auxiliary memory is a nonvolatile memory such as a magnetic disk, an optical disc, and a flash memory. Various programs for causing the computer apparatus 600 to operate are stored in the auxiliary memory. The programs stored in the auxiliary memory are loaded onto the main memory and are executed by the CPU 601.

The user interface 603, for example, includes an input device into which a user operation is input from a user, an output device that outputs information to the user, and the like. The input device can be realized by, for example, a touch panel, keys (for example, a keyboard), a remote controller, or the like. The output device can be realized by, for example, a touch panel, a display, a speaker, or the like. The user interface 603 is controlled by the CPU 601.

The communication interface 604, for example, is a communication interface that performs communication between the computer apparatus 600 and an external apparatus in a radio or cable manner. The communication interface 604 is controlled by the CPU 601.

Functions of the first transmission unit 111, the first reading unit 112, and the first control unit 113 that are illustrated in FIG. 1 are realized by causing the CPU 601 to execute programs that are stored in the memory 602 or by the communication interface 604. Functions of the second transmission unit 121, the second reading unit 122, and the second control unit 123 that are illustrated in FIG. 1 are realized by causing the CPU 601 to execute programs that are in the memory 602, or by the communication interface 604.

Furthermore, the cable I/F 401, the radio I/F 410, and the local loopback I/F 503 that are illustrated in FIG. 4 or 5 are realized by the communication interface 604. Furthermore, functions of the cable transmitting and receiving unit 402, the first logical address extraction determination unit 403, the high-speed protocol processing unit 404, the relay processing unit 405, the proxy processing unit 406, the TCP processing unit 407, the second logical address extraction determination unit 408, the radio transmitting and receiving unit 409, the communication application 501, and the TCP processing unit 502 are realized by causing the CPU 601 to execute programs that are stored in the memory 602. Furthermore, the first management table 431, the second management table 432, and the inter-apparatus quality table 461 that are illustrated in FIG. 5 are realized by the memory 602.

### One Example of Transmitting and Receiving Data at the Time of Performing Position Determination

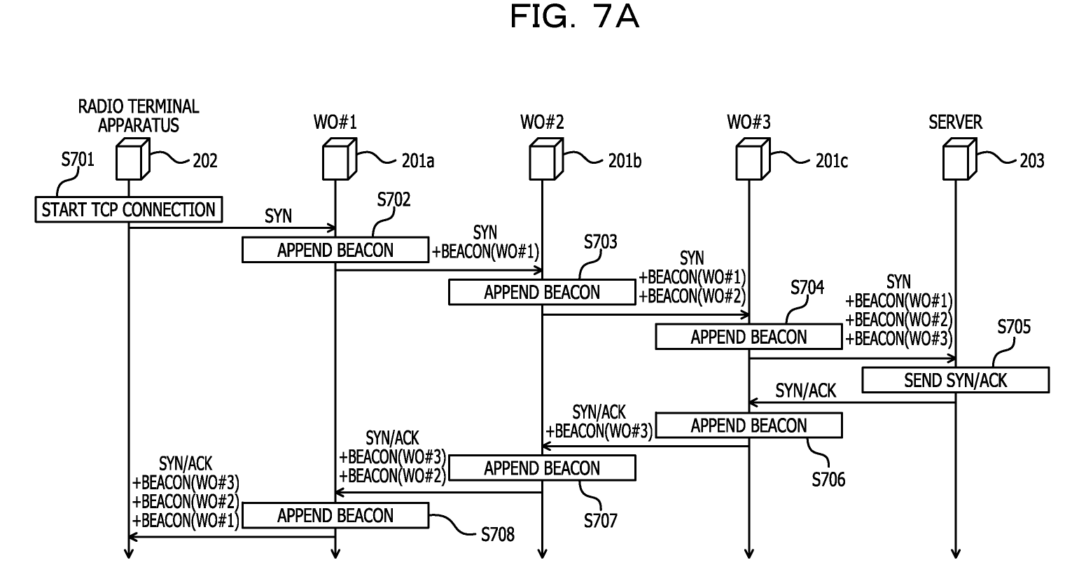

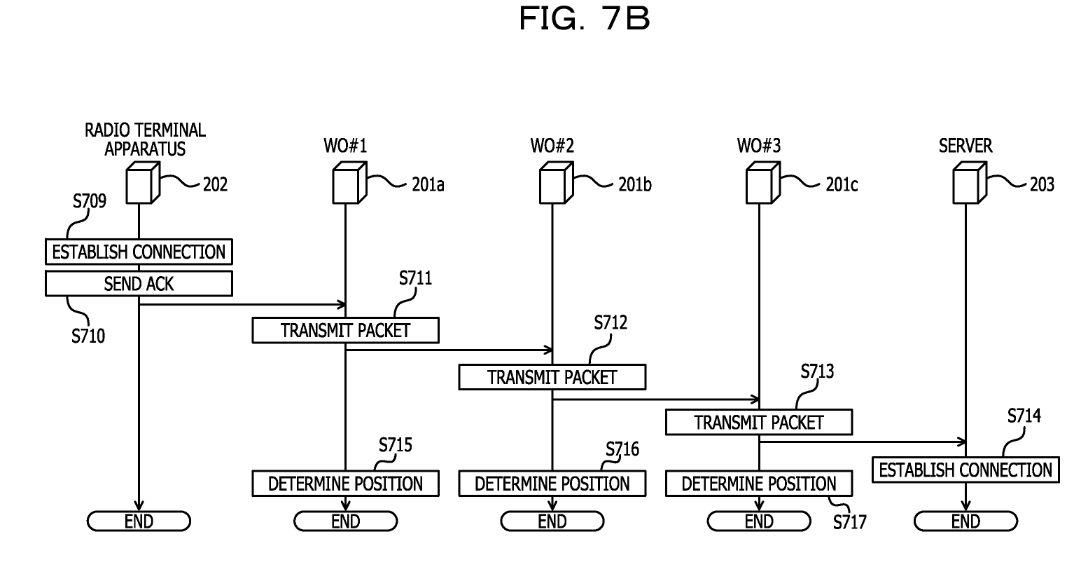

Each of the first WAN optimizer 201a, the second WAN optimizer 201b, and the third WAN optimizer 201c determines positions of the other WAN optimizers 201 on a communication path. A procedure for performing position determination is described referring to FIGS. 7A and 7B.

FIG. 7A is a first half portion of a sequence diagram illustrating an example of transmitting and receiving data at the time of performing the position determination. FIG. 7B is a second half of the sequence diagram illustrating an example of transmitting and receiving the data at the time of performing the position determination. First, in performing the TCP communication, the radio terminal apparatus 202 sends a SYN packet in TCP to the first WAN optimizer 201a in order to start a 3-way handshake that is a connection procedure for a TCP session with a connection destination (Step S701).

Moreover, according to the present embodiment, the first WAN optimizer 201a is included in the radio terminal apparatus 202, but the radio terminal apparatus 202 and the first WAN optimizer 201a are individually suitably described for convenience in description. Specifically, an entity that performs a function of the WAN optimizer 201 in the radio terminal apparatus 202 is set to be the first WAN optimizer 201a, and an entity that performs a function other than the function of the WAN optimizer 201 in the radio terminal apparatus 202 is set to be the radio terminal apparatus 202.

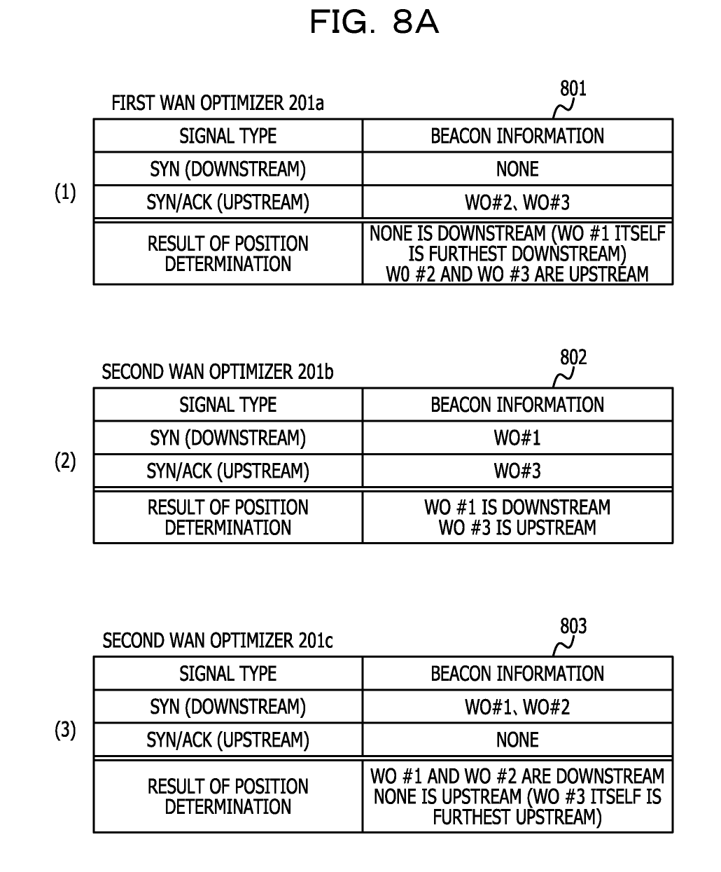

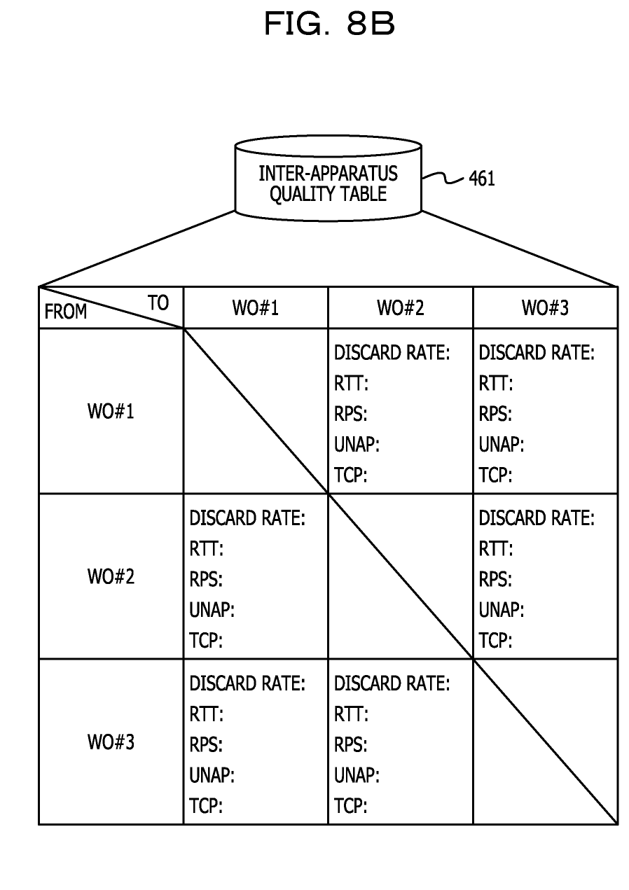

The first WAN optimizer 201a stores received information (refer to FIG. 8A) indicating that beacon information is not appended to the SYN packet received from the radio terminal apparatus 202. The beacon information will be described in detail below, but for example, is stored in the TCP option header. The first WAN optimizer 201a appends the beacon information indicating the first WAN optimizer 201a to the SYN packet received from the radio terminal apparatus 202, and sends the SYN packet to the second WAN optimizer 201b (Step S702).

The second WAN optimizer 201b detects the beacon information indicating the first WAN optimizer 201a, which is appended to the SYN packet received from the first WAN optimizer 201a, and stores the detected beacon information as the received information. Moreover, the second WAN optimizer 201b appends beacon information indicating the second WAN optimizer 201b itself to the SYN packet, and sends the SYN packet to the third WAN optimizer 201c (Step S703). The third WAN optimizer 201c detects the beacon information that is appended to the SYN packet received from the second WAN optimizer 201b, and stores the detected beacon information as the received information. Moreover, the third WAN optimizer 201c appends beacon information indicating the third WAN optimizer 201c itself to the SYN packet and sends the SYN packet to the server 203 (Step S704).

Because the beacon information appended to the SYN packet from the third WAN optimizer 201c is difficult to recognize, the server 203 disregards the beacon information. Then, the server 203 sends a SYN/ACK packet to the third WAN optimizer 201c (Step S705) according to the 3-way handshake procedure.

The third WAN optimizer 201c stores the received information indicating that the beacon information is not appended to the SYN/ACK packet received from the server 203. Moreover, the third WAN optimizer 201c appends beacon information indicating the third WAN optimizer 201c itself to the SYN/ACK packet received from the server 203, and sends the SYN/ACK packet to the second WAN optimizer 201b (Step S706).

The second WAN optimizer 201b detects the beacon information that is appended to the SYN/ACK packet received from the third WAN optimizer 201c, and stores the detected beacon information as the received information. Moreover, the second WAN optimizer 201b appends beacon information indicating the second WAN optimizer 201b itself to the SYN/ACK packet, and sends the SYN/ACK packet to the first WAN optimizer 201a (Step S707). The first WAN optimizer 201a detects the beacon information that is appended to the SYN/ACK packet received from the second WAN optimizer 201b, and stores the detected beacon information as the received information. Moreover, the first WAN optimizer 201a appends beacon information indicating the first WAN optimizer 201a itself to the SYN/ACK packet, and sends the SYN/ACK packet to the radio terminal apparatus 202 (Step S708).

Because the beacon information appended to the SYN/ACK packet from the first WAN optimizer 201a is difficult to recognize, the radio terminal apparatus 202 disregards the beacon information. Then, the radio terminal apparatus 202 establishes a network according to the 3-way handshake procedure (Step S709). Moreover, the radio terminal apparatus 202 sends an ACK in response to the SYN/ACK packet (Step S710).

When receiving the ACK from the radio terminal apparatus 202, the first WAN optimizer 201a sends the received ACK to the second WAN optimizer 201b (Step S711). When receiving the ACK from the first WAN optimizer 201a, the second WAN optimizer 201b sends the received ACK to the third WAN optimizer 201c (Step S712). When receiving the ACK from the second WAN optimizer 201b, the third WAN optimizer 201c sends the received ACK to the server 203 (Step S713). When receiving the ACK from the third WAN optimizer 201c, the server 203 establishes a network (Step S714).

Next, each of the first WAN optimizer 201a, the second WAN optimizer 201b, and the third WAN optimizer 201c performs the position determination (Steps S715, S716, and S717). When performing the position determination, a position determination method that is illustrated in FIG. 8A is used through the use of the received information that the WAN optimizer 201 stores by the processing described above.

### One Example of the Position Determination Method

FIGS. 8A(1) to 8A(3) are diagrams for describing one example of the position determination method. In FIGS. 8A(1) to 8A(3), received pieces of information 801, 802, and 803 each have a signal type and beacon information. In the received pieces of information 801, 802, and 803, a result of the position determination indicates a relationship in position between each apparatus and the other apparatuses from the signal type and the beacon information.

“SYN” depicted in the received pieces of information 801, 802, and 803 indicates a situation where the WAN optimizer 201 corresponding to the beacon information appended to the SYN packet is present. Specifically, “SYN” in each of the received pieces of information 801, 802, and 803 indicates that the WAN optimizer 201 indicated by the received beacon information is positioned downstream. With the beacon information appended to the SYN packet and a sequence to which the beacon information is appended, the WAN optimizer 201 can determine a situation where the WAN optimizer 201 is present downstream. Furthermore, in a case where the beacon information is not appended to the SYN packet, the WAN optimizer 201 can determine that the WAN optimizer 201 itself is furthest downstream. The first WAN optimizer 201a is set to be a representative WAN optimizer apparatus that manages an optimal protocol in the present communication session and an optional application section for the optimal protocol. In other words, the first WAN optimizer 201a has a function of the control apparatus 130 illustrated in FIG. 1.

Furthermore, “SYN/ACK” shown in the received pieces of information 801, 802, and 803 indicates a situation where the WAN optimizer 201 corresponding to the beacon information appended to the SYN/ACK packet is present. Specifically, “SYN/ACK” in each of the received pieces of information 801, 802, and 803 indicates that the WAN optimizer 201 indicated by the received beacon information is positioned upstream. With the beacon information appended to the SYN/ACK packet and a sequence to which the beacon information is appended, the WAN optimizer 201 can determine a situation where the WAN optimizer 201 is present upstream. Furthermore, in a case where the beacon information is not appended to the SYN/ACK packet, the WAN optimizer 201 can determine that the WAN optimizer 201 itself is furthest upstream.

For detailed description, FIG. 8A(1) illustrates the received information 801 of the first WAN optimizer 201a. As illustrated in the received information 801, in the case of the first WAN optimizer 201a, the beacon information is not appended to the SYN packet. Furthermore, in the case of the first WAN optimizer 201a, the beacon information corresponding to the second WAN optimizer 201b and the third WAN optimizer 201c is appended to the SYN/ACK packet. For this reason, the first WAN optimizer 201a can determine that the first WAN optimizer 201a itself is positioned furthest downstream, the second WAN optimizer 201b is positioned one step upward, and the third WAN optimizer 201c is positioned two steps upward.

FIG. 8A(2) illustrates the received information 802 of the second WAN optimizer 201b. As illustrated in the received information 802, in the case of the second WAN optimizer 201b, the beacon information corresponding to the first WAN optimizer 201a is appended to the SYN packet. Furthermore, in the second WAN optimizer 201b, the beacon information corresponding to the third WAN optimizer 201c is appended to the SYN/ACK packet. For this reason, the second WAN optimizer 201b can determine that the first WAN optimizer 201a itself is positioned one step downward, and the third WAN optimizer 201c is positioned one step upward.

FIG. 8A(3) illustrates the received information 803 of the third WAN optimizer 201c. As illustrated in the received information 803, in the case of the third WAN optimizer 201c, the beacon information corresponding to the first WAN optimizer 201a and the second WAN optimizer 201b is appended to the SYN packet. Furthermore, in the case of the third WAN optimizer 201c, the beacon information is not appended to the SYN/ACK packet. For this reason, the third WAN optimizer 201c can determine that the third WAN optimizer 201c itself is positioned furthest upstream, the second WAN optimizer 201b is positioned one step downward, and the first WAN optimizer 201a is positioned two steps downward.

### One Example of Contents Entered into the Inter-Apparatus Quality Table

FIG. 8B is a descriptive diagram illustrating an example of contents entered into the inter-apparatus quality table. The communication quality of each of the WAN optimizer 201 at the sending side and the WAN optimizer 201 at the receiving side between the WAN optimizer 201 at the sending side and the WAN optimizer 201 at the receiving side is recorded in the inter-apparatus quality table 461 that is illustrated in FIG. 8B. The communication quality is, for example, in terms of a packet discard rate, RTT, a communication speed of the high-speed protocol, and a communication speed of TCP. According to the present embodiment, UNAP is used as one example of the high-speed protocol.

With the position determination in FIG. 8A(1) to 8A(3), each of the WAN optimizer 201a, the second WAN optimizer 201b, and the third WAN optimizer 201c knows which position on the communication path each of the first WAN optimizer 201a, the second WAN optimizer 201b, and the third WAN optimizer 201c is present on. Each of the first WAN optimizer 201a, the second WAN optimizer 201b, and the third WAN optimizer 201c enters the WAN optimizer 201, of which the position is determined by the position determination, into the inter-apparatus quality table 461. Moreover, at a stage where the WAN optimizer 201 is entered into the inter-apparatus quality table 461, the inter-apparatus quality table 461 has no entry.

### One Example of a Method of Measuring Inter-Apparatus Quality Between the WAN Optimizers

Here, the measuring of the inter-apparatus on the network is described which is performed by the WAN optimizer 201 in determining an optimal acceleration section where the high-speed protocol is used. Specifically, a case is described where WAN optimizer 201 sends a measurement packet using an IP protocol that is included in the beacon information, to the other WAN optimizers, and the communication quality (for example, RTT or the discard rate) between each of the first WAN optimizer 201a, the second WAN optimizer 201b, and the third WAN optimizer 201c is measured.

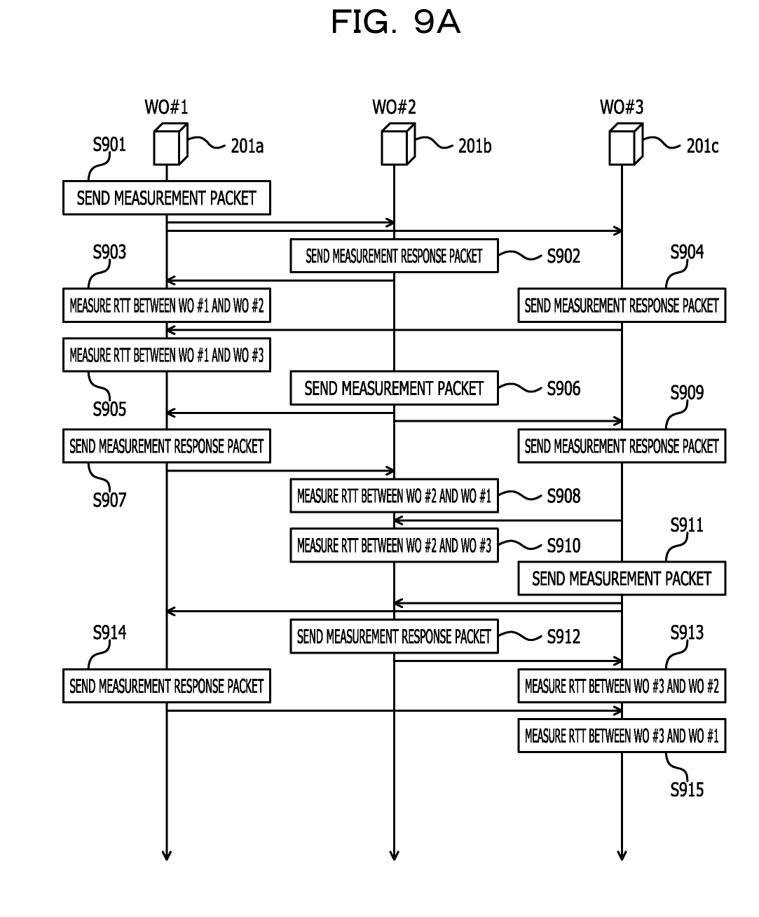

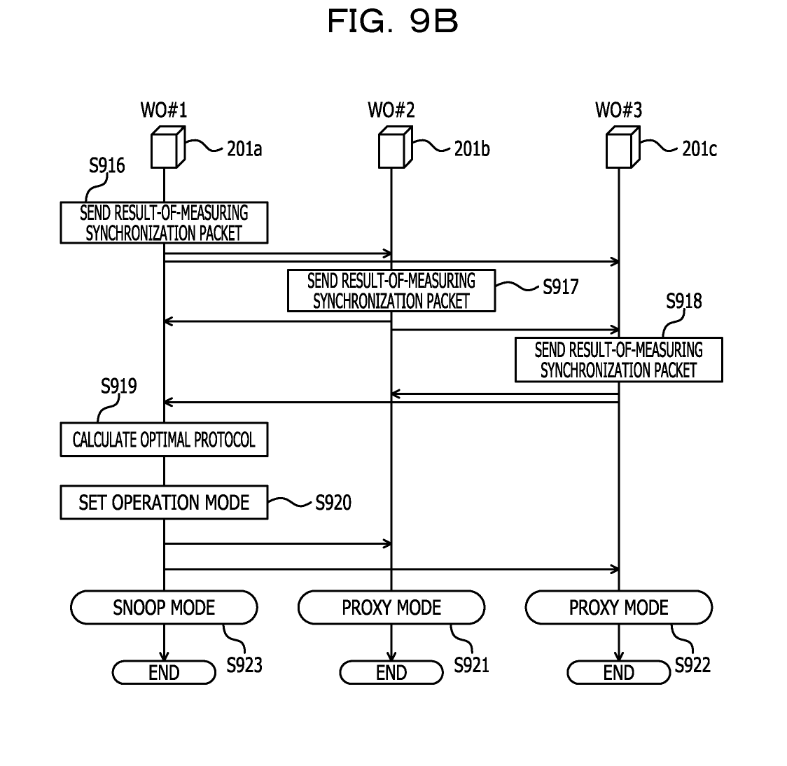

FIG. 9A is the first portion of a sequence diagram illustrating one example of a method of measuring the communication quality between the WAN optimizers. FIG. 9B is the second and last portion of the sequence diagram illustrating one example of the method of measuring the communication quality between WAN optimizers. First, the first WAN optimizer 201a sends the measurement packet including a time stamp indicating the sending time to the second WAN optimizer 201b and the third WAN optimizer 201c (Step S901). Because even if packet loss occurs, there is no obstacle to measuring of the communication quality, for example, the high-speed protocol is used in the measurement packet.

When receiving the measurement packet including the time stamp from the first WAN optimizer 201a, the second WAN optimizer 201b sends a measurement response packet to the first WAN optimizer 201a (Step S902). When receiving the measurement response packet from the second WAN optimizer 201b, the first WAN optimizer 201a measures the round trip time (RTT) between the first WAN optimizer 201a and the second WAN optimizer 201b (Step S903). The round trip time is acquired from a difference between the time when the measurement response packet is received and the time when the measurement packet is sent by the first WAN optimizer 201a, which is indicated by the time stamp in the measurement response packet.

Furthermore, when receiving the measurement packet including the time stamp from the first WAN optimizer 201a, the third WAN optimizer 201c sends the measurement response packet including the time stamp to the first WAN optimizer 201a (Step S904). When receiving the measurement response packet from the third WAN optimizer 201c, the first WAN optimizer 201a measures the round trip time (RTT) between the first WAN optimizer 201a and the third WAN optimizer 201c (Step S905). The round trip time is acquired from the difference between the time when the measurement response packet is received and the time when the measurement packet is sent by the first WAN optimizer 201a, which is indicated by the time stamp in the measurement response packet.

Moreover, measurement-target communication quality may be the discard rate in addition to RTT. For example, the first WAN optimizer 201a may repeat the sending of the measurement packet in Step S901 at suitable intervals, and measure the packet discard rate based on the number of times that the measurement response packet is not returned.

Furthermore, the second WAN optimizer 201b sends the measurement packet including the time stamp indicating the sending time to the first WAN optimizer 201a and the third WAN optimizer 201c (Step S906). When receiving the measurement packet including the time stamp from the second WAN optimizer 201b, the first WAN optimizer 201a sends the measurement response packet including the time stamp to the second WAN optimizer 201b (Step S907). When receiving the measurement response packet from the first WAN optimizer 201a, the second WAN optimizer 201b measures the round trip time (RTT) between the second WAN optimizer 201b and the first WAN optimizer 201a (Step S908). The round trip time is acquired from a difference between the time when the measurement response packet is received and the time when the measurement packet is sent by the second WAN optimizer 201b, which is indicated by the time stamp in the measurement response packet.

When receiving the measurement packet including the time stamp from the second WAN optimizer 201b, the third WAN optimizer 201c sends the measurement response packet including the time stamp to the second WAN optimizer 201b (Step S909). When receiving the measurement response packet from the third WAN optimizer 201c, the second WAN optimizer 201b measures the round trip time (RTT) between the second WAN optimizer 201b and the third WAN optimizer 201c (Step S910). The round trip time is acquired from the difference between the time when the measurement response packet is received and the time when the measurement packet is sent by the second WAN optimizer 201b, which is indicated by the time stamp in the measurement response packet.

Moreover, the measurement-target communication quality may be the discard rate in addition to RTT. For example, the second WAN optimizer 201b may repeat the sending of the measurement packet in Step S906 at suitable intervals, and measure the packet discard rate based on the number of times that the measurement response packet is not returned.

Furthermore, the third WAN optimizer 201c sends the measurement packet including the time stamp indicating the sending time to the first WAN optimizer 201a and the second WAN optimizer 201b (Step S911). When receiving the measurement packet including the time stamp from the third WAN optimizer 201c, the second WAN optimizer 201b sends a measurement response packet to the third WAN optimizer 201c (Step S912).

When receiving the measurement response packet from the second WAN optimizer 201b, the third WAN optimizer 201c measures the round trip time (RTT) between the third WAN optimizer 201c and the second WAN optimizer 201b (Step S913). The round trip time is acquired from a difference between the time when the measurement response packet is received and the time when the measurement packet is sent by the third WAN optimizer 201c, which is indicated by the time stamp in the measurement response packet.

When receiving the measurement packet including the time stamp from the third WAN optimizer 201c, the first WAN optimizer 201a sends the measurement response packet to the third WAN optimizer 201c (Step S914). When receiving the measurement response packet from the first WAN optimizer 201a, the third WAN optimizer 201c measures the round trip time (RTT) between the third WAN optimizer 201c and the first WAN optimizer 201a (Step S915). The round trip time is acquired from the difference between the time when the measurement response packet is received and the time when the measurement packet is sent by the third WAN optimizer 201c, which is indicated by the time stamp in the measurement response packet.

Moreover, the measurement-target communication quality may be the discard rate in addition to RTT. Specifically, the third WAN optimizer 201c may repeat the sending of the measurement packet in Step S911 at suitable intervals, and measure the packet discard rate based on the number of times that the measurement response packet is not returned.

When the measuring in each of Steps S901 to 915 is completed, the first WAN optimizer 201a sends a result-of-measuring synchronization packet to the second WAN optimizer 201b and the third WAN optimizer 201c (Step S916). Accordingly, network quality in the first WAN optimizer 201a can be shared with the second WAN optimizer 201b and the third WAN optimizer 201c.

Similarly, the second WAN optimizer 201b sends the result-of-measuring synchronization packet to the first WAN optimizer 201a and the third WAN optimizer 201c (Step S917). Accordingly, the network quality in the second WAN optimizer 201b can be shared with the first WAN optimizer 201a and the third WAN optimizer 201c.

Furthermore, the third WAN optimizer 201c sends the result-of-measuring synchronization packet to the first WAN optimizer 201a and the second WAN optimizer 201b (Step S918). Accordingly, the network quality in the third WAN optimizer 201c can be shared with the first WAN optimizer 201a and the second WAN optimizer 201b.

The first WAN optimizer 201a that is present furthest downstream is a representative WAN optimizer that manages the optimal protocol in the present communication session and the optional application section for the optimal protocol. Based on the network quality, the first WAN optimizer 201a calculates an optimal protocol indicating which protocol has to be applied to which section in order to increase the highest transmission performance between one end and another end (the radio terminal apparatus 202 and the server 203) (Step S919).

Based on a result of calculating the optimal protocol, the first WAN optimizer 201a sets an operation mode indicating a protocol that is to be applied between each of the first WAN optimizer 201a, the second WAN optimizer 201b, and the third WAN optimizer 201c (Step S920). For example, when by calculating the optimal protocol, UNAP is used on the communication path from the third WAN optimizer 201c to the second WAN optimizer 201b and TCP is used on the communication path from the second WAN optimizer 201b to the first WAN optimizer 201a, it is determined that the transmission performance is increased.

In this case, because the high-speed protocol is used on the communication path from the third WAN optimizer 201c to the second WAN optimizer 201b, the second WAN optimizer 201b sets the proxy mode under the instruction of the first WAN optimizer 201a (Step S921). The second WAN optimizer 201b performs protocol conversion between TCP and UNAP in the proxy mode.

Furthermore, the third WAN optimizer 201c sets the proxy mode in which the conversion between UNAP and TCP is performed, under the instruction of the first WAN optimizer 201a (Step S922). On the other hand, the first WAN optimizer 201a sets the snoop mode in which the first WAN optimizer 201a itself allows TCP, which is used by the radio terminal apparatus 202, to pass through without performing any protocol conversion (Step S923). Specifically, because a distance from the radio terminal apparatus 202 to the first WAN optimizer 201a is short, the first WAN optimizer 201a sets the communication path from the radio terminal apparatus 202 to the second WAN optimizer 201b to be in the same TCP session.

Accordingly, this can reduce overhead more than retranslating a protocol (here, retranslating TCP into TCP) in the first WAN optimizer 201a. Moreover, according to the present embodiment, the first WAN optimizer 201a that is present furthest downstream is set to be a representative WAN optimizer, but the third WAN optimizer 201c that is present furthest upstream or the second WAN optimizer 201b that is midway between the first WAN optimizer 201a and the third WAN optimizer 201c may be set to be the representative apparatus.

### One Example of a Result of Measuring the Inter-Apparatus Quality

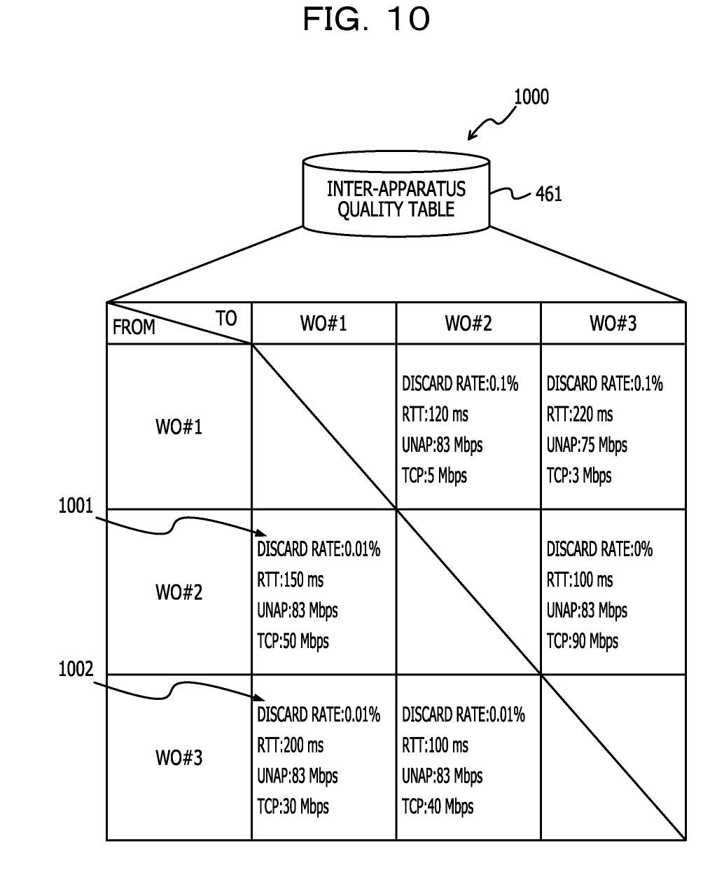

FIG. 10 is a descriptive diagram illustrating one example of a result of measuring the Inter-apparatus quality. As illustrated in FIG. 10, a result 1,000 of measuring the communication quality that is stored in the inter-apparatus quality table 461 indicates the communication quality of each of the WAN optimizer 201 at the sending side and the WAN optimizer 201 at the receiving side between the WAN optimizer 201 at the sending side and the WAN optimizer 201 at the receiving side.

For example, with regard to communication quality 1001 of the communication path from the second WAN optimizer 201b to the first WAN optimizer 201a, a discard rate is 0.01%, RTT is 150 ms, a UNAP communication speed is 83 Mbps, and a TCP communication speed is 50 Mbps. For example, with regard to communication quality 1002 of the communication path from the third WAN optimizer 201c to the first WAN optimizer 201a, a discard rate is 0.01%, RTT is 200 ms, a UNAP communication speed is 83 Mbps, and a TCP communication speed is 30 Mbps. Here, a relationship between the discard rate for every RTT and the throughput is described that is stored in advance by the first WAN optimizer 201a, a representative WAN optimizer, which is present furthest downstream.

### One Example of the Relationship Between the Discard Rate for Every RTT and the Throughput

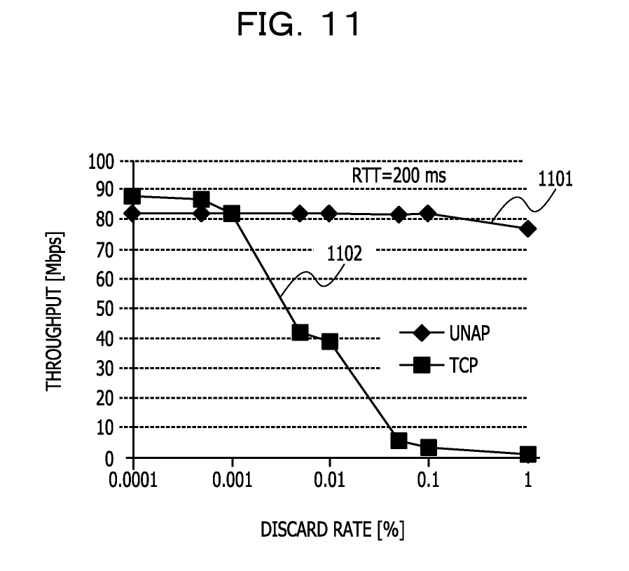

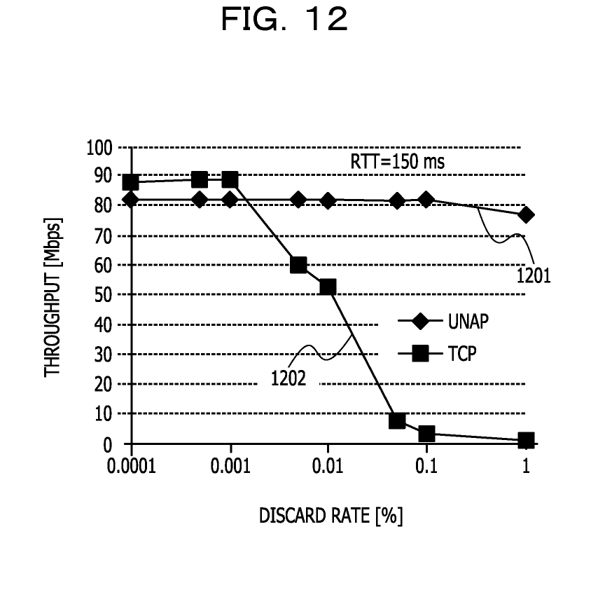

FIG. 11 is a diagram illustrating an example of the relationship between the discard rate for every RTT and the throughput (first). FIG. 12 is a diagram illustrating a different example of the relationship between the discard rate for every RTT and the throughput (second). In FIGS. 11 and 12, a horizontal axis indicates the discard rate [%], and a vertical axis indicates the throughput [Mbps]. FIG. 11 illustrates a case where RTT is 200 ms. FIG. 12 illustrates a case where RTT is 150 ms.

As indicated by a relationship line 1101 illustrated in FIG. 11, in the case where RTT is 200 ms, the throughput for UNAP is almost unchanged, without depending on the discard rate. On the other hand, it is understood from a relationship line 1102 that in the case where RTT is 200 ms, when the discard rate is greater than 0.001%, the throughput for TCP has a tendency to decrease. Furthermore, similarly, as indicated by a relationship line 1201 in FIG. 12, in the case where RTT is 150 ms, the throughput for UNAP is also almost unchanged without depending on the discard rate.

On the other hand, it is understood from a relationship line 1202 in FIG. 12 that in the case where RTT is 150 ms, when the discard rate is greater than 0.001%, the throughput for TCP has a tendency to decrease. In FIGS. 11 and 12, the case where RTT is 200 ms and the case where RTT is 150 ms are illustrated, but the first WAN optimizer 201a also stores graphs indicating relationships between the discard rate and the throughput for other RTT's.

In the case of the communication quality 1001 (discard rate: 0.01% and RTT: 150 ms) in FIG. 10, as indicated by the relationship line 1202 in FIG. 12, because when the discard rate is 0.01%, the throughput for TCP is approximately 50 Mbps, UNAP is suitable. In the case of the communication quality 1002 (discard rate: 0.01% and RTT: 200 ms) in FIG. 10, as indicated by the relationship line 1102 in FIG. 11, because when the discard rate is 0.01%, the throughput for TCP is approximately 40 Mbps, UNAP is suitable.

For this reason, it can be determined that UNAP that is the high-speed protocol is suitable in a section from the third WAN optimizer 201c to the second WAN optimizer 201b, and a section from the second WAN optimizer 201b to the first WAN optimizer 201a.

### Different Example of the Result of Measuring the Inter-Apparatus Quality

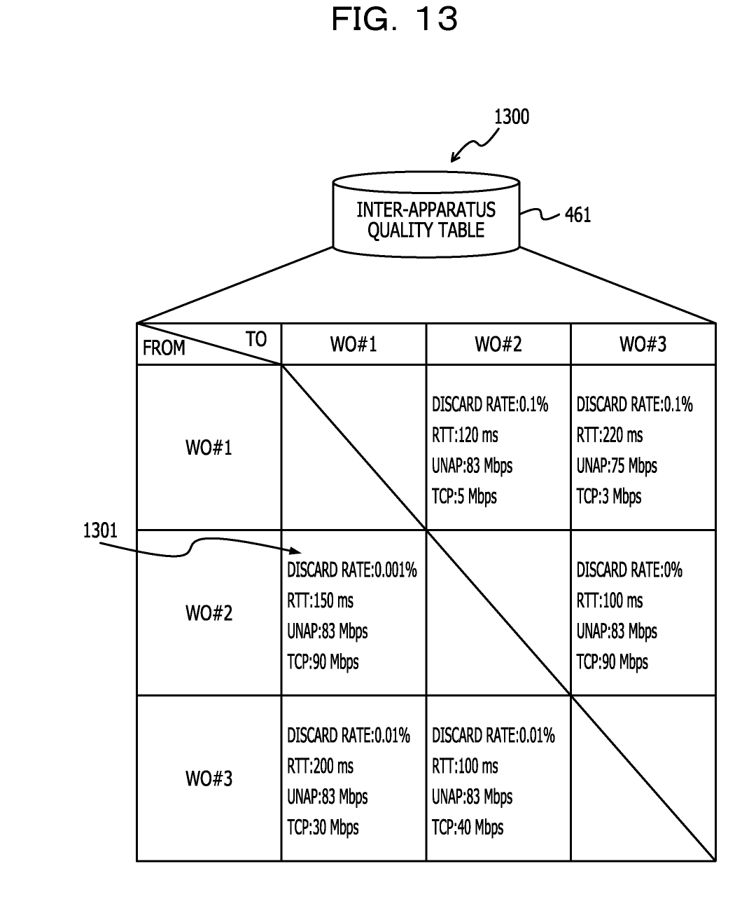

FIG. 13 is a descriptive diagram illustrating a different example of the result of measuring the Inter-apparatus quality. As illustrated in FIG. 13, a result 1300 of measuring the inter-apparatus quality that is stored in the inter-apparatus quality table 461 indicates the communication quality of each of the WAN optimizer 201 at the sending side and the WAN optimizer 201 at the receiving side between the WAN optimizer 201 at the sending side and the WAN optimizer 201 at the receiving side, in the same manner as does the result 1000 of the measuring that is illustrated in FIG. 10. Moreover, what distinguishes the inter-apparatus quality in FIG. 13 from that in FIG. 10 will be described.

For example, with regard to communication quality 1301 of the communication path from the second WAN optimizer 201b to the first WAN optimizer 201a, RTT is 150 ms, and a discard rate is 0.001%. In the case of the communication quality 1301 (discard rate: 0.001% and RTT: 150 ms) in FIG. 13, as indicated by the relationship line 1202 in FIG. 12, because when the discard rate is 0.001%, the throughput for TCP is equal to or more than 80 Mbps, TCP is suitable.

For this reason, it can be determined that TCP is suitable for use in a section from the second WAN optimizer 201b to the first WAN optimizer 201a and UNAP that is the high-speed protocol is suitable for use in a section from the third WAN optimizer 201c to the second WAN optimizer 201b. In this manner, the communication system 100 can change the section using the high-speed protocol according to a communication state of the WAN optimizer 201.

Here, an operation that is performed in a case where a TCP section is shortened is described in detail. Specifically, a case is described where the TCP session is extended from the radio terminal apparatus 202 to the second WAN optimizer 201b and, due to network communication quality, is reduced to a section to which the first WAN optimizer 201a belongs.

### One Example of the Operation that is Performed when the TCP Section is Shortened

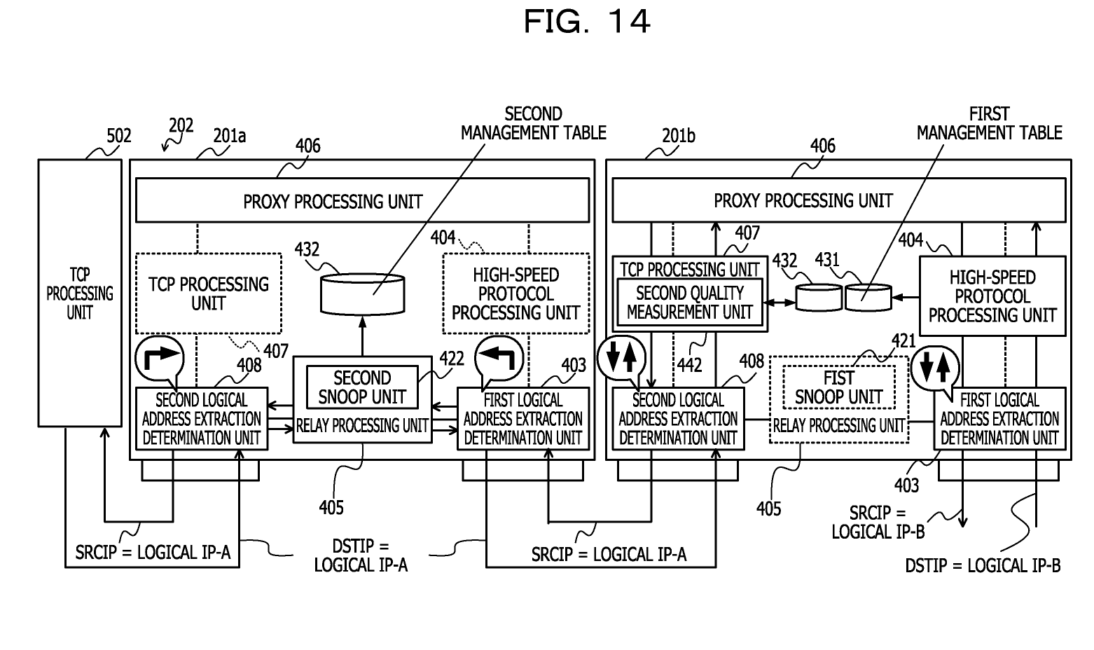

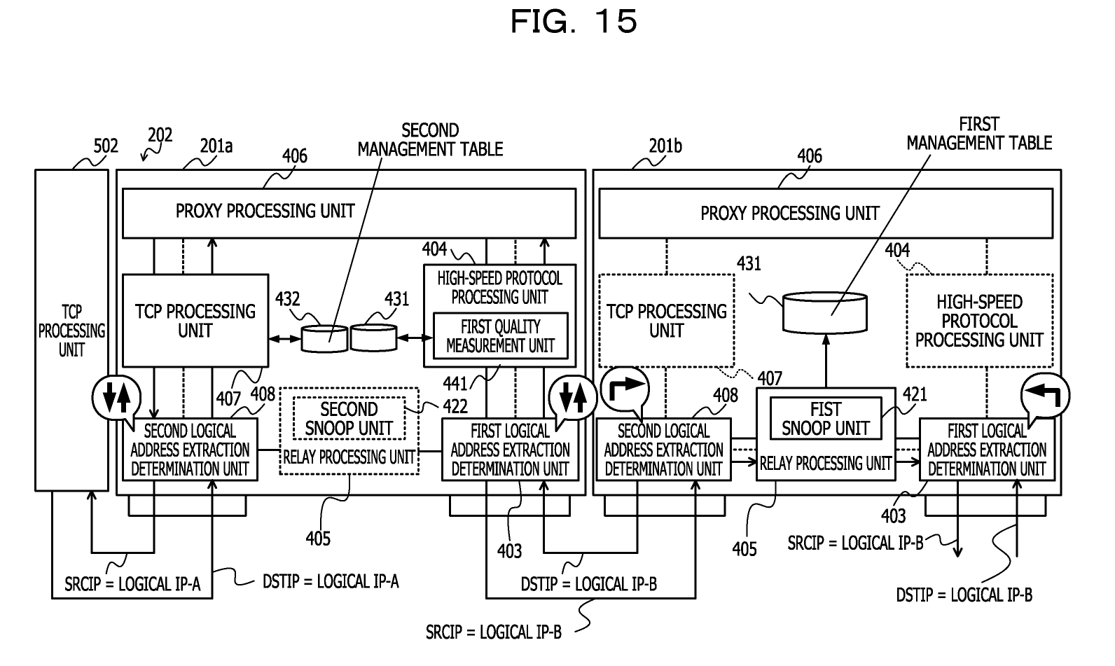

FIG. 14 is a descriptive diagram illustrating one example of an operation that is performed in a case where the conversion between TCP and the high-speed protocol is performed by the second WAN optimizer 201b. FIG. 15 is a descriptive diagram illustrating one example of an operation that is performed in a case where the conversion between TCP and the high-speed protocol is performed by the first WAN optimizer 201a.

As illustrated in FIG. 14, the second WAN optimizer 201b, which is set to be in the proxy mode, converts a protocol of TCP into the high-speed protocol. Specifically, the second WAN optimizer 201b terminates TCP with the TCP processing unit 407. Furthermore, the second WAN optimizer 201b terminates the high-speed protocol with the high-speed protocol processing unit 404.

When receiving a packet in the high-speed protocol that is destined for the radio terminal apparatus 202, the second WAN optimizer 201b causes the TCP processing unit 407 to perform the TCP processing on the packet, and then sends the resulting packet to the radio terminal apparatus 202. Furthermore, the TCP processing unit 407 sequentially stores in the second management table 432 the protocol communication state that is indicated by the header information in the packet in TCP that is sent to the radio terminal apparatus 202. The second quality measurement unit 442 that is installed in the TCP processing unit 407 of the second WAN optimizer 201b measures the discard rate and RTT from the retransmission state of TCP.

Furthermore, for example, when receiving a packet in TCP that is destined for the server 203 the second WAN optimizer 201b causes the high-speed protocol processing unit 404 to perform the high-speed protocol processing on the packet, and then sends the resulting packet to the server 203. Furthermore, the high-speed protocol processing unit 404 sequentially stores in the first management table 431 the protocol communication state that is indicated by the header information in the packet in the high-speed protocol that is sent to the server 203.

On the other hand, the first WAN optimizer 201a that is positioned between the radio terminal apparatus 202 and the second WAN optimizer 201b is set to be in the snoop mode. In the snoop mode, the first WAN optimizer 201a reads the header information in the packet in TCP that is relayed, by snooping (looking into) and stores a state of the TCP session (a sequence number, an ACK number, or like). Specifically, the second snoop unit 422 of the first WAN optimizer 201a reads the header information in the packet in TCP by snooping and sequentially updates the protocol communication state that is stored in the second management table 432. In this manner, the first WAN optimizer 201a reads the header information in the packet in TCP by snooping, and retains the state of the TCP session.

In the second WAN optimizer 201b that is in the proxy mode, when the result of the second quality measurement unit 442 measuring quality is that, for example, communication quality of the radio network is improved, the second WAN optimizer 201b switched to the snoop mode as illustrated in FIG. 15. Furthermore, the first WAN optimizer 201a switches to the proxy mode.

In the mode switching, the control unit 450 performs a function of causing the first WAN optimizer 201a and the second WAN optimizer 201b to exchange control messages. At the timing at which synchronization is achieved between the first WAN optimizer 201a and the second WAN optimizer 201b, the communication system 100 changes a termination point of TCP from the second WAN optimizer 201b to the first WAN optimizer 201a.

Specifically, in switching to the proxy mode, the first WAN optimizer 201a is set to receive a packet destined for a logical IP protocol (logical IP-A) for termination of TCP from the second WAN optimizer 201b. In this case, the control unit 450 of the first WAN optimizer 201a instructs the first logical address extraction determination unit 403 to send the packet, as a packet destined for the base station 301, to the TCP processing unit 407. At this time, the TCP processing unit 407 is set to be able to transmit and receive data during the TCP session also after a transition from the high-speed protocol to TCP occurs, by referring to the second management table 432 that is updated by snooping while the first WAN optimizer 201a is in the snoop mode.

In the proxy mode, the first WAN optimizer 201a is set to receive a packet destined for a logical IP protocol (logical IP-B) for termination of the high-speed protocol from the second WAN optimizer 201b. In this case, the control unit 450 of the first WAN optimizer 201a instructs the first logical address extraction determination unit 403 to send the packet, as a packet destined for the base station 301, to the high-speed protocol processing unit 404.

The control unit 450 of the first WAN optimizer 201a instructs the proxy processing unit 406 to send the data received from the TCP processing unit 407 to the high-speed protocol processing unit 404. The high-speed protocol processing unit 404 converts TCP into the high-speed protocol and sequentially stores in the first management table 431 the protocol communication state that is indicated by the header information in the packet in the high-speed protocol.

Furthermore, the control unit 450 of the first WAN optimizer 201a instructs the proxy processing unit 406 to send the data received from the high-speed protocol processing unit 404 to the TCP processing unit 407. The TCP processing unit 407 converts the high-speed protocol into TCP, and sequentially stores in the second management table 432 the protocol communication state that is indicated by the header information in the packet in TCP. Furthermore, the first quality measurement unit 441 that is installed in the high-speed protocol processing unit 404 of the first WAN optimizer 201a measures radio link quality from the retransmission situation of the high-speed protocol or from an RTT change.

On the other hand, the second WAN optimizer 201b allows the packet in the high-speed protocol to pass through in the snoop mode. The second WAN optimizer 201b reads the header information in the packet in the high-speed protocol that is allowed to pass through, by snooping, and monitors a state of a high-speed protocol session (the sequence number, an ACK number, or the like). Specifically, the first snoop unit 421 of the second WAN optimizer 201b reads the header information in the packet in the high-speed protocol by snooping and sequentially updates the protocol communication state that is stored in the first management table 431.

Furthermore, while the first WAN optimizer 201a is in the proxy mode, the first quality measurement unit 441 that is installed in the high-speed protocol processing unit 404 measures the radio link quality, such as the discard rate of the high-speed protocol or RTT. Based on a result of the measuring by the first quality measurement unit 441, the control unit 450 can cause the first WAN optimizer 201a to switch from the proxy mode to the snoop mode. Accordingly, even if the radio terminal apparatus 202 does not detect that a TCP session has discontinued, the termination point of TCP can be changed from the second WAN optimizer 201b to the first WAN optimizer 201a.

### One Example of an Operation that is Performed when a TCP Section is Shortened

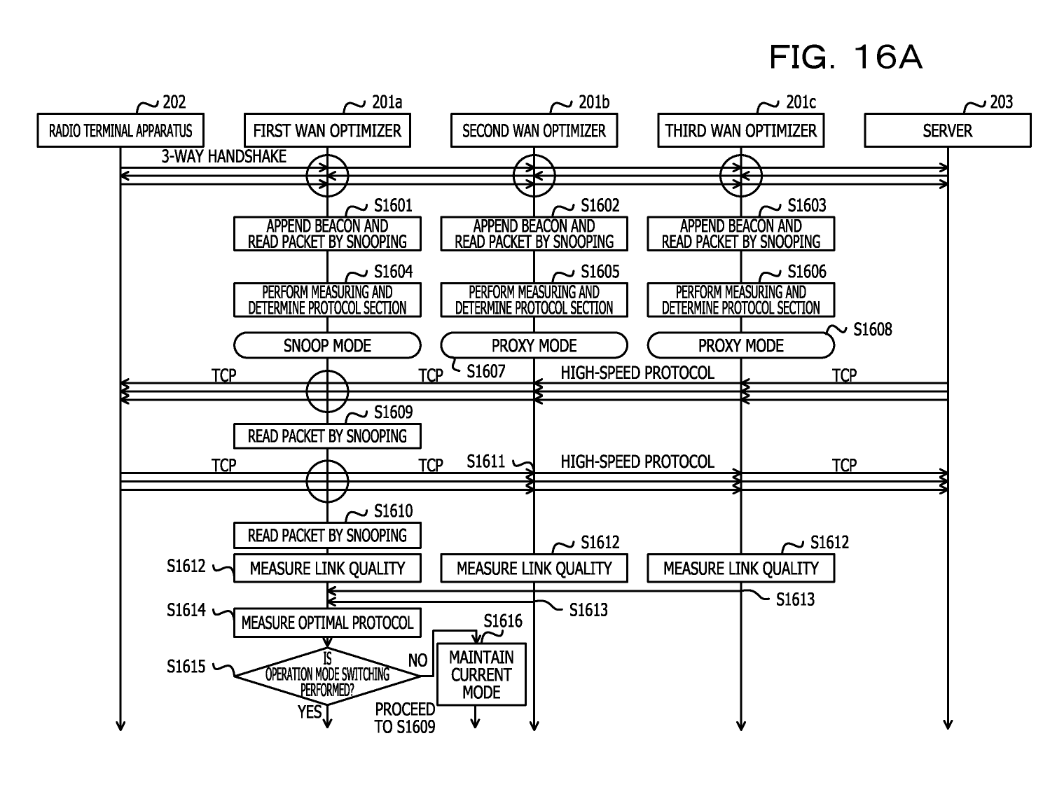

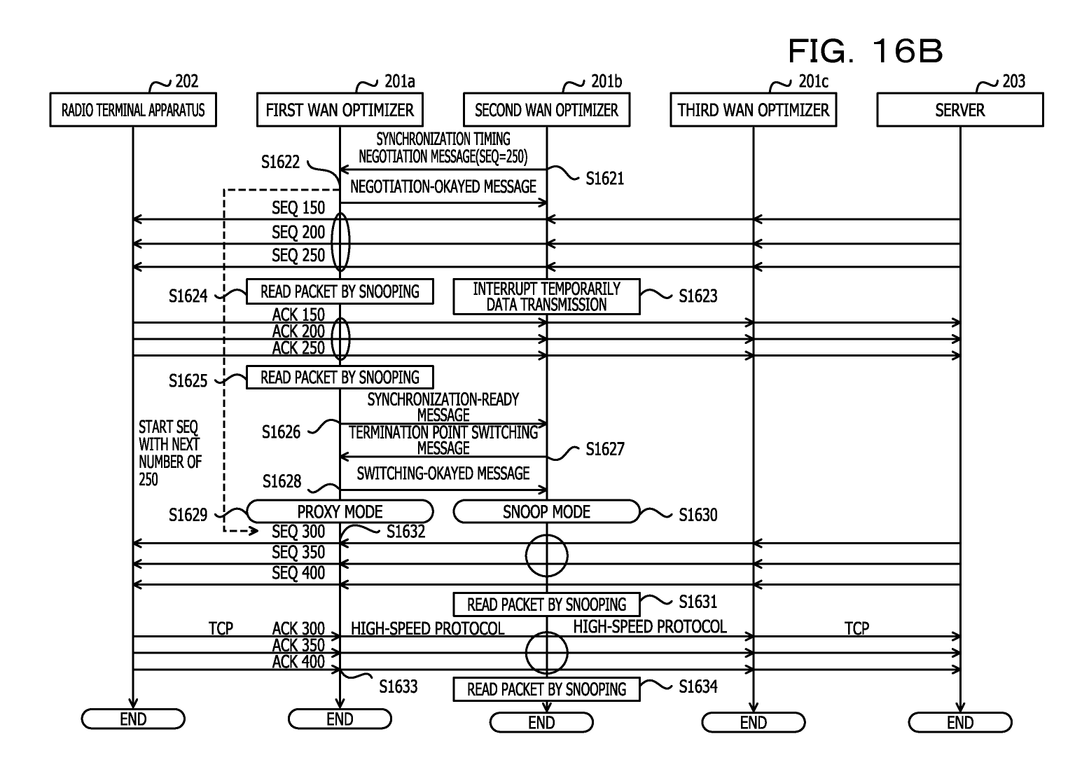

FIG. 16A is the first portion of a sequence diagram illustrating one example of an operation that is performed by the communication system when a TCP section is shortened. FIG. 16B is the second and last portion of the sequence diagram illustrating one example of the operation that is performed by the communication system when a TCP section is shortened.

In FIGS. 16A and 16B, the radio terminal apparatus 202 first extends the TCP session to the second WAN optimizer 201b within the base station 301. At this time, the 3-way handshake is executed. In the 3-way handshake, the WAN optimizer 201 appends the beacon information to the packet that is sent from the radio terminal apparatus 202 or the server 203, and reads the packet by snooping (Steps S1601, S1602, and S1603).

An operation of appending the beacon information is as illustrated in FIG. 7A. Furthermore, the WAN optimizer 201 detects its position and the state of the TCP session. Next, each of the first WAN optimizer 201a, the second WAN optimizer 201b, and the third WAN optimizer 201c sends the measurement packet to the other WAN optimizers, and measures the communication quality of the WAN optimizer 201 and determines an optimal high-speed protocol section (Steps S1604, S1605, and S1606). Determination of a protocol section that is based on a result of measuring the communication quality is as illustrated in FIGS. 9A and 9B.

As the result of measuring the communication quality, for example, the first WAN optimizer 201a is set to operate in the snoop mode, and the second WAN optimizer 201b and the third WAN optimizer 201c are set to operate in the proxy mode. Furthermore, the high-speed protocol is set to be used between the third WAN optimizer 201c and the second WAN optimizer 201b. Moreover, according to the present embodiment, only the switching of each of the first WAN optimizer 201a and the second WAN optimizer 201b between the modes is described, and a description of the switching of the third WAN optimizer 201c between the modes is omitted.

The second WAN optimizer 201b in the proxy mode temporarily terminates the high-speed protocol, retranslates a protocol of received data into a protocol of TCP, and transmits the received data in TCP to the first WAN optimizer 201a (Step S1607). Furthermore, the third WAN optimizer 201c in the proxy mode temporarily terminates the high-speed protocol, converts a protocol of the received data into a protocol of TCP, and transmits the received data in TCP to the server 203 (Step S1608).

The first WAN optimizer 201a in the snoop mode relays the packet in TCP that is received from the second WAN optimizer 201b. At this time, the first WAN optimizer 201a reads the packet by snooping (Step S1609) and sequentially updates the protocol communication state that is indicated by the header information in the packet within the second management table 432.

The first WAN optimizer 201a in the snoop mode relays the packet in TCP that is received from the radio terminal apparatus 202. At this time, the first WAN optimizer 201a reads the packet by snooping (Step S1610), and sequentially updates the protocol communication state that is indicated by the header information in the packet within the second management table 432.

The second WAN optimizer 201b in the proxy mode temporarily terminates TCP, retranslates the protocol of the received data into the high-speed protocol, and transmits the received data in the high-speed protocol to the third WAN optimizer 201c (Step S1611).

The first WAN optimizer 201a, the second WAN optimizer 201b, and the third WAN optimizer 201c monitor whether an ACK in response to each of the packets in TCP or in the high-speed protocol that are sent is received and measures the discard rate and RTT. Furthermore, the first WAN optimizer 201a, the second WAN optimizer 201b, and the third WAN optimizer 201c perform measuring of the link quality by measuring a band that is not in use or a band that is in use, from a relationship between a packet-sending rate and an occurrence of packet-discarding (Step S1612). The second WAN optimizer 201b and the third WAN optimizer 201c send the result of the measuring to the first WAN optimizer 201a that is a representative WAN optimizer (Step S1613).

The first WAN optimizer 201a calculates the optimal protocol (Step S1614). Then, the first WAN optimizer 201a determines whether or not operation mode switching is performed (Step S1615). In a case where the operation mode switching is not performed (No in Step S1615), the first WAN optimizer 201a maintains a current mode (Step S1616), and proceeds to Step S1609.

For example, in a case where it is determined that the high-speed protocol, not TCP, is suitable as a protocol for a radio section and the operation mode switching is performed (Yes in Step S1615), the first WAN optimizer 201a performs the operation mode switching. Specifically, the first WAN optimizer 201a sets itself to be in the proxy mode in order to use the high-speed protocol in a section from the third WAN optimizer 201c to the first WAN optimizer 201a. Furthermore, the first WAN optimizer 201a sets the second WAN optimizer 201b to be in the snoop mode in which the high-speed protocol, as is, is allowed to pass through without performing any protocol conversion. Moreover, the first WAN optimizer 201a does not change a mode that is set for the third WAN optimizer 201c.

The switching of each of the first WAN optimizer 201a and the second WAN optimizer 201b between the modes will be described in detail. As illustrated in FIG. 16, the second WAN optimizer 201b sends a synchronization timing negotiation message to the first WAN optimizer 201a (Step S1621).

The sequence number for performing the data waiting operation on the second WAN optimizer 201b and the first WAN optimizer 201a is included in the synchronization timing negotiation message. The synchronization timing negotiation message, for example, includes a future sequence number (for example, SEQUENCE (SEQ)=250) that is calculated based on the data that is sent from the second WAN optimizer 201b and the subsequent WAN optimizers.

The sequence number is a number that is determined based on the delay time that the first WAN optimizer 201a takes to receive the data that is sent from the second WAN optimizer 201b. The longer the delay time, the greater the sequence number for waiting. The sequence number, for example, is determined by the first WAN optimizer 201a that is a representative WAN optimizer. When receiving the synchronization timing negotiation message, the first WAN optimizer 201a records the sequence number for performing a waiting operation and replies to the second WAN optimizer 201b with a network-okayed message (Step S1622).

When receiving the network-okayed message, the second WAN optimizer 201b sends data until a sequence number 250 is reached, which is negotiated, and thereafter temporarily interrupts the data transmission (Step S1623). The first WAN optimizer 201a is in the snoop mode, reads, by snooping, the packet in TCP until the sequence number 250 is reached (Step S1624), and, by snooping, reads an ACK packet from the radio terminal apparatus 202, which is in response to the packet in TCP by snooping (Step S1625). Then, when by snooping, the radio terminal apparatus 202 confirms that the data has been received before until the sequence number 250 was reached, the first WAN optimizer 201a sends a synchronization-ready message to the second WAN optimizer 201b (Step S1626).

Here, in a case where lost data, such as discarded data, that is not received, is present among items of data that are transmitted from the second WAN optimizer 201b, the first WAN optimizer 201a requests the second WAN optimizer 201b to retransmit the lost data. For example, in a case where based on the sequence number, the presence or absence of lost data is checked for, and, in a case where lost data is detected, the first WAN optimizer 201a requests the second WAN optimizer 201b to retransmit the lost data.

In a case where the first WAN optimizer 201a requests the second WAN optimizer 201b to retransmit the lost data, the second WAN optimizer 201b retransmits the lost data to the first WAN optimizer 201a. Even though the sequence for waiting is read by snooping, in a case where the lost data is not received from the second WAN optimizer 201b, the first WAN optimizer 201a does not send the synchronization-ready message (control signal) to the second WAN optimizer 201b. Furthermore, the first WAN optimizer 201a does not perform the switching to the proxy mode.

Furthermore, even if the sequence number for waiting is reached, in a case where the request for the retransmission of the lost data to the first WAN optimizer 201a is made, the second WAN optimizer 201b retransmits the lost data and then performs the switching to the snoop mode. Accordingly, even if lost data occurs before the switching between the transmission states is performed, the second WAN optimizer 201b can retransmit the lost data in the same protocol as when the data was first sent. Furthermore, the first WAN optimizer 201a can receive the lost data in the same protocol as when the lost data occurred. For this reason, the lost data can be made up for, and the data matching is possible before and after the switching between the transmission states.

The second WAN optimizer 201b checks whether the radio terminal apparatus is in the same state as the first WAN optimizer 201a by receiving an ACK signal from the radio terminal apparatus 202 until the sequence number 250 is reached and by receiving the synchronization-ready message from the first WAN optimizer 201a. When this is done, the second WAN optimizer 201b sends a termination point switching message to the first WAN optimizer 201a (Step S1627).

When receiving the termination point switching message from the second WAN optimizer 201b, the first WAN optimizer 201a sends a switching-okayed message to the second WAN optimizer 201b (Step S1628). Furthermore, the first WAN optimizer 201a switches from the snoop mode to the proxy mode (Step S1629). When receiving a switching-okayed message from the first WAN optimizer 201a, the second WAN optimizer 201b switches from the proxy mode to the snoop mode (Step S1630).

Thereafter, the second WAN optimizer 201b resumes the interrupted data transmission, and when receiving the packet in the high-speed protocol from the third WAN optimizer 201c, performs relaying at IP packet level. Moreover, the second WAN optimizer 201b in the snoop mode reads, by snooping, the header in the high-speed protocol that is received from the third WAN optimizer 201c (Step S1631) and updates the protocol communication state that is indicated by the header information within the first management table 431. In the proxy mode, the first WAN optimizer 201a terminates the high-speed protocol, converts the protocol of the received data into TCP and transmits the received data in TCP to the radio terminal apparatus 202 (Step S1632).

Furthermore, in the proxy mode, the first WAN optimizer 201a terminates TCP, converts the protocol of the received data into the high-speed protocol, and sends the received data in the high-speed protocol to the second WAN optimizer 201b (Step S1633). The second WAN optimizer 201b in the snoop mode reads, by snooping, the header in the high-speed protocol that is received from the first WAN optimizer 201a (Step S1634), and updates the protocol communication state that is indicated by the header information within the first management table 431.

### One Example of an Operation that is Performed when the TCP Section is Lengthened

Next, an operation that is performed when the TCP section is lengthened will be described referring to FIGS. 14 and 15. First, referring back to FIG. 15, an operation that is performed in a case where the conversion between TCP and the high-speed protocol is performed in the first WAN optimizer 201a is described. As illustrated in FIG. 15, the second WAN optimizer 201b is in the snoop mode. The relay processing unit 405 of the second WAN optimizer 201b relays a packet in the high-speed protocol. The first snoop unit 421 of the second WAN optimizer 201b reads, by snooping, the header information in the packet in the high-speed protocol, and sequentially updates the first management table 431.

Furthermore, in FIG. 15, the first WAN optimizer 201a is in the proxy mode. When receiving a packet destined for a logical IP-B, the first logical address extraction determination unit 403 of the first WAN optimizer 201a sends the received packet to the proxy processing unit 406. The proxy processing unit 406 causes the TCP processing unit 407 to perform the TCP processing, and then sends the packet to the radio terminal apparatus 202 (TCP processing unit 502).

Furthermore, when receiving a packet in TCP, destined for a logical IP-A, from the radio terminal apparatus 202, the first WAN optimizer 201a receives the packet in TCP, as a packet destined for a local IP address of the proxy processing unit 406, and causes the high-speed protocol processing unit 404 to perform the conversion to the high-speed protocol. The first quality measurement unit 441 that is installed in the high-speed protocol processing unit 404 of the first WAN optimizer 201a measures the radio link quality from the retransmission situation of the high-speed protocol or from the RTT change.

In the second WAN optimizer 201b that is in the proxy mode, when the result of the first quality measurement unit 441 measuring the quality is that, for example, the communication quality of the radio network deteriorates, the first WAN optimizer 201a switches to the snoop mode as illustrated in FIG. 14. Furthermore, the second WAN optimizer 201b switches to the proxy mode. In the mode switching, the control unit 450 performs a function of causing the first WAN optimizer 201a and the second WAN optimizer 201b to exchange control messages. At the timing at which the synchronization is achieved between the first WAN optimizer 201a and the second WAN optimizer 201b, the communication system 100 changes the termination point of TCP from the first WAN optimizer 201a to the second WAN optimizer 201b.

In switching to the proxy mode, in a case where a packet destined for the logical IP protocol (logical IP-B) for the termination of the high-speed protocol is received, the second WAN optimizer 201b instructs the first logical address extraction determination unit 403 to send the received packet to the high-speed protocol processing unit 404. At this time, the TCP processing unit 404 is set to be able to continue to transmit and receive the data also after a protocol transition from TCP to the high-speed protocol occurs, by referring to the first management table 431 that is updated by snooping while the second WAN optimizer 201b is in the snoop mode.

When the switching to the proxy mode is performed, the control unit 450 of the second WAN optimizer 201b causes the proxy processing unit 406 to transmit the data received from the TCP processing unit 407 to the high-speed protocol processing unit 404. Furthermore, the control unit 450 of the second WAN optimizer 201b instructs the proxy processing unit 406 to send the data received from the high-speed protocol processing unit 404 to a network through the TCP processing unit 407.

On the other hand, in the snoop mode, when the first logical address extraction determination unit 403 receives the packet destined for the logical IP-A, the first WAN optimizer 201a sends the received packet to the relay processing unit 405. Specifically, the control unit 450 of the first WAN optimizer 201a instructs the first logical address extraction determination unit 403 and the second logical address extraction determination unit 408 to allow the packet in TCP to pass through. The relay processing unit 405 reads, by snooping, the header information in the packet that is relayed, and retains a state (sequence number, an ACK number, and the like) of the protocol of TCP. Specifically, the second snoop unit 422 of the first WAN optimizer 201a reads the header information in TCP by snooping, and sequentially updates the second management table 432.

In the second WAN optimizer 201b in the proxy mode, the second quality measurement unit 442 that is installed in the TCP processing unit 407 measures the radio link quality from the retransmission situation of TCP or from the RTT change. Based on a result of the measuring by the second quality measurement unit 442, the control unit 450 can cause the second WAN optimizer 201b to switch from the proxy mode to the snoop mode. Accordingly, even if the radio terminal apparatus 202 does not detect that the TCP session has discontinued, the termination point of TCP can be changed from the first WAN optimizer 201a to the second WAN optimizer 201b.

### One Example of an Operation Sequence that is Performed when the TCP Section is Lengthened

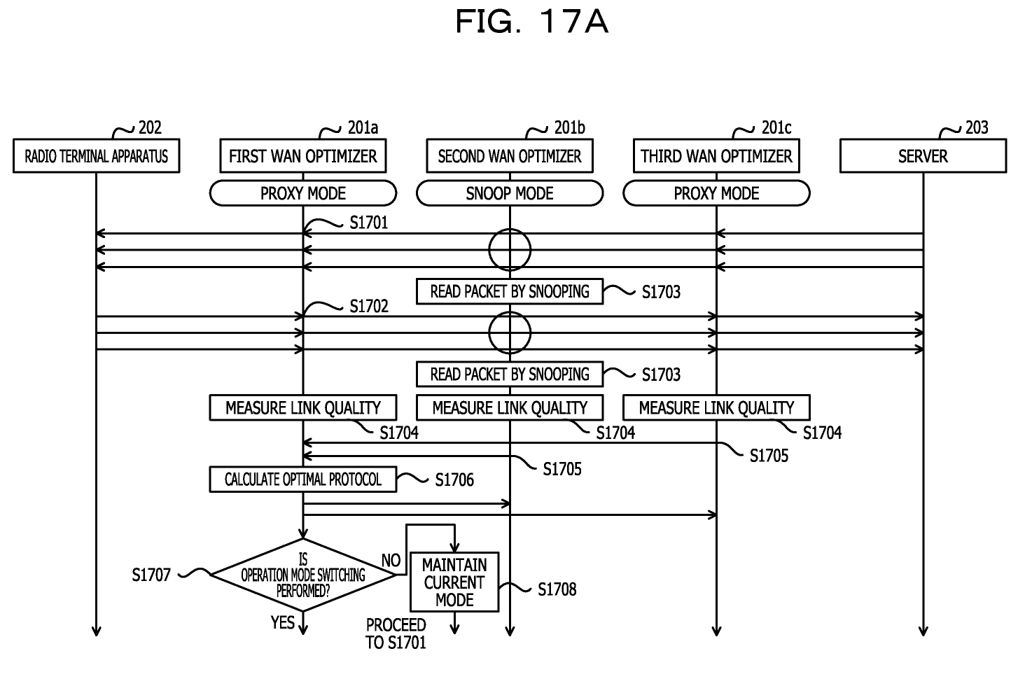

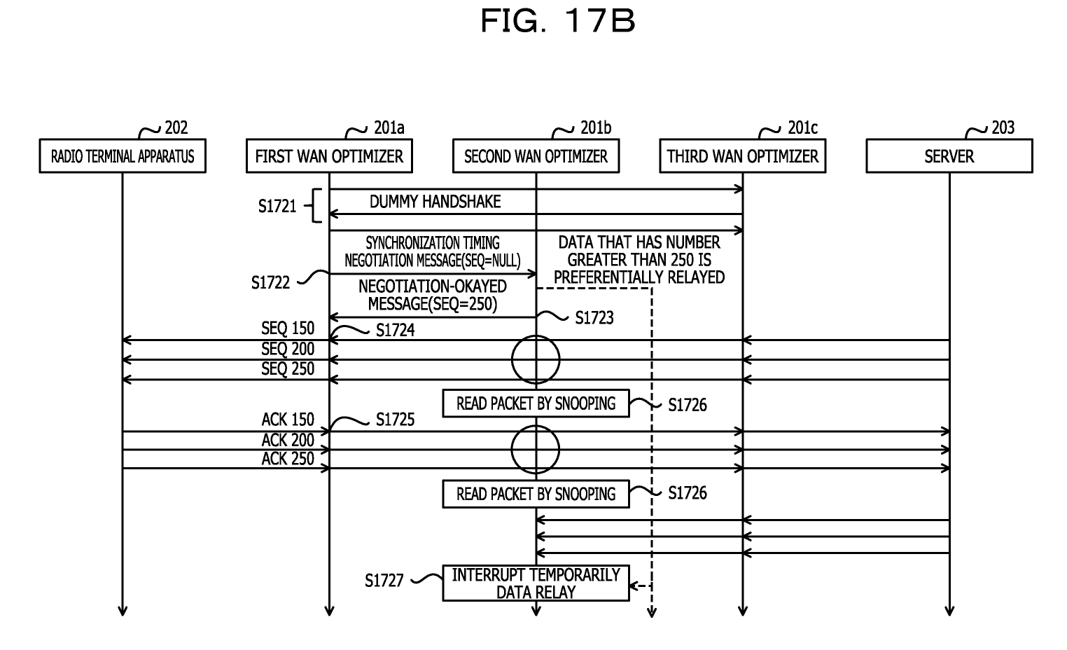

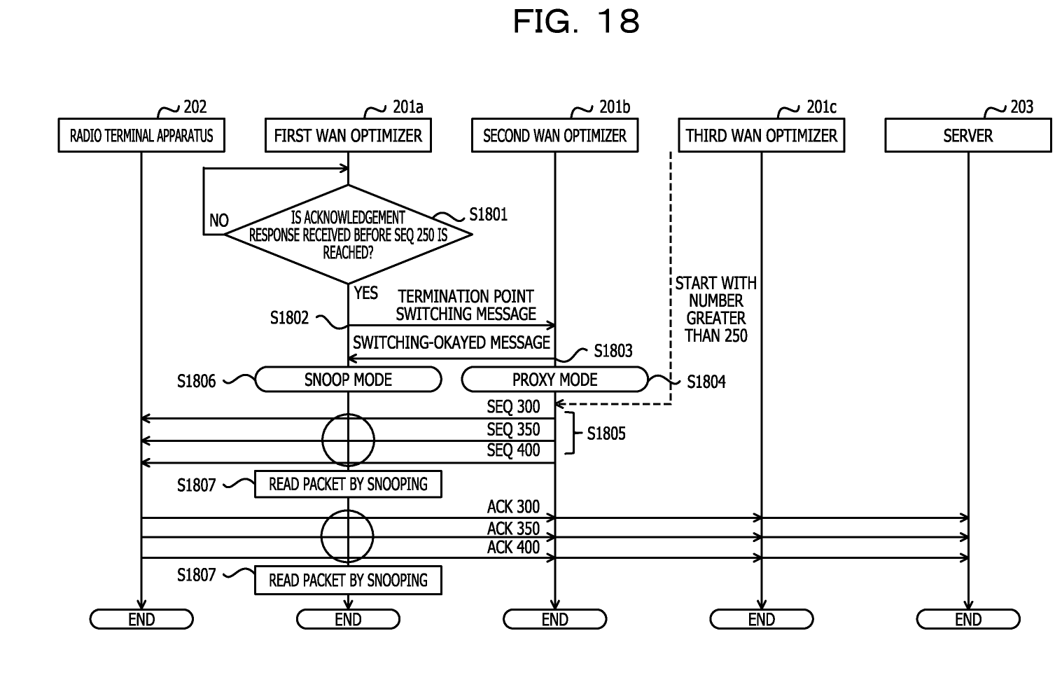

FIG. 17A is the first portion of a sequence diagram illustrating one example of an operation that is performed by the communication system when a TCP section is lengthened. FIG. 17B is the second, portion of the sequence diagram illustrating one example of the operation that is performed by the communication system when a TCP section is lengthened. FIG. 18 is the third and last portion of the sequence diagram illustrating one example of the operation that is performed by the communication system when a TCP section is lengthened.

In FIGS. 17A, 17B, and 18, the second WAN optimizer 201b is set to be in the snoop mode, and the first WAN optimizer 201a is set to be in the proxy mode. To sum up, the termination point of TCP is set to be the first WAN optimizer 201a. Moreover, the third WAN optimizer 201c is set to be in the proxy mode, and the mode switching is not set to be performed.

The first WAN optimizer 201a converts the high-speed protocol of the packet that is transmitted from the third WAN optimizer 201c through the second WAN optimizer 201b, into TCP, and transmits the resulting packet in TCP to the radio terminal apparatus 202 (Step S1701). Furthermore, the first WAN optimizer 201a converts TCP that is sent from the radio terminal apparatus 202 into the high-speed protocol and transmits the resulting high-speed protocol to the second WAN optimizer 201b (Step S1702).

The second WAN optimizer 201b is in the snoop mode, and relays the packet in the high-speed protocol that is received from the first WAN optimizer 201a or the third WAN optimizer 201c. At this time, the second WAN optimizer 201b reads contents (header information) of the packet by snooping (Step S1703) and sequentially updates the first management table 431.

The first WAN optimizer 201a, the second WAN optimizer 201b, and the third WAN optimizer 201c monitor whether an ACK in response to each of the packets in TCP or in the high-speed protocol that are sent is received and measures the discard rate and RTT. Furthermore, the first WAN optimizer 201a, the second WAN optimizer 201b, and the third WAN optimizer 201c perform the measuring of the link quality by measuring a band that is not in use or a band that is in use, from the relationship between the packet-sending rate and the occurrence of packet-discarding (Step S1704). The second WAN optimizer 201b and the third WAN optimizer 201c send the result of the measuring to the first WAN optimizer 201a that is a representative WAN optimizer (Step S1705).

The first WAN optimizer 201a calculates the optimal protocol (Step S1706). Then, the first WAN optimizer 201a determines whether or not the operation mode switching is performed (Step S1707). In a case where the operation mode switching is not performed (No in Step S1707), the first WAN optimizer 201a maintains a current mode (Step S1708), and proceeds to Step S1701.

For example, in a case where it is determined that TCP, not the high-speed protocol, is suitable as a protocol for the radio section and the operation mode switching is performed (Yes in Step S1707), the first WAN optimizer 201a performs the operation mode switching. Specifically, the first WAN optimizer 201a sets itself to be in the snoop mode in order to use the high-speed protocol in a section from the third WAN optimizer 201c to the second WAN optimizer 201b. Furthermore, the first WAN optimizer 201a sets the second WAN optimizer 201b to be in the proxy mode in which the protocol conversion between the high-speed protocol and TCP is performed. Moreover, the mode that is set for the third WAN optimizer 201c is not changed.

The switching of each of the first WAN optimizer 201a and the second WAN optimizer 201b between the modes will be described in detail. As illustrated in FIG. 17, the first WAN optimizer 201a performs a dummy handshake according to the same procedure as with the 3-way handshake on the second WAN optimizer 201b, and opens the TCP session with the second WAN optimizer 201b (Step S1721). Moreover, the first WAN optimizer 201a sends the synchronization timing negotiation message to the second WAN optimizer 201b (Step S1722). At this time, the first WAN optimizer 201a sends the sequence number in a state where the sequence number is set to NULL.

When receiving the synchronization timing negotiation message, the second WAN optimizer 201b designates the sequence number for performing the waiting operation on the second WAN optimizer 201b and the first WAN optimizer 201a. The sequence number is a future sequence number (for example, SEQ=250) that is calculated from the data that is sent from the second WAN optimizer 201b.

Furthermore, when receiving a synchronization timing negotiation signal from the first WAN optimizer 201a, the second WAN optimizer 201b sends a network-okayed message including a designated sequence number to the first WAN optimizer 201a (Step S1723).

Until the sequence number 250 is reached, the first WAN optimizer 201a sends the packet, which is received from the second WAN optimizer 201b, to the radio terminal apparatus 202 (Step S1724). Furthermore, the first WAN optimizer 201a sends the ACK packet from the radio terminal apparatus 202 to the second WAN optimizer 201b (Step S1725). Until the sequence number 250 is reached, the second WAN optimizer 201b reads, by snooping, the packet in the high-speed protocol, which is sent to the radio terminal apparatus 202, and reads, by snooping, the ACK packet from the radio terminal apparatus 202, which is in response to the packet in the high-speed protocol (Step S1726).

Furthermore, the second WAN optimizer 201b sends the data to the first WAN optimizer 201a until the sequence number 250 is reached, and thereafter, temporarily interrupts the data transmission in such a manner that the data having a sequence number smaller than 250 is not sent (Step S1727).

Then, as illustrated in FIG. 18, the first WAN optimizer 201a waits until the radio terminal apparatus 202 receives an acknowledgement response before a number 250 is reached (No in Step S1801). When the acknowledgement response is received before the number 250 is reached (Yes in Step S1801), the first WAN optimizer 201a sends the termination point switching message to the second WAN optimizer 201b (Step S1802).

Here, in the case where lost data that is not received, is present among the items of data that are transmitted from the second WAN optimizer 201b, the first WAN optimizer 201a requests the second WAN optimizer 201b to retransmit the lost data. For example, in a case where based on the sequence number, the presence or absence of lost data is checked for, and, in a case where lost data is detected, the first WAN optimizer 201a requests the second WAN optimizer 201b to retransmit the lost data.

In the case where the first WAN optimizer 201a requests the second WAN optimizer 201b to retransmit the lost data, the second WAN optimizer 201b retransmits the lost data to the first WAN optimizer 201a. Even though the sequence for waiting is read by snooping, in the case where the lost data is not received from the second WAN optimizer 201b, the first WAN optimizer 201a does not send the termination point switching message (control signal) to the second WAN optimizer 201b. Furthermore, the first WAN optimizer 201a does not perform the switching to the snoop mode in Step S1806.

Furthermore, even if the sequence number for waiting is reached, in the case where the request for the retransmission of the lost data to the first WAN optimizer 201a is made, the second WAN optimizer 201b retransmits the lost data and then performs the switching to the proxy mode. Accordingly, even if lost data occurs before the switching between the transmission states is performed, the second WAN optimizer 201b can retransmit the lost data in the same protocol as when the data was first sent. Furthermore, the first WAN optimizer 201a can receive the lost data in the same protocol as when the lost data occurred. For this reason, the lost data can be made up for, and the data matching is possible before and after the switching between the transmission states.

When receiving the termination point switching message from the first WAN optimizer 201a, the second WAN optimizer 201b sends a switching-okayed message to the first WAN optimizer 201a (Step S1803). Furthermore, the second WAN optimizer 201b switches from the snoop mode to the proxy mode (Step S1804). The interrupted data transmission is resumed (Step S1805).

When receiving a switching-okayed message from the second optimizer 201b, the first WAN optimizer 201a switches from the proxy mode to the snoop mode (Step S1806). When receiving the packet in TCP, the first WAN optimizer 201a in the snoop mode performs the relaying at the IP packet level, reads the header in the protocol of TCP by snooping (Step S1807), and updates the header information within the second management table 432.

### One Example of Receiving Processing that is Performed by the WAN Optimizer

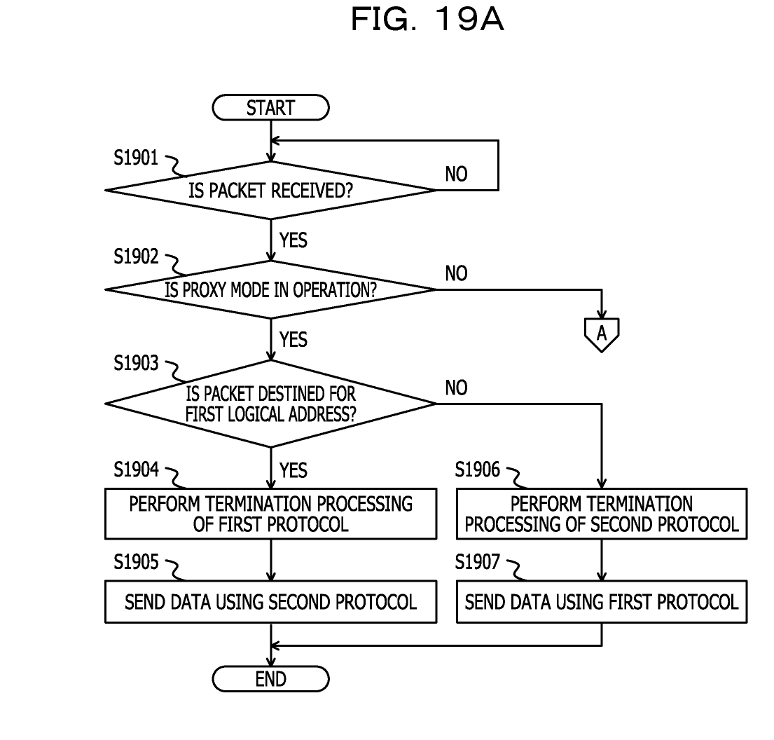

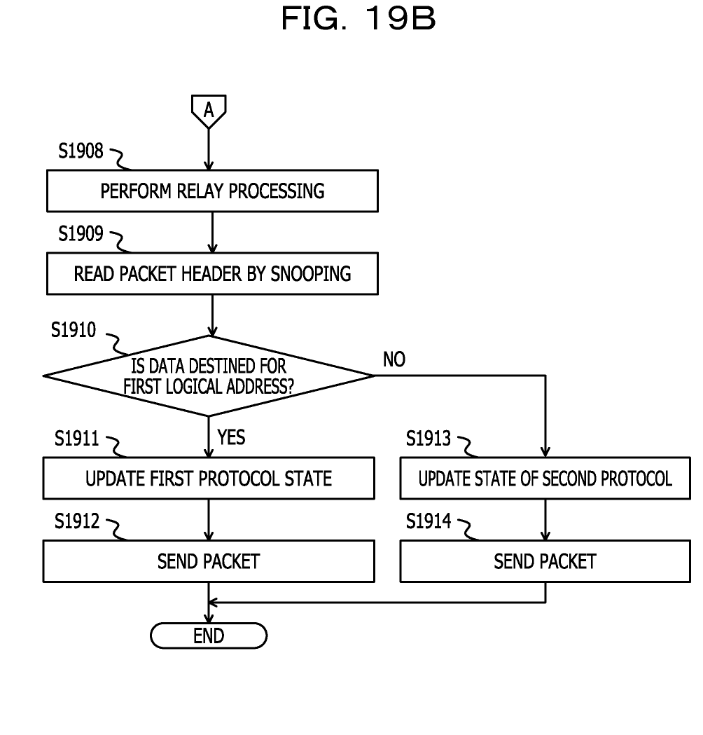

FIG. 19A is the first portion of a flowchart illustrating packet receiving processing that is performed by the WAN optimizer. FIG. 19B is the second and last portion of the flowchart illustrating the packet receiving processing that is performed by the WAN optimizer. In FIGS. 19A and 19B, the WAN optimizer 201, for example, includes the first WAN optimizer 201a and the second WAN optimizer 201b.

In FIGS. 19A and 19B, the WAN optimizer 201 determines whether or not a packet is received (Step S1901). The WAN optimizer 201 waits until the packet is received (No in Step S1901), and, when the packet is received (Yes in Step S1901), determines whether the proxy mode is in operation (Step S1902). In a case where the proxy mode is in operation (Yes in Step S1902), by referring to a destination address in a packet header, the WAN optimizer 201 determines whether or not the packet is destined for a first logical address (Step S1903).

The first logical address is, for example, an address that terminates the high-speed protocol, and is a logical IP-B. In a case where the packet is destined for the first logical address (Yes in Step S1903), the WAN optimizer 201 performs termination processing of a first protocol (high-speed protocol) (Step S1904). Then, the WAN optimizer 201 sends the packet, whose protocol is converted into a second protocol by the termination processing of the first protocol, using a second protocol (TCP) (Step S1905), and ends a processing sequence illustrated in the present flowchart.

In Step S1903, in a case where the packet is not destined for the first logical address (No in Step S1903), that is, in a case where that the packet is destined for a second logical address, the WAN optimizer 201 performs the termination processing of the second protocol (Step S1906). The second logical address is, for example, an address that terminates TCP, and is a logical IP-A. Then, the WAN optimizer 201 sends the packet, whose protocol is converted into the first protocol by the termination processing of the second protocol, using the first protocol (Step S1907), and ends a processing sequence illustrated in the present flowchart.

In Step S1902, in a case where the proxy mode is not in operation (No in Step S1902), that is, in a case where the snoop mode is in operation, the WAN optimizer 201 performs packet relay processing such as searching an IP path table (Step S1908), and reads the packet header by snooping (Step S1909).

Next, referring to the destination address in the packet header, the WAN optimizer 201 determines whether or not the packet is destined for the first logical address (Step S1910). In a case where the packet is destined for the first logical address (Yes in Step S1910), the WAN optimizer 201 updates the first management table 431 for the first protocol using the header information read by snooping (Step S1911). Moreover, the WAN optimizer 201 sends the packet to an interface that is determined referring to the IP path table (Step S1912), and ends the processing sequence illustrated in the present flowchart.

In Step S1910, in a case where the packet is not destined for the first logical address (No in Step S1910), the WAN optimizer 201 updates the second management table 432 for the second protocol using the read by snooping (Step S1913). Moreover, the WAN optimizer 201 sends the packet to the interface that is determined referring to the IP path table (Step S1914), and ends the processing sequence illustrated in the present flowchart.

### One Example of Mode Transition Processing that is Performed by the WAN Optimizer

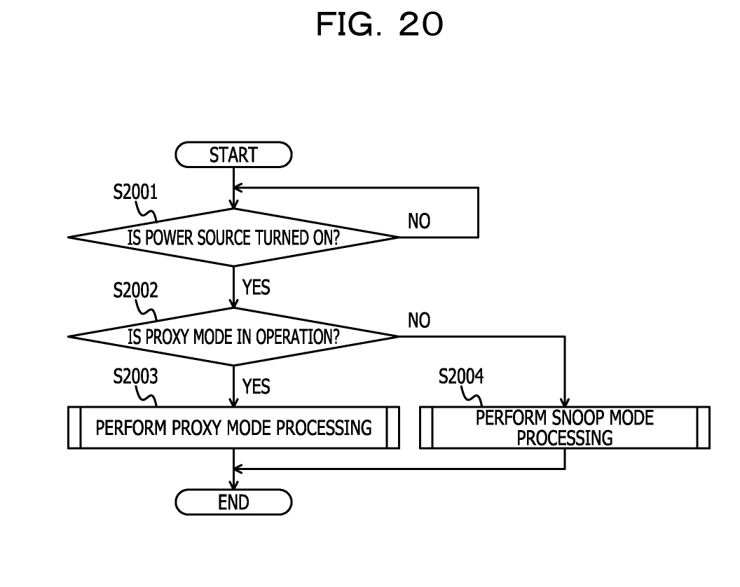

FIG. 20 is a flowchart illustrating one example of mode transition processing that is performed by the WAN optimizer. In FIG. 20, the WAN optimizer 201, for example, includes the first WAN optimizer 201a and the second WAN optimizer 201b.

In FIG. 20, the WAN optimizer 201 determines whether or not a power source is turned on (Step S2001). The WAN optimizer 201 waits until the power source is turned on (No in Step S2001), and, when the power source is turned on (Yes in Step S2001), determines whether or not a proxy mode is in operation (Step S2002). In a case where the proxy mode is in operation (Yes in Step S2002), the WAN optimizer 201 performs proxy mode processing (Step S2003) and ends the processing sequence as illustrated in the present flowchart.

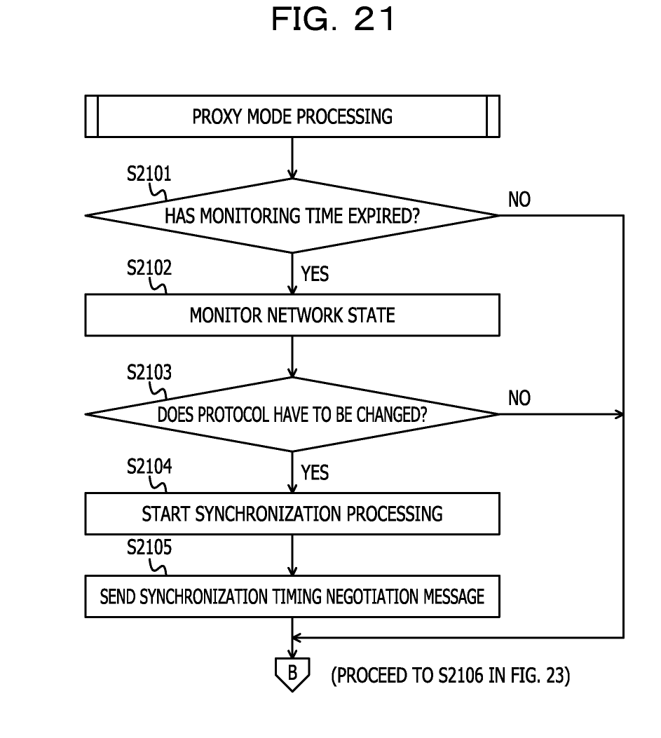

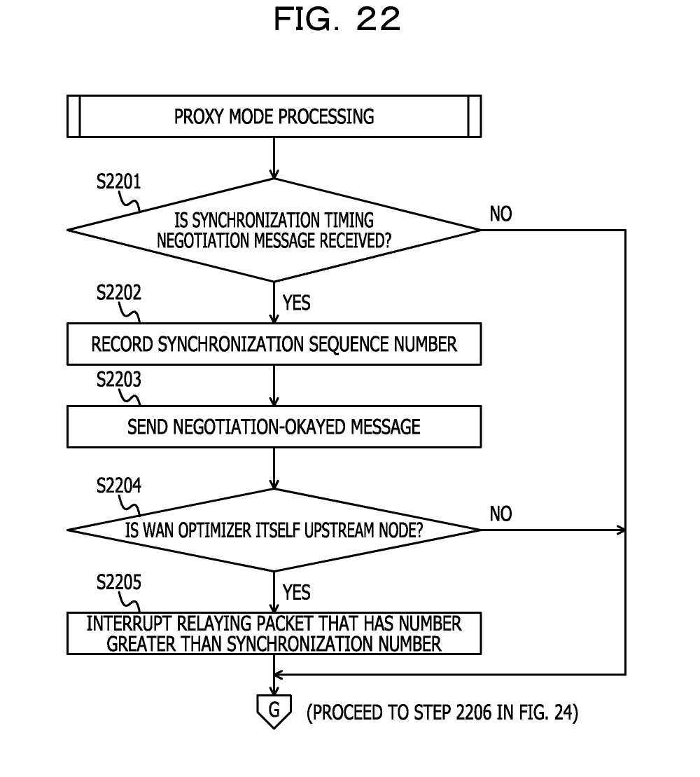

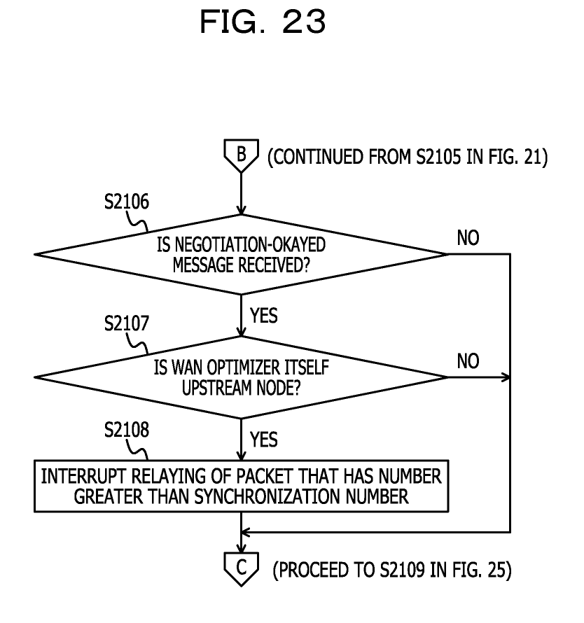

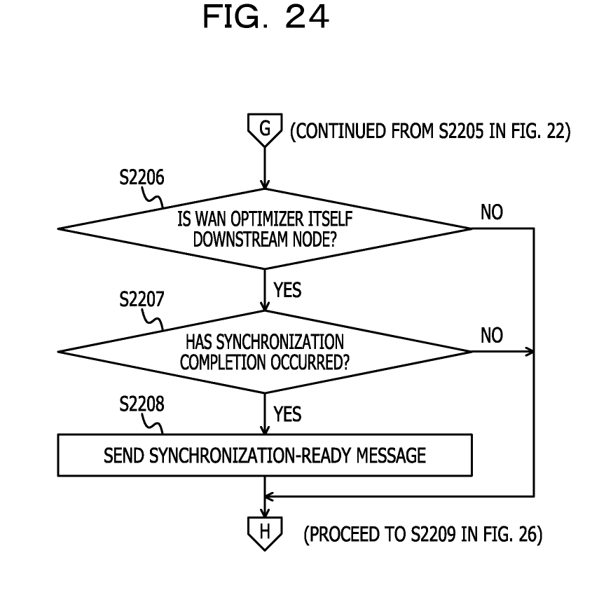

The proxy mode processing will be described below referring to FIGS. 21, 23, 25 and 27. In a case where the proxy mode is not in operation (No in Step S2002), that is, in a case where the snoop mode is in operation, the WAN optimizer 201 performs snoop mode processing (Step S2004), and ends the processing sequence as illustrated in present flowchart. The snoop mode processing will be described below referring to FIGS. 22, 24, and 26.

Here, the proxy mode processing and the snoop mode processing are described referring to FIGS. 21 to 27. The proxy mode processing and the snoop mode processing are hereinafter alternately described considering a relationship between transmitting and receiving message.

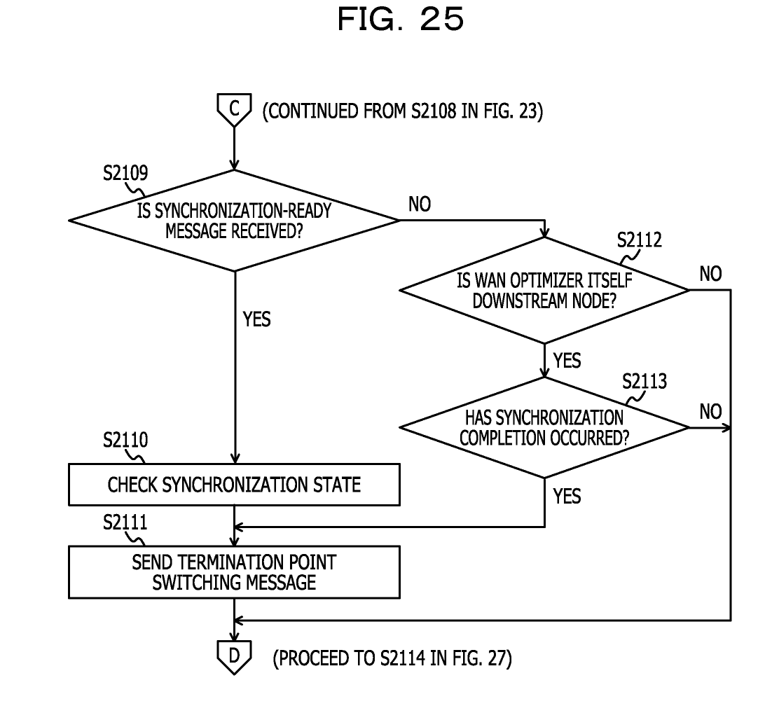

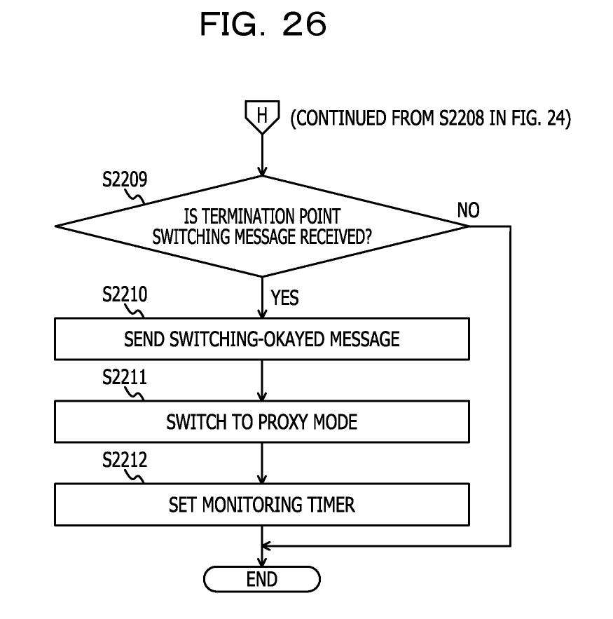

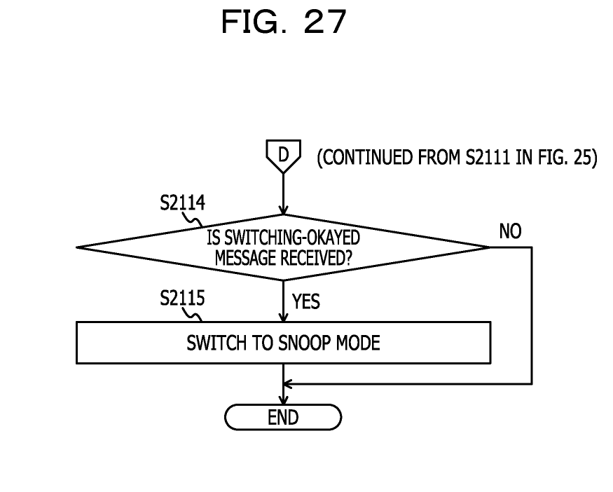

FIG. 21 is the first portion of a flowchart illustrating one example of the proxy mode processing that is performed by the WAN optimizer. FIG. 22 is the first portion of a flowchart illustrating one example of the snoop mode processing that is performed by the WAN optimizer. FIG. 23 is the second portion of the flowchart illustrating one example of proxy mode processing that is performed by the WAN optimizer. FIG. 24 is the second portion of the flowchart illustrating one example of snoop mode processing that is performed by the WAN optimizer. FIG. 25 is the third portion of the flowchart illustrating one example of proxy mode processing that is performed by the WAN optimizer. FIG. 26 is the third and last portion of the flowchart illustrating one example of snoop mode processing that is performed by the WAN optimizer. FIG. 27 is the fourth and last portion of the flowchart illustrating one example of proxy mode processing that is performed by the WAN optimizer.

In FIGS. 21 to 27, the WAN optimizer 210 in the proxy mode 201 determines whether or not a monitoring timer for performing quality measurement has timed-out (Step S2101). In a case where the monitoring timer has not timed-out (No in Step S2101), the processing proceeds to Step S2106. In a case where the monitoring timer has timed-out (Yes in Step S2101), the WAN optimizer 201 monitors a network state using a result of the measuring by the first quality measurement unit 441 or the second quality measurement unit 442 (Step S2102).

For example, in a case where the first WAN optimizer 201a is in the proxy mode, the network state is monitored using the result of the first quality measurement unit 441 of the first WAN optimizer 201a measuring the high-speed protocol. Furthermore, in a case where the second WAN optimizer 201b is in the proxy mode, the network state is monitored using the result of the second quality measurement unit 442 of the second WAN optimizer 201b measuring the high-speed protocol.

As a result of monitoring the network state, it is determined whether or not the protocol has to be changed based on a change in a link congestion state (Step S2103). In a case where the protocol does not have to be changed (No in Step S2103), the WAN optimizer 201 proceeds to Step S2106. In a case where has to be changed the protocol (Yes in Step S2103), the WAN optimizer 201 starts synchronization processing for performing synchronization with the WAN optimizer 201 of the other party (in the snoop mode) that performs switching of the termination point of TCP (Step S2104). Then, the WAN optimizer 201 sends the synchronization timing negotiation message to the WAN optimizer 201 of the other party in the snoop mode (Step S2105) and proceeds to Step S2106.

As illustrated in FIG. 22, the WAN optimizer 201 in the snoop mode determines whether or not the synchronization timing negotiation message (refer to Step S2105 in FIG. 21) is received from the WAN optimizer 201 in the proxy mode (Step S2201). In a case where the synchronization timing negotiation message is not received (No in Step S2201), the WAN optimizer 201 proceeds to Step S2206. When receiving the synchronization timing negotiation message (Yes in Step S2201), the WAN optimizer 201 records a synchronization sequence number for waiting (Step S2202).

Then, the WAN optimizer 201 sends a network-okayed message to the WAN optimizer 201 in the proxy mode of the other party (Step S2203). Moreover, the WAN optimizer 201 determines if it is an upstream node (Step S2204). In a case where it is not an upstream node (No in Step S2204), the WAN optimizer 201 proceeds to Step S2206. In a case where it is an upstream node (Yes in Step S2204), the WAN optimizer 201 temporarily interrupts the relaying of the packet that has a number greater than a synchronization number (Step S2205), and the WAN optimizer 201 proceeds to Step S2206.

As illustrated in FIG. 23, the WAN optimizer 201 in the proxy mode determines whether or not the network-okayed message (refer to Step S2203 in FIG. 22) is received from the WAN optimizer 201 in the snoop mode (Step S2106). In a case where the network-okayed message is not received (No in Step S2106), the WAN optimizer 201 proceeds to Step S2109. In a case where the network-okayed message is received (Yes in Step S2106), the WAN optimizer 201 determines whether or not it is an upstream node (Step S2107).

In the case where it is not an upstream node (No in Step S2107), the WAN optimizer 201 proceeds to Step S2109. In the case where it is an upstream node (Yes in Step S2107), the WAN optimizer 201 interrupts the relaying of the packet that has a number greater than the synchronization number (Step S2108), and proceeds to Step S2109.

As illustrated in FIG. 24, the WAN optimizer 201 in the snoop mode determines whether or not it is a downstream node (Step S2206). In a case where it is not a downstream node (No in Step S2206), the WAN optimizer 201 proceeds to Step S2209. In a case where it is a downstream node (Yes in Step S2206), the WAN optimizer 201 determines whether or not synchronization completion meaning that the synchronization was performed with the sequence number for waiting occurs (Step S2207).

In a case where the synchronization completion does not occur (No in Step S2207), the WAN optimizer 201 proceeds to Step S2209. In a case where the synchronization completion occurs (Yes in Step S2207), the WAN optimizer 201 sends the synchronization-ready message to the WAN optimizer 201 in the proxy mode (Step S2208) and proceeds to Step S2209.

As illustrated in FIG. 25, the WAN optimizer 201 in the proxy mode determines whether or not the synchronization-ready message (refer to Step S2208 in FIG. 24) from the WAN optimizer 201 in the snoop mode is received (Step S2109). In a case where the synchronization-ready message is received (Yes in Step S2109), the WAN optimizer 201 checks a sequence synchronization state (Step S2110). The checking of the sequence synchronization state is defined as, for example, checking whether the ACK signal is received in response to the sent packet. Then, the WAN optimizer 201 sends the termination point switching message to the WAN optimizer 201 in the snoop mode (Step S2111) and proceeds to Step S2114.

In Step S2109, in a case where the synchronization-ready message is not received (No in Step S2109), the WAN optimizer 201 determines whether or not it is a downstream node (Step S2112). In a case where it is not a downstream node (No in Step S2112), the WAN optimizer 201 proceeds to Step S2114. In the case where it is a downstream node (Yes in Step S2112), the WAN optimizer 201 determines whether or not the synchronization completion in a TCP state is detected (Step S2113).

In a case where the synchronization completion in the TCP state is not detected (No in Step S2113), the WAN optimizer 201 proceeds to Step S2114. In a case where the synchronization completion in the TCP state is detected (Yes in Step S2113) is detected, the WAN optimizer 201 proceeds to Step S2111.

As illustrated in FIG. 26, the WAN optimizer 201 in the snoop mode determines whether or not the termination point switching message (refer to Step S2111 in FIG. 25) is received from the WAN optimizer 201 in the proxy mode (Step S2209). In a case where the termination point switching message is not received (No in Step S2209) the WAN optimizer 201 ends the snoop mode processing. In a case where the termination point switching message is received (Yes in Step S2209), the WAN optimizer 201 sends a switching-okayed message to the WAN optimizer 201 in the proxy mode (Step S2210). Then, the WAN optimizer 201 ends the snoop mode and switches to the proxy mode (Step S2211), and sets the monitoring timer for periodically performing the quality measurement (Step S2212) and ends the snoop mode processing.

As illustrated in FIG. 27, the WAN optimizer 201 in the proxy mode determines whether or not the switching-okayed message (refer to Step S2210 in FIG. 26) is received from the WAN optimizer 201 in the snoop mode (Step S2114). In a case where the switching-okayed message is not received (No in Step S2114), the WAN optimizer 201 ends the proxy mode processing. In a case where the switching-okayed message is received (Yes in Step S2114), the WAN optimizer 201 ends the proxy mode and switches to the snoop mode (Step S2115), and ends the proxy mode processing.

### One Example of a Format of the Management Table

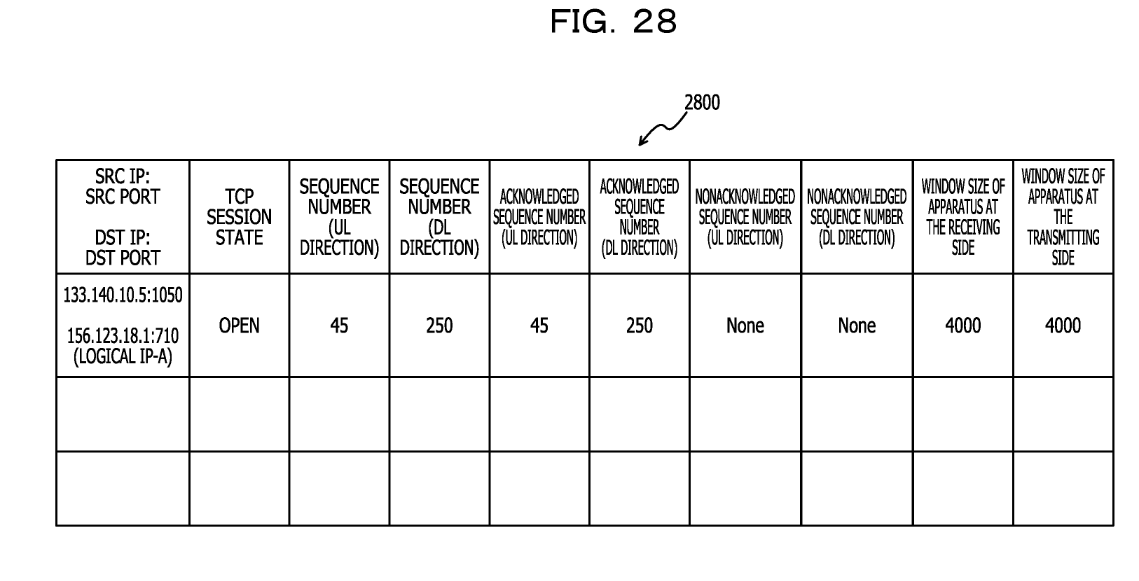

FIG. 28 is a descriptive diagram illustrating one example of a format of the management table. In FIG. 28, for example, the format of the second management table 432 of the first WAN optimizer 201a is described, but this description is also true for the first management table 431 of the first WAN optimizer 201a or for the management tables 431 and 432 of the second WAN optimizer 201b. In a format 2800 illustrated in FIG. 28, an IP address of the radio terminal apparatus 202 is set to 133.140.10.5. Furthermore, a port number associated with an application that runs is set to 1050. Furthermore, the radio terminal apparatus 202 is set to connect to a logical IP-A (156.123.18.1) and a port number 710 of the WAN optimizer 201 in order to communicate with the server 203.

When a new TCP session is extended and the SYN packet and the SYN/ACK packet are checked, the beacon processing unit 423 appends an entry to the second management table 432 and opens the TCP session. Thereafter, the second snoop unit 422 updates a source IP address (SRC IP) field and a destination IP protocol (DST IP) address field, referring to an IP header each time the packet in TCP is read by snooping. Furthermore, the second snoop unit 422 updates a sequence number, an acknowledged sequence number, an unacknowledged sequence number, and a window size field, referring to TCP header information.

(Configuration of the Packet in TCP)

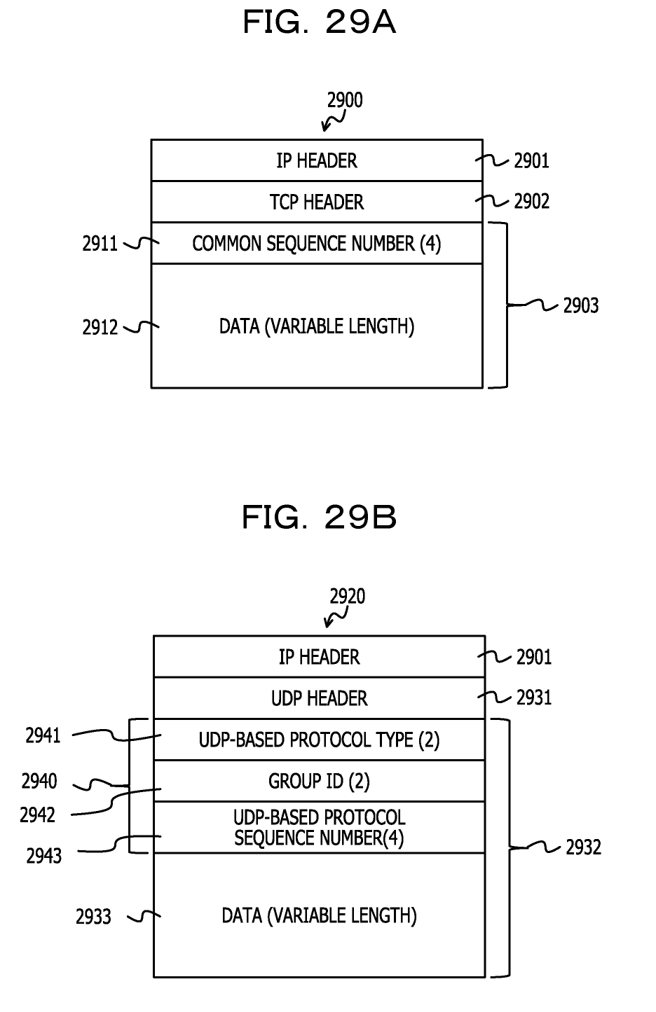

FIGS. 29A and 29B are diagrams, each for describing one example of a configuration of the packet in TCP. As illustrated in FIG. 29A, a packet 2900 in TCP includes an IP header 2901, a TCP header 2902, and a payload 2903.

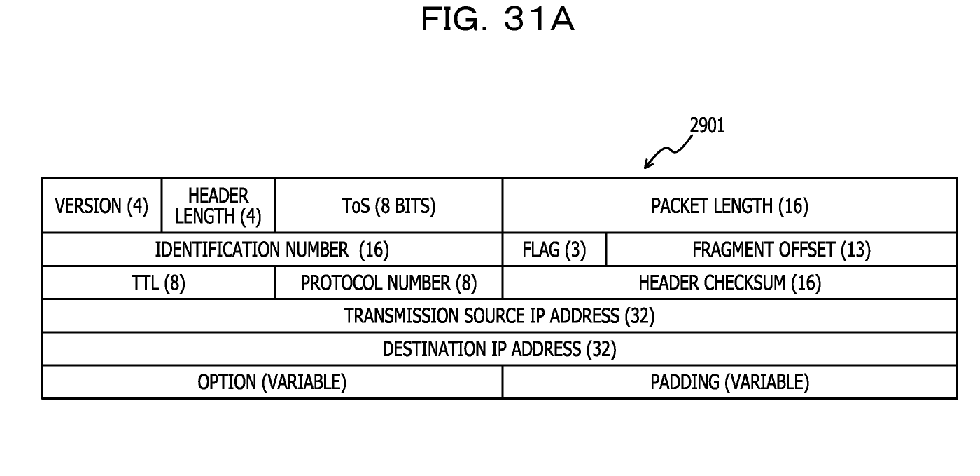

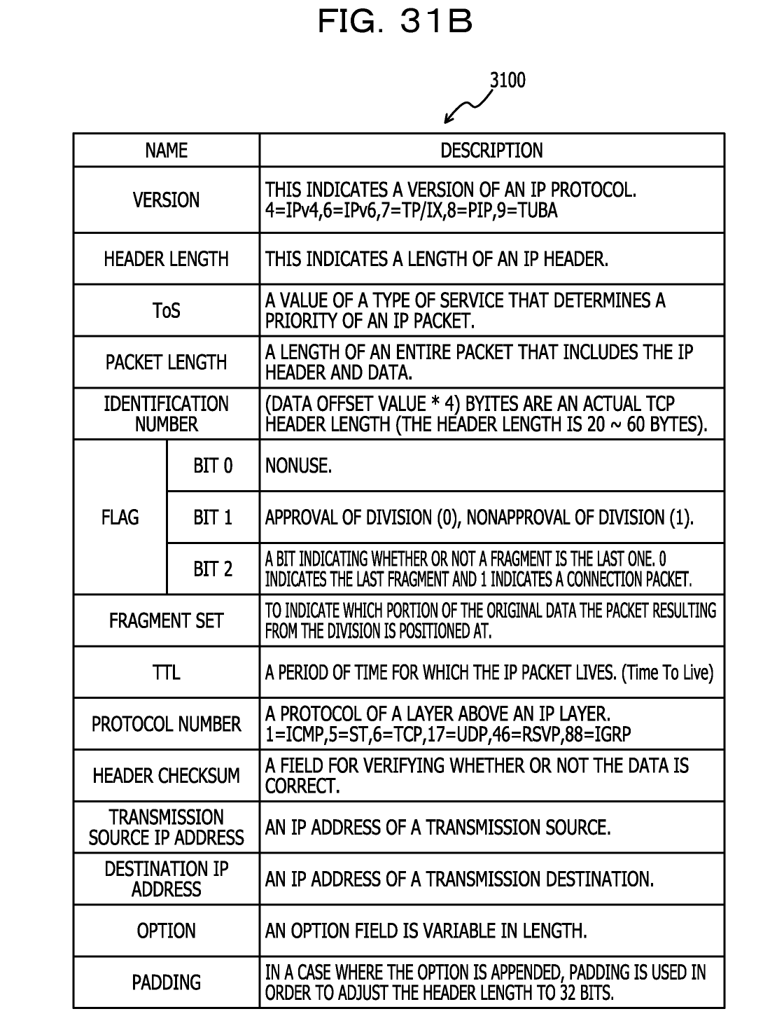

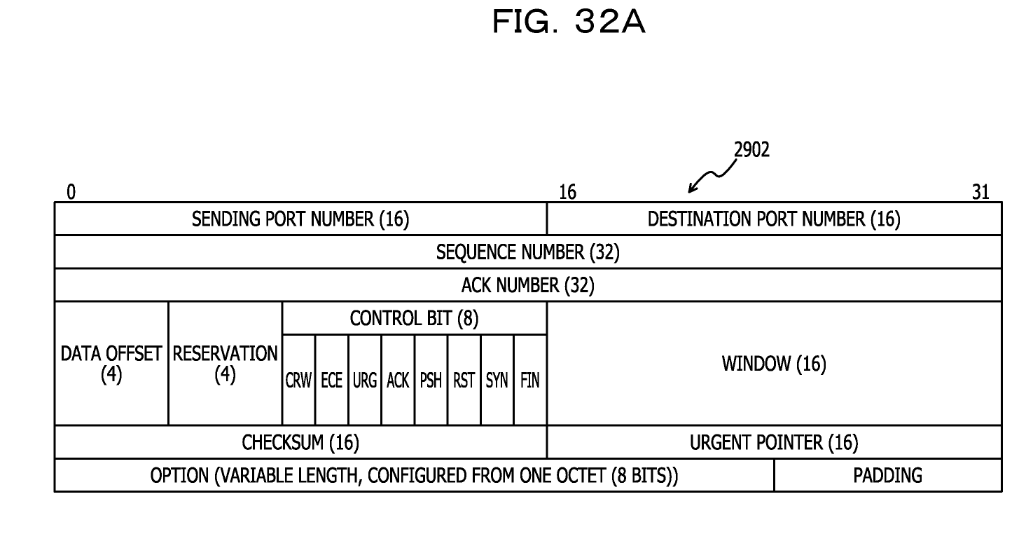

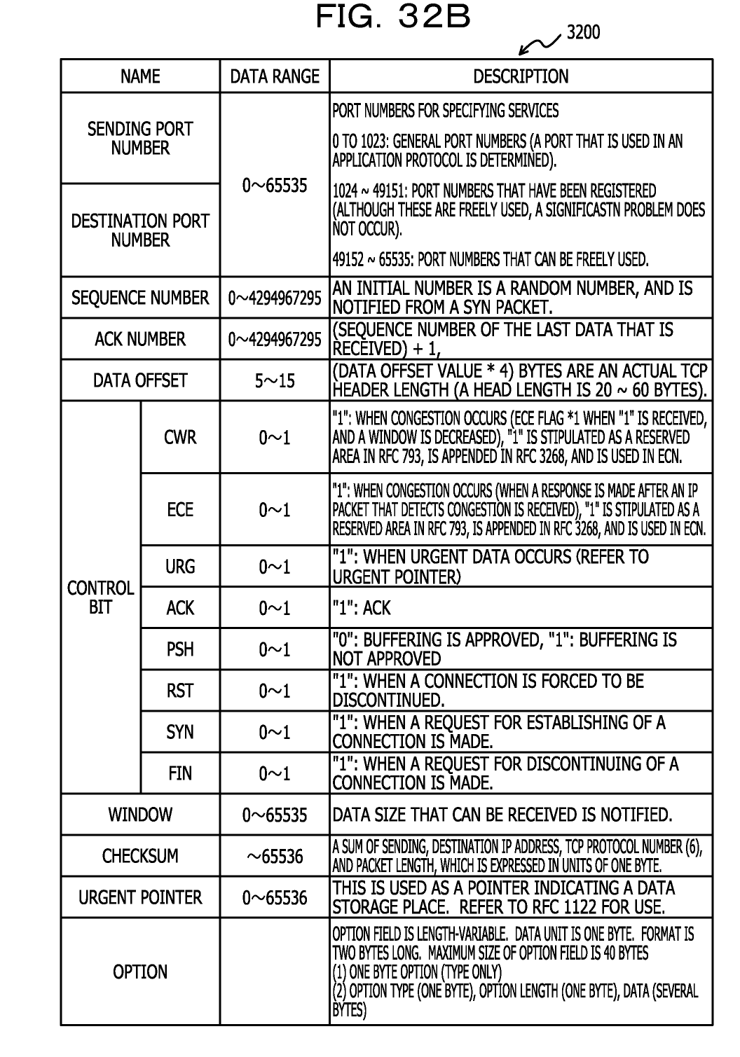

Control information that occupies a front portion of the packet is stored in the IP header 2901. The IP header 2901 will be described in detail below referring to FIG. 31A. Control information for using TCP is stored in the TCP header 2902. The TCP header 2902 will be described in detail below referring FIG. 32A. The payload 2903 includes a common sequence number 2911 and data 2912. The common sequence number 2911 is identification information on the packet 2900 in TCP.

(Configuration of the Packet in the High-Speed Protocol)

FIG. 29B is a descriptive diagram illustrating one example of a configuration of a packet in the high-speed protocol. As illustrated in FIG. 29B, a packet 2920 in the high-speed protocol includes the IP header 2901, a UDP header 2931, and an UDP header 2932. Control information for using UDP is stored in the UDP header 2931. The UDP header 2932 includes a UDP-based protocol header 2940 and data 2933. The UDP-based protocol header 2940 includes a UDP-based protocol type 2941, a group ID 2942, and a UDP-based protocol sequence number 2943.

An identification number for identifying a high-speed protocol type such as UNAP is stored in the UDP-based protocol type 2941. Here, when measuring the communication quality using a packet in UNAP that includes user data, the second quality measurement unit 442 sends consecutive specific amounts of consecutive packets and measures a discard rate of a network using the discarded packets among them. ID's for identifying the consecutive amounts of packets described above are stored in the group ID 2942. Numbers for distinguishing between the packets in order to perform retransmission control are stored in the UDP-based protocol sequence number 2943. The UDP-based protocol sequence number 2943 is identification information on the packet 2920 in the high-speed protocol.

Next, a format of the measurement packet that is used for the initial quality measurement unit 460 to measure quality between each of the first WAN optimizer 201a, the second WAN optimizer 201b, and the third WAN optimizer 201c will be described.

(Configuration of a TCP Measurement Packet)

FIG. 30A is a descriptive diagram illustrating one example of a configuration of a TCP measurement packet. In FIG. 30A, constituent elements that are the same as those illustrated in FIG. 29A are given the same reference numerals, and descriptions of them are omitted. As illustrated in FIG. 30A, a TCP measurement packet 3000 includes a TCP option header 3001. The common sequence number 2911 is identification information on the TCP measurement packet 3000.

FIG. 30B is a descriptive diagram illustrating one example of a configuration of the TCP option header. In FIG. 30B, the TCP option header 3001 includes an option code, a size, a group ID, and a measurement sequence number. A code indicating that the measurement packet is present is stored in the option code. ID's that distinguish between the consecutive specific amounts of packets described above are stored in the group ID. A fixed amount of measurement packets (for example, 100 measurement packets) that have the same group ID is consecutively sent in measuring the communication quality, but numbers for distinguishing between the packets in each group are stored in the measurement sequence number.

(Configuration of a High-Speed-Protocol Measurement Packet)

FIG. 30C is a descriptive diagram illustrating one example of a configuration of the high-speed-protocol measurement packet. In FIG. 30C, constituent elements that are the same as those illustrated in FIG. 29B are given the same reference numerals, and descriptions of them are omitted. As illustrated in FIG. 30C, a high-speed-protocol measurement packet 3020 includes a measurement sequence number 3021 and dummy data 3022.

A fixed amount of measurement packets (for example, 100 measurement packets) that have the same group ID is consecutively sent in measuring the communication quality, but numbers for distinguishing between the packets in each group are stored in the measurement sequence number 3021. The measurement sequence number 3021 is identification information on the high-speed-protocol measurement packet 3020. Dummy data that has a variable length is stored in the dummy data 3022. Furthermore, an ID, different from an ID indicating UNAP, indicating the measurement packet is stored in the UDP-based protocol type 2941.

### One Example of the IP Header

FIG. 31A is a descriptive diagram illustrating one example of the IP header. FIG. 31B is a descriptive diagram illustrating one example of details of a IP header. As illustrated in the IP header 2901 in FIG. 31A and a table 3100 in FIG. 31B, a “version” indicates a version of the IP protocol. The “version” indicates 4 (Internet Protocol Version 4 (IPv4)), 6 (IPv6), 7 (TP/IX: The Next Internet), 8 (P Internet Protocol (PIP), and 9 (TUBA). A “header length” indicates a length of the IP header. A “type of service (ToS)” indicates a priority, a delay, and the like of the IP packet. A “Packet length” indicates a length of the entire packet that includes the IP header and the data.

An “identification number” is a sequential number indicating each IP datagram. A “flag” is a value indicating a delivery method to be used, and is used when division of the IP packet is controlled. A “flag” is any one of a bit 0 indicating nonuse, a bit 1 indicating whether or not the division is approved, and a bit 2 indicating whether or not a fragment is the last one. A “fragment offset” indicates which portion of the original data a packet resulting from division is positioned at. A “time to live (TTL)” indicates a period of time for which the IP packet lives, and for example, indicates the number of routers through which the packet is allowed to pass. Each time the packet passes through one router, the number of routers decreases by one. When the number of routers reaches 0, the packet is discarded.

A “protocol number” indicates a protocol of a layer above an IP layer and indicates a type of protocol such as TCP or UDP. A “header checksum” is a field for verifying whether or not the data is correct. A “transmission source IP address” is an IP protocol of a transmission source. A “destination IP address” is an IP address of a transmission destination. An “option” is arbitrary data, and for example, is information for setting an option that is appended to the IP packet. “Padding” is used in order to adjust a head length to 32 bits in a case where the option is appended.

### One Example of the TCP Header

FIG. 32A is a descriptive diagram illustrating one example of the TCP header. FIG. 32B is a descriptive diagram illustrating one example of details of a TCP header. In the TCP header 2902 in FIG. 32A and a table 3200 in FIG. 32B, a “transmission port number” and a “destination port number” are numbers for specifying a service.

A “sequence number” is a field that designates a number for performing sequencing to the data (data in bytes) that is sent. The sequence number is assigned in such a manner that the sequence number increases by one for every byte of the data that is sent, and how far the data is sent can be designated. The “sequence number” is managed on the side that transmits the data in TCP. Each time the data is sent, the sequence number that is as great as the number of packets of the data that is sent, is added and is sent with the packet in TCP.

An “ACK number” is a field that indicates up to and including which byte position of the received data the bytes are received. The “ACK number” is set to be in a response packet in TCP and is sent in order to indicate up to and including which byte position of the received data the data receiving side receives. Only in the case of an ACK flag to be described below, an ACK number field is set to be effective.

“Data offset” is a field indicating a position from which the data in TCP starts. “Reservation” is provided for future extension, and all bits are set to “0.” Each field for a control bit is a one-bit flag field, and, by default, initial values are all set to 0. However, when a value is 1, each flag is effective.

A “CWR (congestion window reduced)” flag and a “ECE (echo congestion experience)” flag are bits for congestion control. A “URG (urgent) flag indicates that “urgent data” is included in the packet in TCP. An “ACK (acknowledgement) flag indicates that an effective ACK number is included in the TCP header.

A “PSH (push)” flag is a flag for making a request for prompt delivery of the received data to a higher-level application. A “RST (reset)” flag is set in a case where interruption or rejection of TCP connection is desired. In a case where the TCP connection has been interrupted for a long time due to an error and the like and thus, integrity between the sequence number and the ACK number is not achieved, when the packet in TCP, in which the RST flag is set, is sent instead of returning an ACK, the current TCP connection can be forced to be ended.

A “SYN (synchronize)” flag is used to start the TCP connection. Accordingly, opening processing of the TCP connection is started. Because TCP is for a two-way communication path, the SYN flag is set to be in initial connection request packets that are sent from both sides, respectively. In a case where the packet in which SYN is set is received, preparation is made for performing post-synchronization communication by synchronizing the packet with the sequence number according to which the ACK number of the packet itself is received.

A “FIN (finish)” flag is used to end the TCP connection. The packet in which the FIN flag is set means that no further receive data is desired, and ending processing is started on the side that receives the packet in which the FIN flag is set.

A “window” is used to report a window size of the receiving side to the other party. The TCP receiving side determines a maximum amount of data that can be sent, based on the window size notified by the other party. For example, window size=0 means that data is not received. That is, by window size=0, the transmitting side is requested to stop sending the data.

“Checksum” is a field for storing check data for checking integrity of the packet in TCP. An “urgent pointer” is a field that is used to designate a numerical value indicating a place (size) where urgent data is present, when the URG flag is set in a case where the urgent data is included in the packet in TCP.

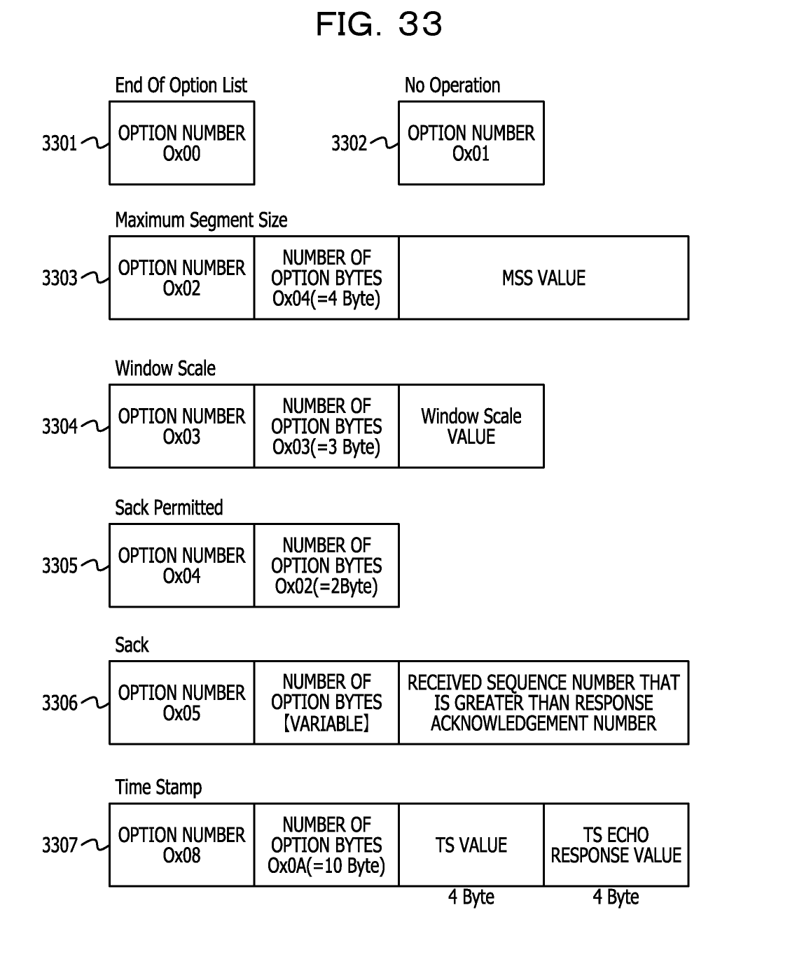

An “option” is used to set various kinds of characteristics in the TCP connection, and can be individually set for every TCP connection. The “option” is has a variable length of byte units, and multiple options can be set at the same time. One example of an “option type” will be described below referring to FIG. 33. “Padding” is a field that is used to make an adjustment by entering meaningless data, “0,” in order to express a length of the TCP header as an integer of 32 bits.

### One Example of the “Option” Type for TCP

FIG. 33 is a descriptive diagram illustrating one example of the “option” type for TCP. In “End of Option List,” an option type 3301 in FIG. 33, an option number is 0 and this indicates that there are no more options. There is a likelihood that the multiple options for TCP will be sequentially arranged side by side in one TCP header, but the “End of Option List” indicates that there are not more options and a subsequent option is not present.

In “No Operation,” an option type 3302, the option number is 1 and this means that nothing is done. The “No Operation” is used as a delimiter between options. For example, the option field is arranged such that its total size is equal to 32 bits (4 bytes) in terms of units.

In “Maximum Segment Size,” an option type 3303, the option number is 2. The “Maximum Segment Size” is an option for notifying the communication partner of a maximum size of a segment that can be received. The “Maximum Segment Size” is used to negotiate a size of a segment that can be mutually received when the SYN packet for a TCP 3-way handshake is sent.

In “Window Scale,” an option type 3304, the option number is 3. The “Window Scale” is an option that is used to further increase the widow size that is limited to a maximum 64 Kbytes due to standard specifications for TCP.

In “Sack Permitted,” an option type 3305, the option number is 4, and this indicates that a selective acknowledgement can be used. In “Sack,” an option type 3306, the option number is 5. The “Sack” is used to optimize a response algorithm of an acknowledgement. For example, in communication among hosts, in which “Sack Permitted” is indicated, at the time of the 3-way handshake, only data that is missing at the transmitting side can be retransmitted.

In “Time Stamp,” an option type 3307, the option number is 8. The “Time Stamp” is used to embed a time stamp (sending time) into the packet. In the timing of the 3-way handshake, by appending the option of the “Time Stamp,” it is possible to calculate RU any time while the connection is being established.

### One Example of Control Data

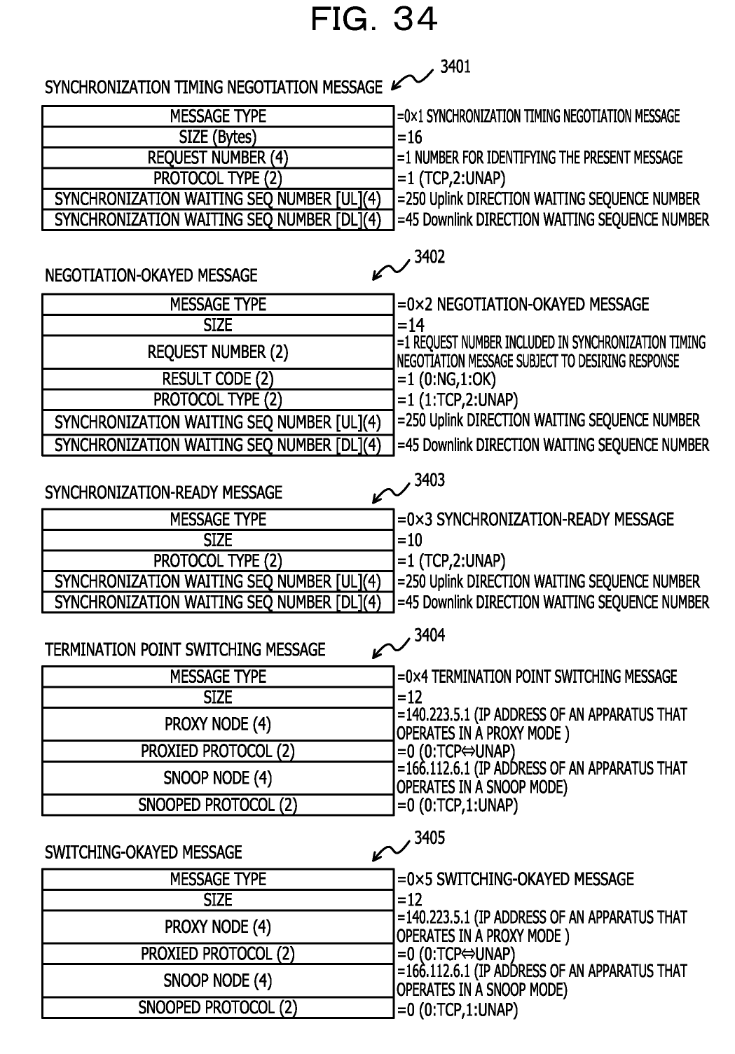

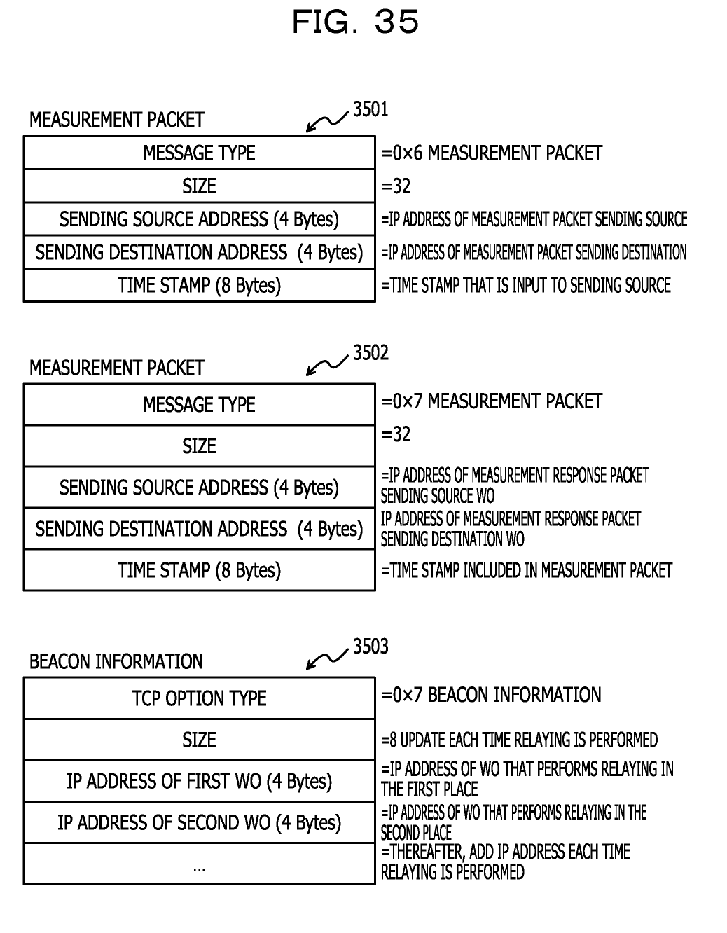

Next, one example of control data will be described referring to FIGS. 34 and 35.

FIG. 34 is the first portion of a descriptive diagram illustrating one example of the control data. As illustrated in FIG. 34, as data, there are a synchronization timing negotiation message 3401, a network-okayed message 3402, a synchronization-ready message 3403, a synchronization-ready message 3404, and a switching-okayed message 3405. The messages 3401 to 3405 such as these are pieces of information that are appended to a payload.

The synchronization timing negotiation message 3401 includes a message type, a size, a request number, a protocol type, and a synchronization waiting sequence (SEQ) number. The message type indicates a type of the present message. The size is a size of the present message. The request number is a number for identifying a message according to the present embodiment. The protocol type indicates either TCP or UNAP. The synchronization waiting sequence number is a sequence number for performing the waiting operation with respect to either uplink or downlink. Descriptions of contents of each piece of data that are the same as those of the synchronization timing negotiation message 3401 are hereinafter omitted.

The network-okayed message 3402 includes a message type, a size, a request number, a code of result, a protocol type, and a synchronization waiting sequence number. The request number is a request number that is included in the synchronization timing negotiation message subject to desiring a response. The result code indicates either OK indicating negotiation approval or NG indicating negotiation refusal. The synchronization-ready message 3403 includes a message type, a size, a protocol type, and a synchronization waiting sequence number.

The synchronization-ready message 3404 includes a message type, a size, a PROXY NODE, a PROXIED protocol, a SNOOP NODE, and a SNOOPED protocol. The PROXY NODE is an IP address of the WAN optimizer 201 that operates in the proxy mode. The PROXIED protocol indicates the switching between TCP and UNAP. The SNOOP NODE is an IP address of the WAN optimizer 201 that operates in the snoop mode. The SNOOPED protocol indicates a protocol (TCP or UNAP) that is a target for snooping. The switching-okayed message 3405 includes a message type, a size, a PROXY NODE, a PROXIED protocol, a SNOOP NODE, and a SNOOPED protocol.

FIG. 35 is the second and last portion of the diagram of one example of control data. As illustrated in FIG. 35, as data, there are a measurement packet 3501, a measurement response packet 3502, and a measurement response packet 3503. The measurement packet 3501 and the measurement response packet 3502 are pieces of information that are appended to the payload. The measurement response packet 3503 is information that is stored in the TCP option header 3001 (refer to FIG. 30A).

The measurement packet 3501 includes a message type, a size, a sending address, a size, a sending source address, a sending destination address, and a time stamp. The sending source address of the measurement packet 3501 is an IP address of the WAN optimizer 201 that sends the measurement packet. The sending destination address of the measurement packet 3501 is an IP address of the WAN optimizer 201 that is a sending destination of the measurement packet. The time stamp in the measurement packet 3501 indicates the time when the sending source sends the measurement packet 3501.

The measurement response packet 3502 includes a message type, a size, a sending source address, a sending destination address, and a time stamp. The sending source address of the measurement response packet 3502 is an IP address of the WAN optimizer 201 that sends the measurement response packet. The sending destination address of the measurement response packet 3502 is an IP address of the WAN optimizer 201 that is the sending source of the measurement response packet. The time stamp of the measurement response packet 3502 is a time stamp included in the measurement packet.

The measurement response packet 3503 includes a TCP option type, a size, an IP address of the first WAN optimizer, and an IP address of the second WAN optimizer. The TCP option type indicates a type of the present information. The size is a data size of the measurement response packet 3503, and is updated each time the relaying is performed. The IP protocol of the first WAN optimizer is an IP address of the WAN optimizer 201 that performs the relaying in the first place. The IP protocol of the second WAN optimizer is an IP address of the WAN optimizer 201 that performs the relaying in the second place. IP addresses of the WAN optimizers 201 that perform the relaying in the third place, in the fourth place, and so forth are sequentially recorded each time the relaying is performed.

### Modification Example of the Embodiment

Next, a modification example of the embodiment will be described. Moreover, in the modification example, constituent elements that are the same as those described above according to the embodiment are given the same reference numerals, and description of them are omitted.

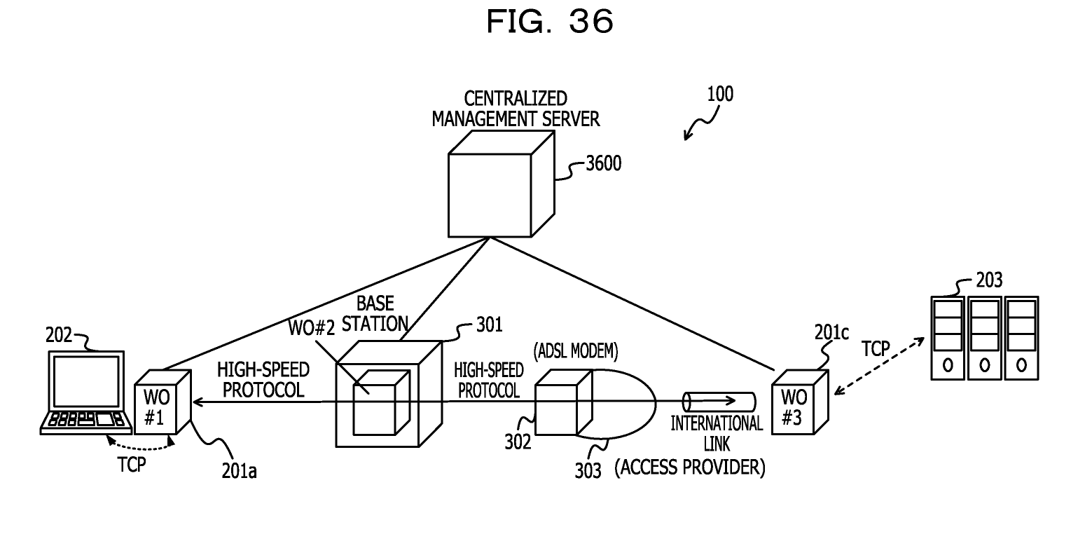

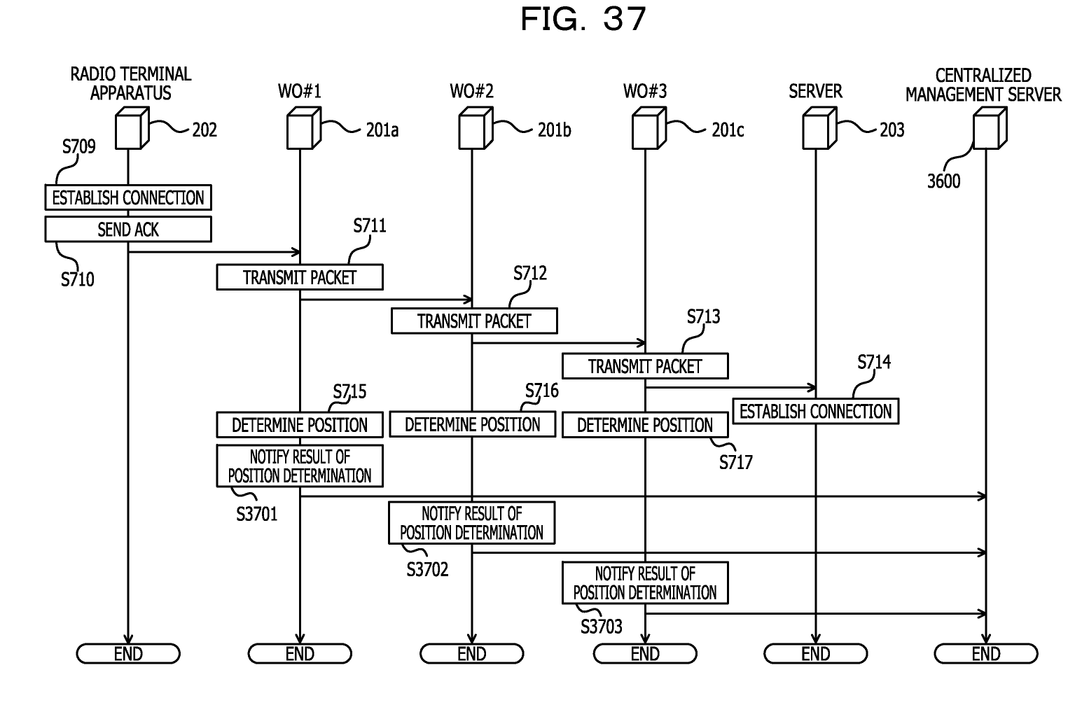

FIG. 36 is a descriptive diagram illustrating a modification example of the communication system. As illustrated in FIG. 36, the communication system 100 includes a centralized management server 3600. The centralized management server 3600 has the functions of the control apparatus 130 illustrated in FIG. 1, and manages the first WAN optimizer 201a, the second WAN optimizer 201b, and the third WAN optimizer 201c. Specifically, the centralized management server 3600 receives a result of the position measurement and a result of the communication quality measurement from the WAN optimizer 201 and manages the mode of the WAN optimizer 201. To sum up, the centralized management server 3600 has a function of a representative apparatus (the first WAN optimizer 201a according to the embodiment) that manages an optimal protocol application section.

### One Example of Transmitting and Receiving Data when the Position Determination is Performed in a Modification Example of an Embodiment

FIG. 37 is a sequence diagram illustrating one example of sending and receiving data when the position determination is performed in a modification example of the embodiment. Moreover, what distinguishes the sequence diagram in FIG. 37 from that illustrated in FIG. 7B is described.

As illustrated in FIG. 37, the first WAN optimizer 201a performs the position determination (Step S715), and then notifies the centralized management server 3600 of the result of the position determination (Step S3701). The second WAN optimizer 201b performs the position determination (Step S716), and then notifies the centralized management server 3600 of the result of the position determination (Step S3702). The third WAN optimizer 201c performs the position determination (Step S717), and then notifies the centralized management server 3600 of the result of the position determination (Step S3703).

Accordingly, the centralized management server 3600 can manage a relationship in position between each of the first WAN optimizer 201a, the second WAN optimizer 201b, and the third WAN optimizer 201c. Specifically, the centralized management server 3600 can acquire the results of the position determination, receive pieces of information 801, 802, and 803 illustrated in FIG. 8A, and with these, can manage the relationship in position between the first WAN optimizer 201a, the second WAN optimizer 201b, and the third WAN optimizer 201c.

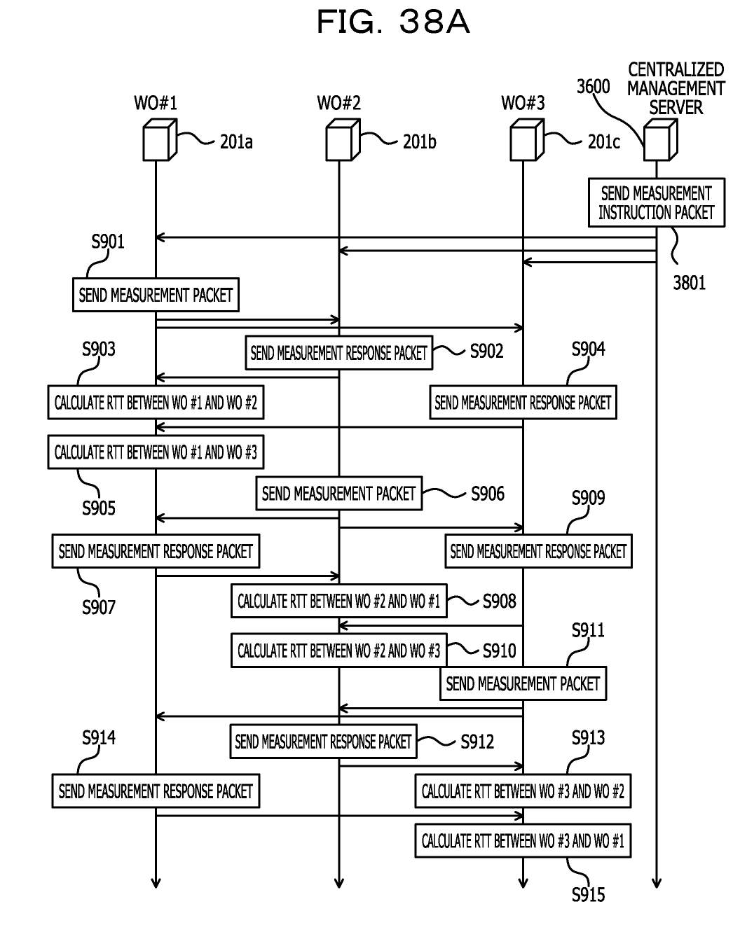

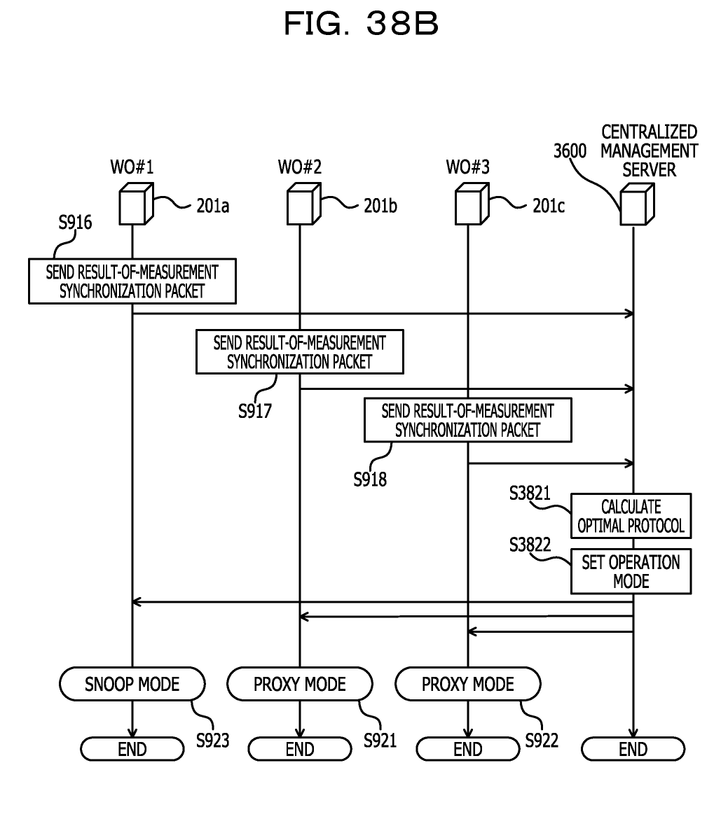

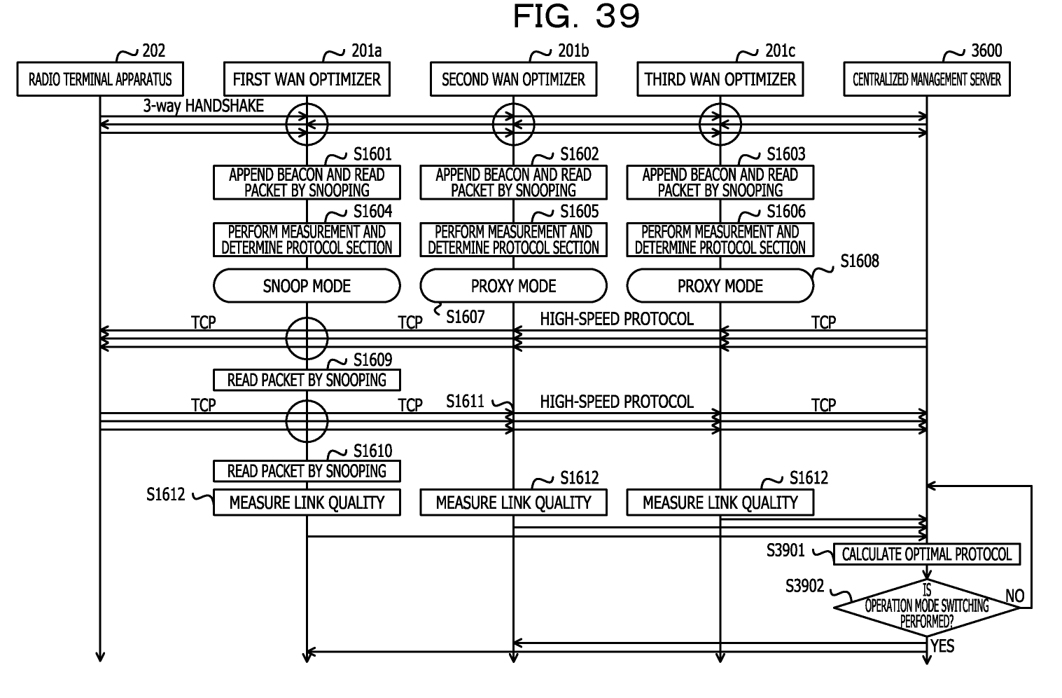

FIG. 38A is the first portion of a sequence diagram illustrating one example of a method of measuring the communication quality between the WAN optimizers in the modification example of the embodiment. FIG. 38b is the second and last portion of the sequence diagram illustrating one example of the method of measuring the communication quality between the WAN optimizers in the modification example of the embodiment. Moreover, what distinguishes the sequence diagram in FIGS. 38A and 38B from that illustrated in FIGS. 9A and 9B is described.

First, the centralized management server 3600 sends a measurement instruction packet to the WAN optimizer 201 (Step S3801). Accordingly, the WAN optimizer 201 starts to measure the communication quality. When measuring of the communication quality is finished, the WAN optimizer 201 sends the result-of-measuring synchronization packet to the centralized management server (Steps S916, S917, and S918). When the network quality is poor, for example, the centralized management server 3600 estimates performance (for example, throughput or latency) that would be possible if each protocol was used using the graph illustrated in FIG. 11 and the result of the measuring illustrated in FIG. 10.

The centralized management server 3600 calculates an optimal protocol that is used to determine which protocol has to be applied to which section in order to acquire the highest end-to-end (between the radio terminal apparatus 202 and the server 203) transmission performance (Step S3821). The centralized management server 3600 determines that optimal throughput is secured when the high-speed protocol is used in a section from the third WAN optimizer 201c to the second WAN optimizer 201b and TCP is used in a section between the second WAN optimizer 201b to the first WAN optimizer 201a.

In this case, the centralized management server 3600 sets an operation mode that indicates the protocol that is applied between each of the first WAN optimizer 201a, the second WAN optimizer 201b, and the third WAN optimizer 201c (Step S3822). The second WAN optimizer 201b sets the proxy mode according to the operation mode instruction of the centralized management server 3600 (Step S921). The third WAN optimizer 201c sets the proxy mode according to the operation mode instruction of the centralized management server 3600 (Step S922). The first WAN optimizer 201a sets the snoop mode according to the operation mode instruction of the centralized management server 3600 (Step S923).

### One Example of an Operation Sequence that is Performed when the TCP Section is Shortened in the Modification Example of the Embodiment

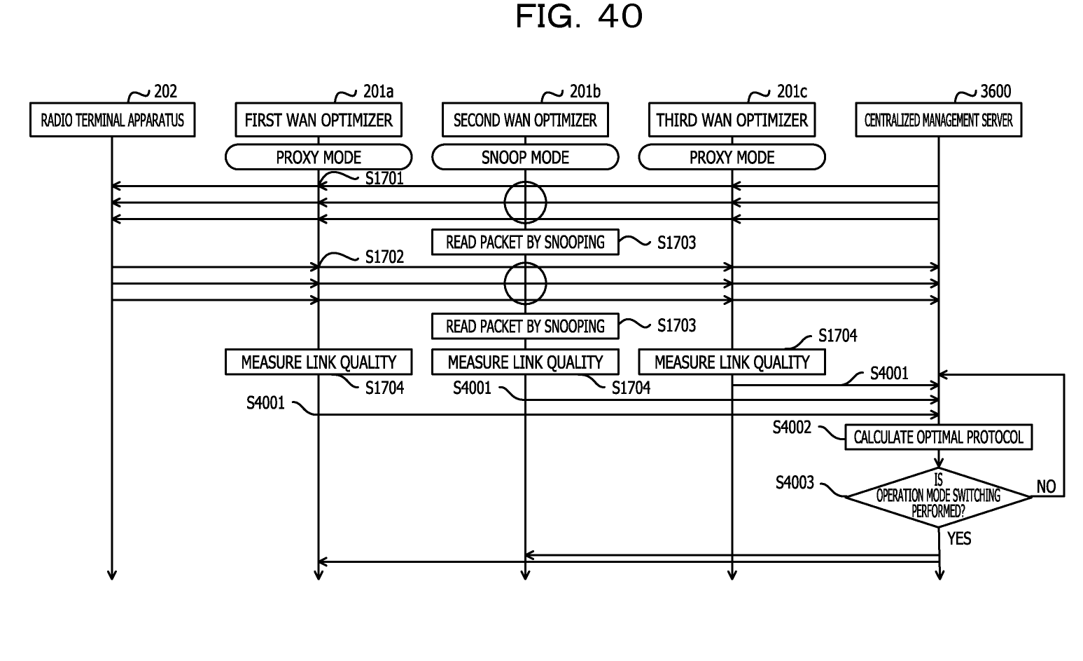

FIG. 39 is a sequence diagram illustrating one example of an operation that is performed by the communication system when the TCP section is shortened in the modification example of the embodiment. Moreover, what distinguishes the sequence diagram in FIG. 39 from that illustrated in FIG. 16A is described.

In FIG. 39, when the measuring of the link quality is performed (Step S1612), the WAN optimizer 201 sends the result of the measuring to the centralized management server 3600. The centralized management server 3600 calculates the optimal protocol (Step S3901). Then, the centralized management server 3600 determines whether or not the operation mode switching is performed (Step S3902). In a case where the operation mode switching is not performed (No in Step S3902), the centralized management server 3600 waits for the result of the measuring from the WAN optimizer 201.

For example, in a case where it is determined that the high-speed protocol, not TCP, is suitable as a protocol for the radio section and the operation mode switching is performed (Yes in Step S3902), the first WAN optimizer 201a performs the operation mode switching. Specifically, the first WAN optimizer 201a sets the proxy mode according to the instruction of the centralized management server 3600 in order to use the high-speed protocol in a section from the third WAN optimizer 201c to the first WAN optimizer 201a (refer to FIG. 16B). Furthermore, the second WAN optimizer 201b sets the snoop mode according to the instruction of the centralized management server 3600. Moreover, the centralized management server 3600 does not change the mode that is set for the third WAN optimizer 201c.

### One Example of an Operation Sequence that is Performed when the TCP Section is Lengthened in the Modification Example of the Embodiment

FIG. 40 is a sequence diagram illustrating one example of an operation that is performed by the communication system when a TCP section is lengthened in the modification example of the embodiment. Moreover, what distinguishes the sequence diagram in FIG. 40 from that illustrated in FIG. 17A is described.

In FIG. 40, when the measuring of the link quality is performed (Step S1704), the first WAN optimizer 201a, the second WAN optimizer 201b, and the third WAN optimizer 201c send the result of the measuring to the centralized management server 3600 (Step S4001). Then, the centralized management server 3600 calculates the optimal protocol using the result of the measuring (Step S4002). Next, the centralized management server 3600 determines whether or not the operation mode switching is performed (Step S4003). In a case where the operation mode switching is not performed (No in Step S4003), the centralized management server 3600 waits for the result of the measuring from the WAN optimizer 201.

For example, in a case where it is determined that TCP, not the high-speed protocol, is suitable as a protocol for the radio section and the operation mode switching is performed (Yes in Step S4003), the first WAN optimizer 201a performs the operation mode switching. Specifically, the second WAN optimizer 201b sets the proxy mode according to the instruction of the centralized management server 3600 in order to use the high-speed protocol in a section from the third WAN optimizer 201c to the second WAN optimizer 201b (refer to FIG. 18). Furthermore, the first WAN optimizer 201a sets the snoop mode according to the instruction of the centralized management server 3600. Moreover, the centralized management server 3600 does not change the mode that is set for the third WAN optimizer 201c.

In this manner, according to the modification example of the embodiment, the centralized management server 3600 can manage the mode of the WAN optimizer 201 using the result of measuring the position determination or the result of measuring the communication quality that are received from the WAN optimizer 201.

As described above, according to the present embodiment, when the WAN optimizer 201 in the snoop mode reads data by snooping and detects a waiting number, the WAN optimizer 201 switches to the proxy mode, and when the WAN optimizer 201 in the proxy mode detects the waiting number, the WAN optimizer 201 switches to the proxy mode. In this manner, the WAN optimizer 201 in the snoop mode and the WAN optimizer 201 in the proxy mode can switch mode at the same timing. For this reason, the termination position of the high-speed protocol can be dynamically changed without discontinuing the communication.

Furthermore, according to the present embodiment, in a case where the WAN optimizer 201 at the downstream side detects the sequence number for waiting, the control signal such as the synchronization-ready message is sent to the WAN optimizer 201 at the upstream side. In a case where the sequence number for waiting is detected, the WAN optimizer 201 at the upstream side interrupts the sending of data, and in a case where the control signal is received from the WAN optimizer 201 at the downstream side, the WAN optimizer 201 at the upstream side resumes the sending of the data. Therefore, at the time of the dynamic change of the termination position of the high-speed protocol, an amount of data mismatch can be reduced.

Furthermore, according to the present embodiment, in a case where lost data is present among pieces of data that are transmitted from the WAN optimizer 201 at the upstream side, the WAN optimizer 201 at the downstream side makes a request for the retransmission of lost data. Then, even though the sequence number for waiting is read, in a case where the lost data is not received, the WAN optimizer 201 at the downstream side performs neither the sending of the control signal to the WAN optimizer 201 at the upstream side nor the switching of its mode.

Accordingly, in a case where the data is lost before the mode switching, the WAN optimizer 201 at the upstream side can retransmit the lost data in the same protocol as when the lost data was first sent. Furthermore, the WAN optimizer 201 at the downstream side can receive the lost data in the same protocol as when the lost data occurred. In this manner, the lost data can be made up for and the data matching is possible before and after the switching between the transmission states.

Furthermore, the sequence number for waiting is set to be information that is determined based on the delay time between the multiple WAN optimizers. Therefore, the sequence number for waiting can be set based on the delay time between each of the first WAN optimizer 201a, the second WAN optimizer 201b, and the third WAN optimizer 201c and synchronization deviation can be suppressed at the time of switching the transmission state.

Furthermore, according to the present embodiment, before establishing the communication between each of the first WAN optimizer 201a, the second WAN optimizer 201b, and the third WAN optimizer 201c, the mode (the snoop mode and the proxy mode) between each of the first WAN optimizer 201a, the second WAN optimizer 201b, and the third WAN optimizer 201c is set based on the communication quality between each of the first WAN optimizer 201a, the second WAN optimizer 201b, and the third WAN optimizer 201c. Accordingly, the communication can be started at the optimal termination position of the high-speed protocol.

Furthermore, according to the present embodiment, the mode between each of the first WAN optimizer 201a, the second WAN optimizer 201b, and the third WAN optimizer 201c can be switched based on the communication quality between of each of the first WAN optimizer 201a, the second WAN optimizer 201b, and the third WAN optimizer 201c. Therefore, the optimal termination position of the high-speed protocol can be dynamically changed according to the communication quality between each of the first WAN optimizer 201a, the second WAN optimizer 201b, and the third WAN optimizer 201c in the inter-apparatus quality table 461.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication system comprising:
a first communication apparatus including:
a first transmitter, and
a first processor coupled to the first transmitter and configured to:
set an operation mode in the first communication apparatus for forwarding data, to be one of a first operation mode and a second operation mode, the first operation mode in which the data is forwarded without a protocol conversion, the second operation mode in which the data is forwarded with the protocol conversion,
detect identification information of the data included in the data that is received from an upstream communication apparatus and forwarded to a second communication apparatus, and
when the operation mode in the first communication apparatus is the first operation mode and the identification information detected by the first processor is a first given value, switch the operation mode in the first communication apparatus from the first operation mode to the second operation mode; and
the second communication apparatus including:
a second transmitter, and
a second processor coupled to the second transmitter and configured to:
set an operation mode in the second communication apparatus for forwarding data, to be one of the first operation mode and the second operation mode,
detect identification information of the data included in the data that is received from the first communication apparatus and forwarded to a downstream communication apparatus, and
when the operation mode in the second communication apparatus is the second operation mode and the identification information detected by the second processor is the first given value, switch the operation mode in the second communication apparatus from the second operation mode to the first operation mode.

2. The communication system according to claim 1, wherein
the second processor is configured to:
when the operation mode in the second communication apparatus is the second operation mode and the identification information detected by the second processor is the first given value, transmit a control information indicating that the second communication apparatus receives the data including the identification information that is the first given value, to the first communication apparatus, and
the first processor is configured to:
when the operation mode in the first communication apparatus is the first operation mode and the identification information detected by the first processor is the first given value, suspend forwarding the data to the second communication apparatus, and
when the control information is received from the second communication apparatus, resume forwarding the data that is suspended, with switching the operation mode in the first communication apparatus from the first operation mode to the second operation mode.

3. The communication system according to claim 1, wherein
the second processor is configured to:
when detecting lost data that is not received from the first communication apparatus among the data that is transmitted from the first communication apparatus to the second communication apparatus, request the first communication apparatus to retransmit the lost data,
the first processor is configured to:
when requested to retransmit the lost data, retransmit the lost data, and
the second processor is configured to:
when the retransmitted lost data is not received, stop switching the operation mode in the second communication apparatus regardless of detecting the identification information that is the first given value.

4. The communication system according to claim 1,
wherein the first given value is determined based on a length of a period from a first time when the first communication apparatus transmits the data to a second time when the second communication apparatus receives the data.

5. The communication system according to claim 4 further comprising:
a control apparatus configured to:
determine the first given value, and
outputs the determined first given value to the first communication apparatus and the second communication apparatus.

6. The communication system according to claim 1, wherein
the identification information is a serial number of the data.

7. The communication system according to claim 1 further comprising:
a control apparatus configured to:
set the operation mode in the first communication apparatus and the operation mode in the second communication apparatus to be different from each other based on quality of a channel between the first communication apparatus and the second communication apparatus, before a communication between the first communication apparatus and the second communication apparatus is established.

8. The communication system according to claim 1 further comprising:
a control apparatus configured to:
make a determination to switch the operation mode in the first communication apparatus and the operation mode in the second communication apparatus based on quality of a channel between the first communication apparatus and the second communication apparatus,
wherein the first communication apparatus and the second communication apparatus are configured to switch the operation mode in the first communication apparatus and the operation mode in the second communication apparatus, when the determination is made and the identification information being the first given value is detected.

9. A communication system comprising according to claim 1, wherein:
the first processor is configured to:
when the operation mode in the first communication apparatus is the second operation mode and the identification information detected by the first processor is a second given value, switch the operation mode in the first communication apparatus from the second operation mode to the first operation mode, and
the second processor is configured to:
when the operation mode in the second communication apparatus is the first operation mode and the identification information detected by the second processor is the second given value, switch the operation mode in the second communication apparatus from the first operation mode to the second operation mode.

10. The communication system according to claim 9, wherein
the second processor is configured to:
when the operation mode in the second communication apparatus is the first operation mode and the identification information detected by the second processor is the second given value, transmit a control information indicating that the second communication apparatus receives the data including the identification information that is the second given value, to the first communication apparatus, and
the first processor is configured to:
when the operation mode in the first communication apparatus is the second operation mode and the identification information detected by the first processor is the second given value, suspend forwarding the data to the second communication apparatus, and
when the control information is received from the second communication apparatus, resume forwarding the data that is suspended, with switching the operation mode in the first communication apparatus from the second operation mode to the first operation mode.

11. A communication apparatus comprising:
a transmitter; and
a processor coupled to the transmitter and configured to:
set an operation mode in the communication apparatus for forwarding data, to be one of a first operation mode and a second operation mode, the first operation mode in which the data is forwarded without a protocol conversion, the second operation mode in which the data is forwarded with the protocol conversion,
detect identification information of the data included in the data that is received from an upstream communication apparatus and forwarded to a downstream communication apparatus, and
when the operation mode in the communication apparatus is the first operation mode and the identification information detected by the first processor is a first given value, switch the operation mode in the communication apparatus from the first operation mode to the second operation mode.

12. A communication method performed by a communication apparatus, the communication method comprising:
setting an operation mode in the communication apparatus for forwarding data, to be one of a first operation mode and a second operation mode, the first operation mode in which the data is forwarded without a protocol conversion, the second operation mode in which the data is forwarded with the protocol conversion,
detecting identification information of the data included in the data that is received from an upstream communication apparatus and forwarded to a downstream communication apparatus, and
when the operation mode in the communication apparatus is the first operation mode and the identification information detected by the first processor is a first given value, switching the operation mode in the communication apparatus from the first operation mode to the second operation mode.
